(19) United States
(12) Patent Application Publication
(10) Pub. No.: US 2018/0044245 A1
(43) Pub. Date: Feb. 15, 2018

(54) GEL COMPOSITIONS, SHAPED GEL ARTICLES AND A METHOD OF MAKING A SINTERED ARTICLE

(71) Applicant: 3M Innovative Properties Company, St. Paul, MN (US)

(72) Inventors: Kathleen M. HUMPAL, Stillwater, MN (US); Brant U. KOLB, Afton, MN (US); Melissa A. LACKEY, Woodbury, MN (US); Mark J. HENDRICKSON, Minneapolis, MN (US); Paul D. PENNINGTON, Farmington, MN (US)

(21) Appl. No.: 15/552,382

(22) PCT Filed: Feb. 24, 2016
(86) PCT No.: PCT/US2016/019231

§ 371 Date: Aug. 21, 2017

Related U.S. Application Data
(60) Provisional application No. 62/127,569, filed on Mar. 3, 2015.

(51) Int. Cl. C04B 35/48; C08F 220/06; C04B 35/634; B01J 13/00; C04B 35/624; C04B 35/64; C08F 222/20; C08J 9/24

(52) U.S. Cl. CPC C04B 35/48; C08F 222/20; C08F 220/06; C08J 9/24; B01J 13/0065; C04B 35/624; C04B 35/64; C04B 35/63488; C08J 2205/026; C08J 2335/02; C08J 2333/02; C04B 2235/3244; C04B 2235/48; C04B 2235/6023

(57) ABSTRACT

Reaction mixtures, gel compositions that are a polymerized product of the reaction mixtures, shaped gel articles that are formed within a mold cavity and that retain the size and shape of the mold cavity upon removal from the mold cavity, and sintered articles prepared from the shaped gel articles are provided. The sintered article has a shape identical to the mold cavity (except in regions where the mold cavity was overfilled) and to the shaped articles but reduced in size proportional to the amount of isotropic shrinkage. Methods of forming the sintered articles also are provided.

### CROSS REFERENCE TO RELATED APPLICATION

This application claims the benefit of U.S. Provisional Patent Application No. 62/127,569, filed Mar. 3, 2015, the disclosure of which is incorporated by reference herein in its entirety.

### TECHNICAL FIELD

Gel compositions, reaction mixtures used to form gel compositions, shaped gel articles, sintered articles, and methods of making sintered articles are provided.

### BACKGROUND

Net shaped processing of ceramic materials is advantageous because it can be difficult and/or expensive to machine ceramic materials into complex shapes. The term “net shaped process” refers to a process of producing an initial item that is very close to the desired final (net) shape. This reduces the need for traditional and costly finishing methods such as machining or grinding.

Various methods have been used to prepare net shaped ceramic materials. These include processes such as gel casting, slip casting, sol-gel casting, and injection molding. Each of these techniques has limitations. For example, gel casting involves casting a ceramic powder slurry into a mold. The ceramic powder often has a size in a range of about 0.5 to 5 microns. To prevent non-uniform shrinkage during processing, the slurry used for gel casting often contains about 50 volume percent solids. Because such slurries typically have a high viscosity, there are limitations on how well they can replicate small, complex features on a mold surface. Slip casting often results in green bodies with a non-uniform density resulting from powder packing during casting. Injection molding methods typically use large amounts of thermoplastic materials that can be difficult to remove from the green body without causing distortion due to slumping when the thermoplastic material softens during the organic burnout process.

### SUMMARY

Reaction mixtures, gel compositions that are a polymerized product of the reaction mixture, shaped gel articles that are formed within a mold cavity and that retain the size and shape of the mold cavity upon removal from the mold cavity, and sintered articles prepared from the shaped gel articles are provided. The sintered article has a shape identical to the mold cavity (except in regions where the mold cavity was overfilled) and to the shaped gel article but reduced in size proportional to the amount of isotropic shrinkage.

In a first aspect, a reaction mixture is provided that includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including (1) a first surface modification agent having a free radical polymerizable group; and (d) a photoinitiator for a free radical polymerization reaction.

In a second aspect, a gel composition is provided that includes a polymerized product of the reaction mixture described above.

In a third aspect, an article is provided that includes (a) a mold having a mold cavity and (b) a reaction mixture positioned within the mold cavity and in contact with a surface of the mold cavity. The reaction mixture is the same as described above.

In a fourth aspect, an article is provided that includes (a) a mold having a mold cavity and (b) a gel composition positioned within the mold cavity and in contact with a surface of the mold cavity. The gel composition includes a polymerized product of a reaction mixture and the reaction mixture is the same as described above.

In a fifth aspect, a shaped gel article is provided. The shaped gel article is a polymerized product of a reaction mixture, wherein the reaction mixture is positioned within a mold cavity during polymerization and wherein the shaped gel article retains both a size and shape identical to the mold cavity (except in regions where the mold cavity was overfilled) when removed from the mold cavity. The reaction mixture is the same as described above.

In a sixth aspect, a method of making a sintered article is provided. The method includes (a) providing a mold having a mold cavity, (b) positioning a reaction mixture within the mold cavity, (c) polymerizing the reaction mixture to form a shaped gel article that is in contact with the mold cavity, (d) removing the shaped gel article from the mold cavity, wherein the shaped gel article retains a size and shape identical to the mold cavity (except in regions where the mold cavity was overfilled), (e) forming a dried shaped gel article by removing the solvent medium, (f) heating the dried shaped gel article to form a sintered article. The sintered article has a shape identical to the mold cavity (except in regions where the mold cavity was overfilled) and to the shaped gel article but reduced in size proportional to an amount of isotropic shrinkage. The reaction mixture is the same as described above.

In a seventh aspect, a sintered article is provided that is prepared using the method described above for making a sintered article.

In an eighth aspect, a method of making an aerogel is provided. The method includes (a) providing a mold having a mold cavity, (b) positioning a reaction mixture within the mold cavity, (c) polymerizing the reaction mixture to form a shaped gel article that is in contact with the mold cavity, (d) removing the shaped gel article from the mold cavity, wherein the shaped gel article retains a size and shape identical to the mold cavity (except in regions where the mold cavity was overfilled), and (e) removing the solvent medium from the shaped gel article by supercritical extraction to form the aerogel. The reaction mixture is the same as described above.

In a ninth aspect, a method of making a xerogel is provided. The method includes (a) providing a mold having a mold cavity, (b) positioning a reaction mixture within the mold cavity, (c) polymerizing the reaction mixture to form a shaped gel article that is in contact with the mold cavity, (d) removing the shaped gel article from the mold cavity, wherein the shaped gel article retains a size and shape identical to the mold cavity (except in regions where the mold cavity was overfilled), and (e) removing the solvent medium from the shaped gel article by evaporation at room temperature or at an elevated temperature to form the xerogel. The reaction mixture is the same as described above.

### BRIEF DESCRIPTION OF THE DRAWINGS

FIG. 1 is a schematic diagram of the fiducial mold used in Example 4.

FIG. 2 is a photograph of the sintered article prepared in Example 5.

FIG. 3 is a photograph of the sintered article prepared in Example 11.

FIG. 4 is a photograph of the sintered article prepared in Example 6.

FIG. 5 is a photograph of the dried bodies prepared in Example 23 (left) and Comparative Example A (right).

### DETAILED DESCRIPTION

Reaction mixtures, gel compositions that are a polymerized product of the reaction mixtures, shaped gel articles that are formed within a mold cavity and that retain the size and shape of the mold cavity upon removal from the mold cavity, and sintered articles prepared from the shaped gel articles are provided. The sintered article has a shape identical to the mold cavity (except in regions where the mold cavity was overfilled) and to the shaped gel articles but reduced in size proportional to an amount of isotropic shrinkage. Additionally, methods of forming the sintered articles, xerogels, and aerogels are provided.

The gel compositions, the shaped gel articles, and the sintered articles are formed using a reaction mixture that includes (a) zirconia-based particles, (b) a solvent medium that includes an organic solvent having a boiling point equal to at least 150° C., (c) polymerizable material that includes a first surface modification agent having a free radical polymerizable group, and (d) a photoinitiator for a free radical polymerization reaction. The polymerized product of the reaction mixture, which is the gel composition in the form of a shaped gel article, can be handled and processed to form a sintered article that can have a complex shape and/or features, that can be free of cracks, and that can have a uniform density throughout.

More particularly, the reaction mixture contains (a) 20 to 60 weight percent zirconia-based particles based on a total weight of the reaction mixture, the zirconia-based particles having an average particle size no greater than 100 nanometers and comprising at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, wherein the polymerizable material contains a first surface modification agent having free radical polymerizable group, and (d) a photoinitiator for a free radical polymerization reaction. The reaction mixture can be referred to interchangeably herein as the “casting sol”. That is, the reaction mixture or casting sol is used to form the gel composition. The gel composition results from free radical polymerization of the reaction mixture or the casting sol. The gel composition is typically formed within a mold and is in the form of a shaped gel article. The shaped gel article is dried to either an aerogel or xerogel. The sintered article is formed from the aerogel or xerogel.

### Definitions

As used herein, the term “a”, “an”, and “the” are used interchangeably with “at least one” to mean one or more of the component being described.

As used herein, the term “and/or” such as in A and/or B means A alone, B alone, or both A and B.

As used herein, the term “zirconia” refers to various stoichiometric formulas for zirconium oxide. The most typical stoichiometric formula is ZrO₂, which is generally referred to as either zirconium oxide or zirconium dioxide.

As used herein, the term “zirconia-based” means that the majority of the material is zirconia. For example, at least 70 mole percent, at least 75 mole percent, at least 80 mole percent, at least 85 mole percent, at least 90 mole percent, at least 95 mole percent, or at least 98 mole percent of the material is zirconia. The zirconia is often doped with other inorganic oxides such as, for example, a lanthanide element oxide and/or yttrium oxide.

As used herein, the term “inorganic oxide” includes, but is not limited to, oxides of various inorganic elements such as, for example, zirconium oxide, yttrium oxide, lanthanide element oxide, aluminum oxide, calcium oxide, and magnesium oxide.

As used herein, the term “lanthanide element” refers to an element in the lanthanide series of the periodic table of elements. The lanthanide series can have an atomic number 57 (for lanthanum) to 71 (for lutetium). Elements included in this series are lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

As used herein, the term “rare earth” refers to an element that is scandium (Sc), yttrium (Y), or a lanthanide element.

As used herein, the term “in the range” includes the endpoints of the range and all numbers between the endpoints. For example, in the range of 1 to 10 includes the numbers 1, 10, and all numbers between 1 and 10.

As used herein, the term “associated” refers to a grouping of two or more primary particles that are aggregated and/or agglomerated. Similarly, the term “non-associated” refers to two or more primary particles that are free or substantially free from aggregation and/or agglomeration.

As used herein, the term “aggregation” refers to a strong association of two or more primary particles. For example, the primary particles may be chemically bound to one another. The breakdown of aggregates into smaller particles (e.g., primary particles) is generally difficult to achieve.

As used herein, the term “agglomeration” refers to a weak association of two or more primary particles. For example, particles may be held together by charge or polarity. The breakdown of agglomerates into smaller particles (e.g., primary particles) is less difficult than the breakdown of aggregates into smaller particles.

As used herein, the term “primary particle size” refers to the size of a non-associated single crystal zirconia particle, which is considered to be a primary particle. X-ray diffraction (XRD) is typically used to measure the primary particle size.

As used herein, the term “hydrothermal” refers to a method of heating an aqueous medium to a temperature above the normal boiling point of the aqueous medium at a pressure that is equal to or greater than the pressure required to prevent boiling of the aqueous medium.

As used herein, the term “sol” refers to a colloidal suspension of discrete particles in a liquid. The discrete particles often have an average size in a range of 1 to 100 nanometers.

As used herein, the term “gel” or “gel composition” refers to a polymerized product of a reaction mixture that is a casting sol and wherein the casting sol includes zirconia-based particles, a solvent medium, polymerizable material, and a photoinitiator.

As used herein, the term “shaped gel” refers to a gel composition that has been formed within a mold cavity, wherein the shaped gel (i.e., shaped gel article) has a shape and size determined by the mold cavity. In particular, a polymerizable reaction mixture containing zirconia-based particles can be polymerized to a gel composition within a mold cavity, wherein the gel composition (i.e., shaped gel article) retains the size and shape of the mold cavity when removed from the mold cavity.

As used herein, the term “aerogel” means a three-dimensional low density (e.g., less than 30% of theoretical density) solid. An aerogel is a porous material derived from a gel, in which the liquid component of the gel has been replaced with a gas. The solvent removal is often done under supercritical conditions. During this process the network does not substantially shrink and a highly porous, low-density material can be obtained.

As used herein, the term “xerogel” refers to a gel composition that has been further processed to remove the solvent medium by evaporation under ambient conditions or at an elevated temperature.

As used herein, the term “isotropic shrinkage” refers to shrinkage that is essentially to the same extent in the x-direction, the y-direction, and the z-direction. That is, the extent of shrinkage in one direction is within 5 percent, within 2 percent, within 1 percent, or within 0.5 percent of the shrinkage in the other two directions.

As used herein, the term “crack” refers to a material segregation or partitioning (i.e., defect) that is a ratio equal to at least 5:1, at least 6:1, at least 7:1, at least 8:1, at least 10:1, at least 12:1, or at least 15:1 in any two dimensions.

The term “(meth)acryloyl” refers to an acryloyl and/or methacryloyl group of formula CH2═CR^{b}—(CO)— where R^{b} is hydrogen or methyl. When R^{b} is hydrogen, the group is an acryloyl group. When R^{b} is methyl, the group is a methacryloyl group. Similarly, the term “(meth)acrylate” refers to acrylate and/or methacrylate, the term “(meth)acrylic” refers to acrylic and/or methacrylic, and the term “(meth)acrylamide” refers to acrylamide and/or methacrylamide.

### Reaction Mixture (Casting Sol)

1. Zirconia-Based Particles

The reaction mixture contains zirconia-based particles. Any suitable process can be used to form the zirconia-based particles. In particular, the zirconia-based particles have an average particle size no greater than 100 nanometers and contain at least 70 mole percent ZrO₂. The zirconia-based particles are crystalline and the crystalline phase is predominately cubic and/or tetragonal. The zirconia-based particles are preferably non-associated, which makes them suitable for formation of high density, sintered articles. Non-associated particles lead to low viscosity and high light transmission through the reaction mixture. Additionally, non-associated particles lead to more uniform pore structures in the aerogel or xerogel and to more homogeneous sintered articles.

In many embodiments, a hydrothermal method (hydrothermal reactor system) is used to provide zirconia-based particles that are crystalline and non-associated. A feedstock for the hydrothermal reactor system is used that contains zirconia salts and other optional salts dissolved in an aqueous medium. Suitable optional salts include, for example, rare earth salts, transition metal salts, alkaline earth metal salts, and post-transition metal salts. Example rare earth salts include, for example, salts containing scandium, yttrium, lanthanum, cerium, praseodymium, neodymium, promethium, samarium, europium, gadolinium, terbium, dysprosium, holmium, erbium, thulium, ytterbium, and lutetium. Example transition metals include, but are not limited to, salts of iron, manganese, cobalt, chromium, nickel, copper, tungsten, vanadium, and hafnium. Example alkaline earth metal salts include, but are not limited to, salts of calcium and magnesium. Example post-transition metal salts include, but are not limited to, salts of aluminum, gallium, and bismuth. In many embodiments, the post-transition metal salts are salts of aluminum. In many embodiments, the optional salts are yttrium salts, lanthanum salts, calcium salts, magnesium salts, aluminum salts, or mixtures thereof. In some preferred embodiments, the optional salts are yttrium salts and lanthanum salts. The metals are typically incorporated into the zirconia-based particles rather than existing as separate particles.

The dissolved salts included in the feedstock for the hydrothermal reactor system are typically selected to have an anion that is removable during subsequent processing steps and that is non-corrosive. The dissolved salts are typically carboxylate salts such as those having a carboxylate anion with no greater than four carbon atoms such as, for example, formate, acetate, propionate, butyrate, or a combination thereof. In many embodiments, the carboxylate salts are acetate salts. That is, the feedstock often includes dissolved zirconium acetate and other optional acetate salts such as yttrium acetate and lanthanide element acetates (e.g., lanthanum acetate). The feedstock can further include the corresponding carboxylic acid of the carboxylate anion. For example, feedstocks prepared from acetate salts often contain acetic acid. The pH of the feedstock is typically acidic. For example, the pH is often up to 6, up to 5, or up to 4 and at least 2 or at least 3.

One exemplary zirconium salt is zirconium acetate salt, represented by a formula such as ZrO_{((4-n)/2)}ⁿ⁺(CH₃COO⁻)ₙ, where n is in the range from 1 to 2. The zirconium ion may be present in a variety of structures depending, for example, on the pH of the feedstock. Methods of making zirconium acetate are described, for example, in W. B. Blumenthal, “The Chemical Behavior of Zirconium,” pp. 311-338, D. Van Nostrand Company, Princeton, N.J. (1958). Suitable aqueous solutions of zirconium acetate are commercially available, for example, from Magnesium Elektron, Inc. (Flemington, N.J., USA), that contain, for example, up to 17 weight percent zirconium, up to 18 weight percent zirconium, up to 20 weight percent zirconium, up to 22 weight percent zirconium, up to 24 weight percent zirconium, up to 26 weight percent zirconium, or up to 28 weight percent zirconium, based on the total weight of the solution.

The feedstock is often selected to avoid or minimize the use of anions other than the carboxylate anion. That is, the feedstock is selected to avoid the use of or to minimize the use of halide salts, oxyhalide salts, sulfate salts, nitrate salts, or oxynitrate salts. Halide and nitrate anions tend to result in the formation of zirconia-based particles that are predominately of a monoclinic phase rather than the more desirable tetragonal or cubic phases. Because the optional salts are used in relatively low amounts compared to the amount of the zirconium salt, the optional salts can have anions that are not carboxylates. In many embodiments, it is preferable that all salts added to the feedstock are acetate salts.

The amount of the various salts dissolved in the feedstock can be readily determined based on the percent solids selected for the feedstock and the desired composition of the zirconia-based particles. Typically, the feedstock is a solution and does not contain dispersed or suspended solids. For example, seed particles are not present in the feedstock. The feedstock usually contains greater than 5 weight percent solids and these solids are typically dissolved. The “weight percent solids” can be calculated by drying a sample to a constant weight at 120° C. and refers to the portion of the feedstock that is not water, a water-miscible co-solvent, or another compound that can be vaporized at temperatures up to 120° C. The weight percent solids is calculated by dividing the dry weight by the wet weight and then multiplying by 100. The wet weight refers to the weight of the feedstock before drying and the dry weight refers to the weight of the sample after drying. In many embodiments, the feedstock contains at least 5 weight percent, at least 10 weight percent, at least 12 weight percent, or at least 15 weight percent solids. Some feedstocks contain up to 20 weight percent solids, up to 25 weight percent solids, or even higher than 25 weight percent solids.

Once the percent solids have been selected, the amount of each dissolved salt can be calculated based on the desired composition of the zirconia-based particles. The zirconia-based particles are at least 70 mole percent zirconium oxide. For example, the zirconia-based particles can be at least 75 mole percent, at least 80 mole percent, at least 85 mole percent, at least 90 mole percent, or at least 95 mole percent zirconium oxide. The zirconia-based particles be up to 100 mole percent zirconium oxide. For example, the zirconia-based particles can be up to 99 mole percent, up to 98 mole percent, up to 95 mole percent, up to 90 mole percent, or up to 85 mole percent zirconium oxide.

Depending on the intended use of the final sintered articles, other inorganic oxides can be included in the zirconia-based particles in addition to zirconium oxide. Up to 30 mole percent, up to 25 mole percent, up to 20 mole percent, up to 10 mole percent, up to 5 mole percent, up to 2 mole percent, or up to 1 mole percent of the zirconia-based particles can be Y₂O₃, La₂O₃, Al₂O₃, CeO₂, Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, Fe₂O₃, MnO₂, Co₂O₃, Cr₂O₃, NiO, CuO, V₂O₃, Bi₂O₃, Ga₂O₃, Lu₂O₃, HfO₂, or mixtures thereof. Inorganic oxide such as Fe₂O₃, MnO₂, Co₂O₃, Cr₂O₃, NiO, CuO, Bi₂O₃, Ga₂O₃, Er₂O₃, Pr₂O₃, Eu₂O₃, Dy₂O₃, Sm₂O₃, V₂O₃, or W₂O₃ may be added, for example, to alter the color of the zirconia-based particles.

When no other inorganic oxide other than zirconium oxide is included in the zirconia-based particles, the likelihood of having some of the monoclinic crystalline phase present increases. In many uses, it may be desirable to minimize the amount of monoclinic phase because this phase is less stable than either the tetragonal or cubic phases when heated. For example, when the monoclinic phase is heated above 1200° C., it can transform to the tetragonal phase but then return to the monoclinic phase upon cooling. These transformations can be accompanied by volume expansion, which can lead to cracking or fracturing of the material. In contrast, the tetragonal and cubic phase can be heated to about 2370° C. or above without undergoing phase transformations.

In many embodiments when a rare earth oxide is included in the zirconia-based oxide, the rare earth element is yttrium or a combination of yttrium and lanthanum. The presence of yttrium or both yttrium and lanthanum can prevent the destructive transformation of the tetragonal phase or the cubic phase to the monoclinic phase during cooling from an elevated temperature such as those greater than 1200° C. The addition of yttrium or both yttrium and lanthanum can increase or maintain the physical integrity, toughness, or both of the sintered articles.

The zirconia-based particles can contain 0 to 30 weight percent yttrium oxide based on the total moles of inorganic oxide present. If yttrium oxide is added to the zirconia-based particles, it is often added in an amount equal to at least 1 mole percent, at least 2 mole percent, or at least 5 mole percent. The amount of yttrium oxide can be up to 30 mole percent, up to 25 mole percent, up to 20 mole percent, or up to 15 mole percent. For example, the amount of yttrium oxide can be in a range of 1 to 30 mole percent, 1 to 25 mole percent, 2 to 25 mole percent, 1 to 20 mole percent, 2 to 20 mole percent, 1 to 15 mole percent, 2 to 15 mole percent, 5 to 30 mole percent, 5 to 25 mole percent, 5 to 20 mole percent, or 5 to 15 mole percent. The mole percent amounts are based on the total moles of inorganic oxide in the zirconia-based particles.

The zirconia-based particles can contain 0 to 10 mole percent lanthanum oxide based on the total moles of inorganic oxide present. If lanthanum oxide is added to the zirconia-based particles, it can be used in an amount equal to at least 0.1 mole percent, at least 0.2 mole percent, or at least 0.5 mole percent. The amount of lanthanum oxide can be up to 10 mole percent, up to 5 mole percent, up to 3 mole percent, up to 2 mole percent, or up to 1 mole percent. For example, the amount of lanthanum oxide can be in a range of 0.1 to 10 mole percent, 0.1 to 5 mole percent, 0.1 to 3 mole percent, 0.1 to 2 mole percent, or 0.1 to 1 mole percent. The mole percent amounts are based on the total moles of inorganic oxide in the zirconia-based particles.

In some embodiments, the zirconia-based particles contain 70 to 100 mole percent zirconium oxide, 0 to 30 mole percent yttrium oxide, and 0 to 10 mole percent lanthanum oxide. For example, the zirconia-based particles contain 70 to 99 mole percent zirconium oxide, 1 to 30 mole percent yttrium oxide, and 0 to 10 mole percent lanthanum oxide. In other examples, the zirconia-based particles contain 75 to 99 mole percent zirconium oxide, 1 to 25 mole percent yttrium oxide, and 0 to 5 mole percent lanthanum oxide or 80 to 99 mole percent zirconium oxide, 1 to 20 mole percent yttrium oxide, and 0 to 5 mole percent lanthanum oxide or 85 to 99 mole percent zirconium oxide, 1 to 15 mole percent yttrium oxide, and 0 to 5 mole percent lanthanum oxide. In still other embodiments, the zirconia-based particles contain 85 to 95 mole percent zirconium oxide, 5 to 15 mole percent yttrium oxide, and 0 to 5 mole percent (e.g., 0.1 to 5 mole percent or 0.1 to 2 mole percent) lanthanum oxide. The mole percent amounts are based on the total moles of inorganic oxide in the zirconia-based particles.

Other inorganic oxides can be used in combination with a rare earth element or in place of a rare earth element. For example, calcium oxide, magnesium oxide, or a mixture thereof can be added in an amount in a range of 0 to 30 mole percent based on the total moles of inorganic oxide present. The presence of these inorganic oxides tends to decrease the amount of monoclinic phase formed. If calcium oxide and/or magnesium oxide is added to the zirconia-based particles, the total amount added is often at least 1 mole percent, at least 2 mole percent, or at least 5 mole percent. The amount of calcium oxide, magnesium oxide, or a mixture thereof can be up to 30 mole percent, up to 25 mole percent, up to 20 mole percent, or up to 15 mole percent. For example, the amount can be in a range of 1 to 30 mole percent, 1 to 25 mole percent, 2 to 25 mole percent, 1 to 20 mole percent, 2 to 20 mole percent, 1 to 15 mole percent, 2 to 15 mole percent, 5 to 30 mole percent, 5 to 25 mole percent, 5 to 20 mole percent, or 5 to 15 mole percent. The mole percent amounts are based on the total moles of inorganic oxide in the zirconia-based particles.

Further, aluminum oxide can be included in an amount in a range of 0 to less than 1 mole percent based on a total moles of inorganic oxides in the zirconia-based particles. Some example zirconia-based particles contain 0 to 0.5 mole percent, 0 to 0.2 mole percent, or 0 to 0.1 mole percent of these inorganic oxides.

The liquid medium of the feedstock for the hydrothermal reactor is typically predominantly water (i.e., the liquid medium is an aqueous-based medium). This water is preferably deionized to minimize the introduction of other metal species such as alkali metal ions, alkaline earth ions, or both into the feedstock. Water-miscible organic co-solvents can be included in the solvent medium phase in amounts up to 20 weight percent based on the weight of the solvent medium phase. Suitable co-solvents include, but are not limited to, 1-methoxy-2-propanol, ethanol, isopropanol, ethylene glycol, N,N-dimethylacetamide, and N-methyl pyrrolidone. In most embodiments, no organic solvents are added to the aqueous-based medium.

When subjected to hydrothermal treatment, the various dissolved salts in the feedstock undergo hydrolysis and condensation reactions to form the zirconia-based particles. These reactions are often accompanied with the release of an acidic byproduct. That is, the byproduct is often one or more carboxylic acids corresponding to the zirconium carboxylate salt plus any other carboxylate salt in the feedstock. For example, if the salts are acetate salts, acetic acid is formed as a byproduct of the hydrothermal reaction.

Any suitable hydrothermal reactor system can be used for the preparation of the zirconia-based particles. The reactor can be a batch or continuous reactor. The heating times are typically shorter and the temperatures are typically higher in a continuous hydrothermal reactor compared to a batch hydrothermal reactor. The time of the hydrothermal treatments can be varied depending on the type of reactor, the temperature of the reactor, and the concentration of the feedstock. The pressure in the reactor can be autogenous (i.e., the vapor pressure of water at the temperature of the reactor), can be hydraulic (i.e., the pressure caused by the pumping of a fluid against a restriction), or can result from the addition of an inert gas such as nitrogen or argon. Suitable batch hydrothermal reactors are available, for example, from Parr Instruments Co. (Moline, Ill., USA). Some suitable continuous hydrothermal reactors are described, for example, in U.S. Pat. No. 5,453,262 (Dawson et al.) and U.S. Pat. No. 5,652,192 (Matson et al.); Adschiri et al., J. Am. Ceram. Soc., 75, 1019-1022 (1992); and Dawson, Ceramic Bulletin, 67 (10), 1673-1678 (1988).

If a batch reactor is used to form zirconia-based particles, the temperature is often in the range of 160° C. to 275° C., in the range of 160° C. to 250° C., in the range of 170° C. to 250° C., in the range of 175° C. to 250° C., in the range of 200° C. to 250° C., in the range of 175° C. to 225° C., in the range of 180° C. to 220° C., in the range of 180° C. to 215° C., or in the range of 190° C. to 210° C. The feedstock is typically placed in the batch reactor at room temperature. The feedstock within the batch reactor is heated to the designated temperature and held at that temperature for at least 30 minutes, at least 1 hour, at least 2 hours, or at least 4 hours. The temperature can be held up to 24 hours, up to 20 hours, up to 16 hours, or up to 8 hours. For example, the temperature can be held in the range of 0.5 to 24 hours, in the range of 1 to 18 hours, in the range of 1 to 12 hours, or in the range of 1 to 8 hours. Any size batch reactor can be used. For example, the volume of the batch reactor can be in a range of several milliliters to several liters or more.

In many embodiments, the feedstock is passed through a continuous hydrothermal reactor. As used herein, the term “continuous” with reference to the hydrothermal reactor system means that the feedstock is continuously introduced and an effluent is continuously removed from the heated zone. The introduction of feedstock and the removal of the effluent typically occur at different locations of the reactor. The continuous introduction and removal can be constant or pulsed.

In many embodiments, the continuous hydrothermal reactor system contains a tubular reactor. As used herein, the term “tubular reactor” refers to the portion of the continuous hydrothermal reactor system that is heated (i.e., the heated zone). The shape of the tubular reactor is often selected based on the desired length of the tubular reactor and the method used to heat the tubular reactor. For example, the tubular reactor can be straight, U-shaped, or coiled. The interior portion of the tubular reactor can be empty or can contain baffles, balls, or other known mixing means. An example hydrothermal reactor system having a tubular reactor is described in PCT Patent Application Publication WO 2011/082031 (Kolb et al.).

In some embodiments, the tubular reactor has an interior surface that contains a fluorinated polymeric material. This fluorinated polymeric material can include, for example, a fluorinated polyolefin. In some embodiments, the polymeric material is polytetrafluoroethylene (PTFE) such as that available under the trade designation “TEFLON” from DuPont, Wilmington, Del., USA. Some tubular reactors have a PTFE hose within a metal housing such as a braided stainless steel housing. The carboxylic acid that may be present in the feedstock does not leach metals from such tubular reactors.

The dimensions of the tubular reactor can be varied and, in conjunction with the flow rate of the feedstock, can be selected to provide suitable residence times for the reactants within the tubular reactor. Any suitable length tubular reactor can be used provided that the residence time and temperature are sufficient to convert the zirconium in the feedstock to zirconia-based particles. The tubular reactor often has a length of at least 0.5 meter, at least 1 meter, at least 2 meters, at least 5 meters, at least 10 meters, at least 15 meters, at least 20 meters, at least 30 meters, at least 40 meters, or at least 50 meters. The length of the tubular reactor in some embodiments is less than 500 meters, less than 400 meters, less than 300 meters, less than 200 meters, less than 100 meters, less than 80 meters, less than 60 meters, less than 40 meters, or less than 20 meters.

Tubular reactors with a relatively small inner diameter are typically preferred. For example, tubular reactors having an inner diameter no greater than about 3 centimeters are often used because of the fast rate of heating of the feedstock that can be achieved with these reactors. Also, the temperature gradient across the tubular reactor is less for reactors with a smaller inner diameter compared to those with a larger inner diameter. The larger the inner diameter of the tubular reactor, the more this reactor resembles a batch reactor. However, if the inner diameter of the tubular reactor is too small, there is an increased likelihood of the reactor becoming plugged or partially plugged during operation resulting from deposition of material on the walls of the reactor. The inner diameter of the tubular reactor is often at least 0.1 centimeters, at least 0.15 centimeters, at least 0.2 centimeters, at least 0.3 centimeters, at least 0.4 centimeters, at least 0.5 centimeters, or at least 0.6 centimeters. In some embodiments, the diameter of the tubular reactor is no greater than 3 centimeters, no greater than 2.5 centimeters, no greater than 2 centimeters, no greater than 1.5 centimeters, or no greater than 1.0 centimeters. Some tubular reactors have an inner diameter in the range of 0.1 to 3.0 centimeters, in the range of 0.2 to 2.5 centimeters, in the range of 0.3 to 2 centimeters, in the range of 0.3 to 1.5 centimeters or in the range of 0.3 to 1 centimeters.

In a continuous hydrothermal reactor system, the temperature and the residence time are selected in conjunction with the tubular reactor dimensions to convert at least 90 mole percent of the zirconium in the feedstock to zirconia-based particles using a single hydrothermal treatment. That is, at least 90 mole percent of the dissolved zirconium in the feedstock is converted to zirconia-based particles within a single pass through the continuous hydrothermal reactor system.

Alternatively, a multiple step hydrothermal process can be used. For example, the feedstock can be subjected to a first hydrothermal treatment to form a zirconium-containing intermediate and a by-product such as a carboxylic acid. A second feedstock can be formed by removing at least a portion of the by-product of the first hydrothermal treatment from the zirconium-containing intermediate. The second feedstock can then be subjected to a second hydrothermal treatment to form a sol containing the zirconia-based particles. This process is further described in U.S. Pat. No. 7,241,437 (Davidson et al.).

If a two-step hydrothermal process is used, the percent conversion of the zirconium-containing intermediate is typically 40 to 75 mole percent. The conditions used in the first hydrothermal treatment can be adjusted to provide conversion within this range. Any suitable method can be used to remove at least part of the by-product of the first hydrothermal treatment. For example, carboxylic acids such as acetic acid can be removed by a variety of methods such as vaporization, dialysis, ion exchange, precipitation, and filtration.

When referring to a continuous hydrothermal reactor system, the term “residence time” means the average length of time that the feedstock is within the heated portion of the continuous hydrothermal reactor system. Any suitable flow rate of the feedstock through the tubular reactor can be used as long as the residence time is sufficiently long to convert the dissolved zirconium to zirconia-based particles. That is, the flow rate is often selected based on the residence time needed to convert the zirconium in the feedstock to zirconia-based particles. Higher flow rates are desirable for increasing throughput and for minimizing the deposition of materials on the walls of the tubular reactor. A higher flow rate can often be used when the length of the reactor is increased or when both the length and diameter of the reactor are increased. The flow through the tubular reactor can be either laminar or turbulent.

In some exemplary continuous hydrothermal reactors, the reactor temperature is in the range of 170° C. to 275° C., in the range of 170° C. to 250° C., in the range of 170° C. to 225° C., in the range of 180° C. to 225° C., in the range of 190° C. to 225° C., in the range of 200° C. to 225° C., or in the range of 200° C. to 220° C. If the temperature is greater than about 275° C., the pressure may be unacceptably high for some hydrothermal reactors systems. However, if the temperature is less than about 170° C., the conversion of the zirconium in the feedstock to zirconia-based particles may be less than 90 weight percent using typical residence times.

The effluent of the hydrothermal treatment (i.e., the product of the hydrothermal treatment) is a zirconia-based sol and can be referred to as the “sol effluent”. The sol effluent is a dispersion or suspension of the zirconia-based particles in the aqueous-based medium. The sol effluent contains at least 3 weight percent zirconia-based particles dispersed, suspended, or a combination thereof based on the weight of the sol. In some embodiments, the sol effluent contains at least 5 weight percent, at least 6 weight percent, at least 8 weight percent, or at least 10 weight percent zirconia-based particles based on the weight of the sol. The weight percent zirconia-based particles can be up to 16 weight percent or higher, up to 15 weight percent, up to 12 weight percent, or up to 10 weight percent.

The zirconia-based particles within the sol effluent are crystalline and have an average primary particle size no greater than 50 nanometers, no greater than 40 nanometers, no greater than 30 nanometers, no greater than 20 nanometers, no greater than 15 nanometers, or no greater than 10 nanometers. The zirconia-based particles typically have an average primary particle size that is at least 1 nanometer, at least 2 nanometers, at least 3 nanometers, at least 4 nanometers, or at least 5 nanometers.

The sol effluent usually contains non-associated zirconia-based particles. The sol effluent is typically clear or slightly cloudy. In contrast, zirconia-based sols that contain agglomerated or aggregated particles usually tend to have a milky or cloudy appearance. The sol effluent often has a high optical transmission due to the small size and non-associated form of the primary zirconia particles in the sol. High optical transmission of the sol effluent can be desirable in the preparation of transparent or translucent sintered articles. As used herein, “optical transmission” refers to the amount of light that passes through a sample (e.g., a sol effluent or casting sol) divided by the total amount of light incident upon the sample. The percent optical transmission may be calculated using the equation

100(I/I_{O})

where I is the light intensity passing though the sample and I_{O} is the light intensity incident on the sample. The optical transmission through the sol effluent is often related to the optical transmission through the casting sol (reaction mixture used to form the gel composition). Good transmission helps ensure that adequate curing occurs during the formation of the gel composition and provides a greater depth of cure within the gel composition.

The optical transmission may be determined using an ultraviolet/visible spectrophotometer set, for example, at a wavelength of 420 nanometers or 600 nanometers with a 1 centimeter path length. The optical transmission is a function of the amount of zirconia in a sol. For sol effluents containing about 1 weight percent zirconia, the optical transmission is typically at least 70 percent, at least 80 percent, at least 85 percent, or at least 90 percent at either 420 nanometers or 600 nanometers. For sol effluents containing about 10 weight percent zirconia, the optical transmission is typically at least 20 percent, at least 25 percent, at least 30 percent, at least 40 percent, at least 50 percent, or at least 70 percent at either 420 nanometers or 600 nanometers.

The zirconia-based particles in the sol effluent are crystalline and can be cubic, tetragonal, monoclinic, or a combination thereof. Because the cubic and tetragonal phases are difficult to differentiate using x-ray diffraction techniques, these two phases are typically combined for quantitative purposes and are referred to as the “cubic/tetragonal” phases. The percent cubic/tetragonal phase can be determined, for example, by measuring the peak area of the x-ray diffraction peaks for each phase and using the following equation.

% C/T=100(C/T)÷(C/T+M)

In this equation, “C/T” refers to the area of the diffraction peak for the cubic/tetragonal phase, “M” refers to the area of the diffraction peak for the monoclinic phase, and “% C/T” refers to the weight percent cubic/tetragonal crystalline phase. The details of the x-ray diffraction measurements are described further in the Example section below.

Typically, at least 50 weight percent of the zirconia-based particles in the sol effluent have a cubic structure, tetragonal structure, or a combination thereof. A greater content of the cubic/tetragonal phase is usually desired. The amount of cubic/tetragonal phase is often at least 60 weight percent, at least 70 weight percent, at least 75 weight percent, at least 80 weight percent, at least 85 weight percent, at least 90 weight percent, or at least 95 weight percent based on a total weight of all crystalline phases present in the zirconia-based particles.

For example, cubic/tetragonal crystals have been observed to be associated with the formation of low aspect ratio primary particles having a cube-like shape when viewed under an electron microscope. This particle shape tends to be relatively easily dispersed into a liquid matrix. Typically, the zirconia particles have an average primary particle size up to 50 nanometers although larger sizes may also be useful. For example, the average primary particle size can be up to 40 nanometers, up to 35 nanometers, up to 30 nanometers, up to 25 nanometers, up to 20 nanometers, up to 15 nanometers, or even up to 10 nanometers. The average primary particle size is often at least 1 nanometer, at least 2 nanometers, at least 3 nanometers, or at least 5 nanometers. The average primary particle size, which refers to the non-associated particle size of the zirconia particles, can be determined by x-ray diffraction as described in the Example section. Zirconia sols described herein typically have primary particle size in a range of 2 to 50 nanometers. In some embodiments, the average primary particle size is in a range of 5 to 50 nanometers, 2 to 40 nanometers, 5 to 40 nanometers, 2 to 25 nanometers, 5 to 25 nanometers, 2 to 20 nanometers, 5 to 20 nanometers, 2 to 15 nanometers, 5 to 15 nanometers, or 2 to 10 nanometers.

In some embodiments, the particles in the sol effluent are non-associated and the average particle size is the same as the primary particle size. In some embodiments, the particles are aggregated or agglomerated to a size up to 100 nanometers. The extent of association between the primary particles can be determined from the volume-average particle size. The volume-average particle size can be measured using Photon Correlation Spectroscopy as described in more detail in the Examples section below. Briefly, the volume distribution (percentage of the total volume corresponding to a given size range) of the particles is measured. The volume of a particle is proportional to the third power of the diameter. The volume-average size is the size of a particle that corresponds to the mean of the volume distribution. If the zirconia-based particles are associated, the volume-average particle size provides a measure of the size of the aggregate and/or agglomerate of primary particles. If the particles of zirconia are non-associated, the volume-average particle size provides a measure of the size of the primary particles. The zirconia-based particles typically have a volume-average size of up to 100 nanometers. For example, the volume-average size can be up to 90 nanometers, up to 80 nanometers, up to 75 nanometers, up to 70 nanometers, up to 60 nanometers, up to 50 nanometers, up to 40 nanometers, up to 30 nanometers, up to 25 nanometers, up to 20 nanometers, or up to 15 nanometers, or even up to 10 nanometers.

A quantitative measure of the degree of association between the primary particles in the sol effluent is the dispersion index. As used herein the “dispersion index” is defined as the volume-average particle size divided by the primary particle size. The primary particle size (e.g., the weighted average crystallite size) is determined using x-ray diffraction techniques and the volume-average particle size is determined using Photon Correlation Spectroscopy. As the association between primary particles decreases, the dispersion index approaches a value of 1 but can be somewhat higher or lower. The zirconia-based particles typically have a dispersion index in a range of from 1 to 7. For example, the dispersion index is often in a range 1 to 5, 1 to 4, 1 to 3, 1 to 2.5, or even 1 to 2.

Photon Correlation Spectroscopy also can be used to calculate the Z-average primary particle size. The Z-average size is calculated from the fluctuations in the intensity of scattered light using a cumulative analysis and is proportional to the sixth power of the particle diameter. The volume-average size will typically be a smaller value than the Z-average size. The zirconia-based particles tend to have a Z-average size that is up to 100 nanometers. For example, the Z-average size can be up to 90 nanometers, up to 80 nanometers, up to 70 nanometers, up to 60 nanometers, up to 50 nanometers, up to 40 nanometers, up to 35 nanometers, up to 30 nanometers, up to 20 nanometers, or even up to 15 nanometers.

Depending on how the zirconia-based particles are prepared, the particles may contain at least some organic material in addition to the inorganic oxides. For example, if the particles are prepared using a hydrothermal approach, there may be some organic material attached to the surface of the zirconia-based particles. Although not wanting to be bound by theory, it is believed that organic material originates from the carboxylate species (anion, acid, or both) included in the feedstock or formed as a byproduct of the hydrolysis and condensation reactions (i.e., organic material is often absorbed on the surface of the zirconia-based particles). For example, the zirconia-based particles contain up to 15 weight percent, up to 12 weight percent, up to 10 weight percent, up to 8 weight percent, or even up to 5 weight percent organic material based on a total weight of the zirconia-based particles.

The reaction mixture (casting sol) used to form the gel composition typically contains 20 to 60 weight percent zirconia-based particles based on a total weight of the reaction mixture. The amount of zirconia-based particles can be at least 25 weight percent, at least 30 weight percent, at least 35 weight percent, or at least 40 weight percent and can be up to 55 weight percent, up to 50 weight percent, or up to 45 weight percent. In some embodiments, the amount of the zirconia-based particles is in a range of 25 to 55 weight percent, 30 to 50 weight percent, 30 to 45 weight percent, 35 to 50 weight percent, 40 to 50 weight percent, or 35 to 45 weight percent based on the total weight of the reaction mixture used for the gel composition.

2. Solvent Medium

The sol effluent, which is the effluent from the hydrothermal reactor, contains the zirconia-based particles suspended in an aqueous medium. The aqueous medium is predominately water but can contain carboxylic acid and/or carboxylate anions. For the reaction mixture (casting sol) used to form the gel composition and the shaped gel article, the aqueous medium is replaced with a solvent medium that contains at least 60 weight percent of an organic solvent having a boiling point equal to at least 150° C. In some embodiments, the solvent medium contains at least 70 weight percent, at least 80 weight percent, at least 90 weight percent, at least 95 weight percent, at least 97 weight percent, at least 98 weight percent, or at least 99 weight percent of the organic solvent having a boiling point equal to at least 150° C. The boiling point is often at least 160° C., at least 170° C., at least 180° C., or at least 190° C.

Any suitable method can be used to replace the aqueous medium from the sol effluent with the solvent medium that is predominately the organic solvent having a boiling point equal to at least 150° C. In many embodiments, the sol effluent from the hydrothermal reactor system is concentrated to at least partially remove the water as well as the carboxylic acid and/or carboxylate anion. The aqueous medium is often concentrated using methods such as drying or vaporization, solvent exchange, dialysis, diafiltration, ultrafiltration, or a combination thereof.

In some embodiments, the sol effluent of the hydrothermal reactor is concentrated with a drying process. Any suitable drying method can be used such as spray drying or oven drying. For example, the sol effluent can be dried in a conventional oven at a temperature equal to at least 80° C., at least 90° C., at least 100° C., at least 110° C., or at least 120° C. The drying time is often greater than 1 hour, greater than 2 hours, or greater than 3 hours. The dried effluent can then be re-suspended in the organic solvent having a boiling point equal to at least 150° C.

In other embodiments, the sol effluent of the hydrothermal treatment can be subjected to ultrafiltration, dialysis, diafiltration, or a combination thereof to form a concentrated sol. Ultrafiltration provides concentration only. Dialysis and diafiltration both tend to remove at least a portion of the dissolved carboxylic acids and/or carboxylate anions in the sol effluent. For dialysis, a sample of the sol effluent can be positioned within a membrane bag that is closed and then placed within a water bath. The carboxylic acid and/or carboxylate anions diffuse out of the sample within the membrane bag. That is, these species will diffuse out of the sol effluent through the membrane bag into the water bath to equalize the concentration within the membrane bag to the concentration in the water bath. The water in the bath is typically replaced several times to lower the concentration of species within the bag. A membrane bag is typically selected that allows diffusion of the carboxylic acids and/or anions thereof but that does not allow diffusion of the zirconia-based particles out of the membrane bag.

For diafiltration, a permeable membrane is used to filter the sample. The zirconia particles can be retained by the filter if the pore size of the filter is appropriately chosen. The dissolved carboxylic acids and/or anions thereof pass through the filter. Any liquid that passes through the filter is replaced with fresh water. In a discontinuous diafiltration process, the sample is often diluted to a pre-determined volume and then concentrated back to the original volume by ultrafiltration. The dilution and concentration steps are repeated one or more times until the carboxylic acid and/or anions thereof are removed or lowered to an acceptable concentration level. In a continuous diafiltration process, which is often referred to as a constant volume diafiltration process, fresh water is added at the same rate that liquid is removed through filtration. The dissolved carboxylic acid and/or anions thereof are in the liquid that is removed.

While the majority of the inorganic oxides in the zirconia-based particles are incorporated into the crystalline material, there may be a fraction that can be removed during diafiltration or dialysis. The actual composition of the zirconia-based particles after diafiltration or dialysis may be different than in the sol effluent from the hydrothermal reactor or from the composition expected based on the various salts included in the feedstock for the hydrothermal reactor. For example, a sol effluent prepared to have a composition of 89.9/9.6/0.5 ZrO₂/Y₂O₃/La₂O₃ had the following composition after diafiltration: 90.6/8.1/0.24 ZrO₂/Y₂O₃/La₂O₃ and a sol effluent prepared to have a composition of 97.7/2.3 ZrO₂/Y₂O₃ had the same composition after diafiltration.

Through ultrafiltration, dialysis, diafiltration, or a combination thereof, the concentrated sol often has a weight percent solids equal to at least 10 weight percent, at least 20 weight percent, 25 weight percent or at least 30 weight percent and up 60 weight percent, up to 55 weight percent, up to 50 weight percent, or up to 45 weight percent solids. For example, the weight percent solids are often in a range of 10 to 60 weight percent, 20 to 50 weight percent, 25 to 50 weight percent, 25 to 45 weight percent, 30 to 50 weight percent, 35 to 50 weight percent, or 40 to 50 weight percent based on the total weight of the concentrated sol.

The carboxylic acid content (e.g., acetic acid content) of the concentrated sol is often at least 2 weight percent and can be up to 15 weight percent. In some embodiments, the carboxylic acid content is at least 3 weight percent, at least 5 weight percent and can be up to 12 weight percent, or up to 10 weight percent. For example, the carboxylic acid can be present in an amount in a range of 2 to 15 weight percent, 3 to 15 weight percent, 5 to 15 weight percent, or 5 to 12 weight percent based on the total weight of the concentrated sol.

Usually, most of the aqueous medium is removed from the concentrated sol prior to formation of the gel composition. Additional water is often removed using a solvent exchange process. For example, the organic solvent having a boiling point equal to at least 150° C. can be added to the concentrated sol; water plus any remaining carboxylic acid can be removed by distillation. A rotary evaporator is often used for the distillation process.

Suitable organic solvents that have a boiling point equal to 150° C. are typically selected to be miscible with water. Further, these organic solvents are often selected to be soluble in supercritical carbon dioxide or liquid carbon dioxide. The molecular weight of the organic solvent is usually at least 25 grams/mole, at least 30 grams/mole, at least 40 grams/mole, at least 45 grams/mole, at least 50 grams/mole, at least 75 grams/mole, or at least 100 grams/mole. The molecular weight can be up to 300 grams/mole or higher, up to 250 grams/mole, up to 225 grams/mole, up to 200 grams/mole, up to 175 grams/mole, or up to 150 grams/mole. The molecular weight is often in a range of 25 to 300 grams/mole, 40 to 300 grams/mole, 50 to 200 grams/mole, or 75 to 175 grams/mole.

The organic solvent is often a glycol or polyglycol, mono-ether glycol or mono-ether polyglycol, di-ether glycol or di-ether polyglycol, ether ester glycol or ether ester polyglycol, carbonate, amide, or sulfoxide (e.g., dimethyl sulfoxide). The organic solvents usually have one or more polar groups. The organic solvent does not have a polymerizable group; that is, the organic solvent is free of a group that can undergo free radical polymerization. Further, no component of the solvent medium has a polymerizable group that can undergo free radical polymerization.

Suitable glycols or polyglycols, mono-ether glycols or mono-ether polyglycols, di-ether glycols or di-ether polyglycols, and ether ester glycols or ether ester polyglycols are often of Formula (I).

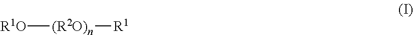

In Formula (I), each R¹ independently is hydrogen, alkyl, aryl, or acyl. Suitable alkyl groups often have 1 to 10 carbon atoms, 1 to 6 carbon atoms, or 1 to 4 carbon atoms. Suitable aryl groups often have 6 to 10 carbon atoms and are often phenyl or phenyl substituted with an alkyl group having 1 to 4 carbon atoms. Suitable acyl groups are often of formula —(CO)R^{a} where R^{a} is an alkyl having 1 to 10 carbon atoms, 1 to 6 carbon atoms, 1 to 4 carbon atoms, 2 carbon atoms, or 1 carbon atom. The acyl is often an acetate group (—(CO)CH₃). In Formula (I), each R² is typically ethylene or propylene. The variable n is at least 1 and can be in a range of 1 to 10, 1 to 6, 1 to 4, or 1 to 3.

Glycols or polyglycols of Formula (I) have two R¹ groups equal to hydrogen. Examples of glycols include, but are not limited to, ethylene glycol, propylene glycol, diethylene glycol, dipropylene glycol, triethylene glycol, and tripropylene glycol.

Mono-ether glycols or mono-ether polyglycols of Formula (I) have a first R¹ group equal to hydrogen and a second R¹ group equal to alkyl or aryl. Examples of mono-ether glycols or mono-ether polyglycols include, but are not limited to, ethylene glycol monohexyl ether, ethylene glycol monophenyl ether, propylene glycol monobutyl ether, diethylene glycol monomethyl ether, diethylene glycol monoethyl ether, diethylene glycol monopropyl ether, diethylene glycol monobutyl ether, diethylene glycol monohexyl ether, dipropylene glycol monomethyl ether, dipropylene glycol monoethyl ether, dipropylene glycol monopropyl ether, triethylene glycol monomethyl ether, triethylene glycol monoethyl ether, triethylene glycol monobutyl ether, tripropylene glycol monomethyl ether, and tripropylene glycol monobutyl ether.

Di-ether glycols or di-ether polyglycols of Formula (I) have two R¹ group equal to alkyl or aryl. Examples of di-ether glycols or di-ether polyglycols include, but are not limited to, ethylene glycol dipropyl ether, ethylene glycol dibutyl ether, dipropylene glycol dibutyl ether, diethylene glycol dimethyl ether, diethylene glycol diethyl ether, triethylene glycol dimethyl ether, tetraethylene glycol dimethyl ether, and pentaethylene glycol dimethyl ether.

Ether ester glycols or ether ester polyglycols of Formula (I) have a first R¹ group equal to an alkyl or aryl and a second R¹ group equal to an acyl. Examples of ether ester glycols or ether ester polyglycols include, but are not limited to, ethylene glycol butyl ether acetate, diethylene glycol butyl ether acetate, and diethylene glycol ethyl ether acetate.

Other suitable organic solvents are carbonates of Formula (II).

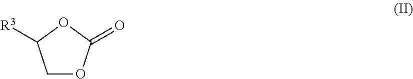

In Formula (II), R³ is hydrogen or an alkyl such as an alkyl having 1 to 4 carbon atoms, 1 to 3 carbon atoms, or 1 carbon atom. Examples include ethylene carbonate and propylene carbonate.

Yet other suitable organic solvents are amides of Formula (III).

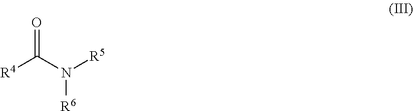

In Formula (III), group R⁴ is hydrogen, alkyl, or combines with R⁵ to form a five-membered ring including the carbonyl attached to R⁴ and the nitrogen atom attached to R⁵. Group R⁵ is hydrogen, alkyl, or combines with R⁴ to form a five-membered ring including the carbonyl attached to R⁴ and the nitrogen atom attached to R⁵. Group R⁶ is hydrogen or alkyl. Suitable alkyl groups for R⁴, R⁵, and R⁶ have 1 to 6 carbon atoms, 1 to 4 carbon atoms, 1 to 3 carbon atoms, or 1 carbon atom. Examples of amide organic solvents of Formula (III) include, but are not limited to, formamide, N,N-dimethylformamide, N,N-dimethylacetamide, N,N-diethylacetamide, N-methyl-2-pyrrolidone, and N-ethyl-2-pyrrolidone.

The solvent medium typically contains less than 15 weight percent water, less than 10 percent water, less than 5 percent water, less than 3 percent water, less than 2 percent water, less than 1 weight percent, or even less than 0.5 weight percent water after the solvent exchange (e.g., distillation) process.

The reaction mixture often includes at least 30 weight percent solvent medium. In some embodiments, the reaction mixture contains at least 35 weight percent, or at least 40 weight percent solvent medium. The reaction mixture can contain up to 75 weight percent, up to 70 weight percent, up to 65 weight percent, up to 60 weight percent, up to 55 weight percent, up to 50 weight percent, or up to 45 weight percent solvent medium. For example, the reaction mixture can contain 30 to 75 weight percent, 30 to 70 weight percent, 30 to 60 weight percent, 30 to 50 weight percent, 30 to 45 weight percent, 35 to 60 weight percent, 35 to 55 weight percent, 35 to 50 weight percent, or 40 to 50 weight percent solvent medium. The weight percent values are based on the total weight of the reaction mixture.

An optional surface modification agent (which can be referred to as a non-polymerizable surface modification agent) is often dissolved in the organic solvent prior to the solvent exchange process. The optional surface modification agent typically is free of a polymerizable group that can undergo free radical polymerization reactions. The optional surface modification agent is usually a carboxylic acid or salt thereof, sulfonic acid or salt thereof, phosphoric acid or salt thereof, phosphonic acid or salt thereof, or silane that can attach to a surface of the zirconia-based particles. In many embodiments, the optional surface modification agents are carboxylic acids that do not contain a polymerizable group that can undergo a free radical polymerization reaction.

In some embodiments, the optional non-polymerizable surface modification agent is a carboxylic acid and/or anion thereof and has a compatibility group that imparts a polar character to the zirconia-based nanoparticles. For example, the surface modification agent can be a carboxylic acid and/or anion thereof having an alkylene oxide or polyalkylene oxide group. In some embodiments, the carboxylic acid surface modification agent is of the following formula.

H₃CO—[(CH₂)_{y}O]_{z}-Q-COOH

In this formula, Q is a divalent organic linking group, z is an integer in the range of 1 to 10, and y is an integer in the range of 1 to 4. The group Q includes at least one alkylene group or arylene group and can further include one or more oxy, thio, carbonyloxy, carbonylimino groups. Representative examples of this formula include, but are not limited to, 2-[2-(2-methoxyethoxy)ethoxy]acetic acid (MEEAA) and 2-(2-methoxyethoxy)acetic acid (MEAA). Still other representative carboxylic acids are the reaction product of an aliphatic anhydride and a polyalkylene oxide mono-ether such as succinic acid mono-[2-(2-methoxy-ethoxy)-ethyl] ester, and glutaric acid mono-[2-(2-methoxy-ethoxy)-ethyl] ester.

In other embodiments, the optional non-polymerizable surface modification agent is a carboxylic acid and/or anion thereof and the compatibility group can impart a non-polar character to the zirconia-containing nanoparticles. For example, the surface modification agent can be a carboxylic acid of formula R^{c}—COOH or a salt thereof where R^{c} is an alkyl group having at least 5 carbon atoms, at least 6 carbon atoms, at least 8 carbon atoms, or at least 10 carbon atoms. R^{c} often has up to 20 carbon atoms, up to 18 carbon atoms, or up to 12 carbon atoms. Representative examples include octanoic acid, lauric acid, dodecanoic acid, stearic acid, and combinations thereof.

In addition to modifying the surface of the zirconia-based particles to minimize the likelihood of agglomeration and/or aggregation when the sol is concentrated, the optional non-polymerizable surface modification agent can be used to adjust the viscosity of the sol.

Any suitable amount of the optional non-polymerizable surface modification agent can be used. If present, the optional non-polymerizable surface modification agent usually is added in an amount equal to at least 0.5 weight percent based on the weight of the zirconia-based particles. For example, the amount can be equal to at least 1 weight percent, at least 2 weight percent, at least 3 weight percent, at least 4 weight percent, or at least 5 weight percent and can be up to 15 weight percent or more, up to 12 weight percent, up to 10 weight percent, up to 8 weight percent, or up to 6 weight percent. The amount of the optional non-polymerizable surface modification agent is typically in a range of 0 to 15 weight percent, 0.5 to 15 weight percent, 0.5 to 10 weight percent, 1 to 10 weight percent, or 3 to 10 weight percent based on the weight of the zirconia-based particles.

Stated differently, the amount of the optional non-polymerizable surface modification agent is often in a range of 0 to 10 weight percent based on a total weight of the reaction mixture. The amount is often at least 0.5 weight percent, at least 1 weight percent, at least 2 weight percent, or at least 3 weight percent and can be up to 10 weight percent, up to 8 weight percent, up to 6 weight percent, or up to 5 weight percent based on the total weight of the reaction mixture.

3. Polymerizable Material

The reaction mixture includes one or more polymerizable materials that have a polymerizable group that can undergo free radical polymerization (i.e., the polymerizable group is free radical polymerizable). In many embodiments, the polymerizable group is an ethylenically unsaturated group such as a (meth)acryloyl group, which is a group of formula —(CO)—CR^{b}═CH₂ where R^{b} is hydrogen or methyl. In some embodiments, the polymerizable group is a vinyl group (—CH═CH₂) that is not a (meth)acryloyl group. The polymerizable material is usually selected so that it is soluble in or miscible with the organic solvent having a boiling point equal to at least 150° C.

The polymerizable material includes a first monomer that is a surface modification agent having a free radical polymerizable group. The first monomer typically modifies the surface of the zirconia-based particles. Suitable first monomers have a surface modifying group that can attach to a surface of the zirconia-based particles. The surface modifying group is usually a carboxyl group (—COOH or an anion thereof) or a silyl group of formula —Si(R⁷)ₓ(R⁸)₃₋ₓ where R⁷ is a non-hydrolyzable group, R⁸ is hydroxyl or a hydrolyzable group, and the variable x is an integer equal to 0, 1, or 2. Suitable non-hydrolyzable groups are often alkyl groups such as those having 1 to 10, 1 to 6, 1 to 4, or 1 to 2 carbon atoms. Suitable hydrolyzable groups are often a halo (e.g., chloro), acetoxy, alkoxy group having 1 to 10, 1 to 6, 1 to 4, or 1 to 2 carbon atoms, or group of formula —OR^{d}—OR^{e} where R^{d} is an alkylene having 1 to 4 or 1 to 2 carbon atoms and R^{e} is an alkyl having 1 to 4 or 1 to 2 carbon atoms.

In some embodiments, the first monomer has a carboxyl group. Examples of first monomers with a carboxyl group include, but are not limited to, (meth)acrylic acid, itaconic acid, maleic acid, crotonic acid, citraconic acid, oleic acid, and beta-carboxyethyl acrylate. Other examples of first monomers having a carboxyl group are the reaction product of hydroxyl-containing polymerizable monomers with a cyclic anhydride such as maleic anhydride, succinic anhydride, or phthalic anhydride. Suitable hydroxyl-containing polymerizable monomers include, for example, hydroxyethyl (meth)acrylate, hydroxypropyl (meth)acrylate, and hydroxybutyl (meth)acrylate. A specific example of these reaction products include, but are not limited to, mono-2-(methacryloxyethyl)succinate (e.g., this is often called hydroxyethyl acrylate succinate). In many embodiments, the first monomer is a (meth)acrylic acid.

In other embodiments, the first monomer has a silyl group of formula —Si(R⁷)ₓ(R⁸)₃₋ₓ. Examples of first monomers with a silyl group include, but are not limited to, (meth)acryloxyalkyltrialkoxysilanes (e.g., 3-(meth)acryloxypropyltrimethoxysilane, and 3-(meth)acryloxypropyltriethoxysilane), (meth)acryloxyalkylalkyldialkoxysilanes (e.g., 3-(meth)acryloxypropylmethyldimethoxysilane), (meth)acrloxyalkyldialkylalkoxysilane (e.g., 3-(meth)acryloxypropyldimethylethoxysilane), styrylalkyltrialkoxysilane (e.g., styrylethyltrimethoxysilane), vinyl trialkoxysilane (e.g., vinyltrimethoxysilane, vinyltriethoxysilane, and vinyltriisopropoxysilane), vinylalkyldialkoxysilanes (e.g., vinylmethyldiethoxylsilane), and vinyldialkylalkoxysilane (e.g., vinyldimethylethoxysilane), vinyltriacetoxysilane, vinylalkyldiacetoxysilane (e.g., vinylmethyldiacetoxysilane), and vinyltris(alkoxyalkoxy)silane (e.g., vinyltris(2-methoxyethoxy)silane).

The first monomer can function as a polymerizable surface modification agent. Multiple first monomers can be used. The first monomer can be the only kind of surface modification agent or can be combined with one or more non-polymerizable surface modification agents such as those discussed above. In some embodiments, the amount of the first monomer is at least 20 weight percent based on a total weight of polymerizable material. For example, the amount of the first monomer is often at least 25 weight percent, at least 30 weight percent, at least 35 weight percent, or at least 40 weight percent. The amount of the first monomer can be up to 100 percent, up to 90 weight percent, up to 80 weight percent, up to 70 weight percent, up to 60 weight percent, or up to 50 weight percent. Some reaction mixtures contain 20 to 100 weight percent, 20 to 80 weight percent, 20 to 60 weight percent, 20 to 50 weight percent, or 30 to 50 weight percent of the first monomer based on a total weight of polymerizable material.

The first monomer (i.e., the polymerizable surface modification monomer) can be the only monomer in the polymerizable material or can be combined with one or more second monomers that are soluble in the solvent medium. Any suitable second monomer that does not have a surface modification group can be used. That is, the second monomer does not have a carboxyl group or a silyl group. The second monomers are often polar monomers (e.g., non-acidic polar monomers), monomers having a plurality of polymerizable groups, alkyl (meth)acrylates, and mixtures thereof.

The overall composition of the polymerizable material is often selected so that the polymerized material is soluble in the solvent medium. Homogeneity of the organic phase is often preferable to avoid phase separation of the organic component in the gel composition. This tends to result in the formation of smaller and more homogeneous pores (pores with a narrower size distribution) in the subsequently formed xerogel or aerogel. Further, the overall composition of the polymerizable material can be selected to adjust compatibility with the solvent medium and to adjust the strength, flexibility, and uniformity of the gel composition. Still further, the overall composition of the polymerizable material can be selected to adjust the burnout characteristics of the organic material prior to sintering.

In many embodiments, the second monomer includes a monomer having a plurality of polymerizable groups. The number of polymerizable groups can be in a range of 2 to 6 or even higher. In many embodiments, the number of polymerizable groups is in a range of 2 to 5 or 2 to 4. The polymerizable groups are typically (meth)acryloyl groups.

Exemplary monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary monomers with three or four (meth)acryloyl groups include, but are not limited to, trimethylolpropane triacrylate (e.g., commercially available under the trade designation TMPTA-N from Cytec Industries, Inc. (Smyrna, Ga., USA) and under the trade designation SR-351 from Sartomer (Exton, Pa., USA)), pentaerythritol triacrylate (e.g., commercially available under the trade designation SR-444 from Sartomer), ethoxylated (3) trimethylolpropane triacrylate (e.g., commercially available under the trade designation SR-454 from Sartomer), ethoxylated (4) pentaertythriol tetraacrylate (e.g., commercially available under the trade designation SR-494 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), and di-trimethylolpropane tetraacrylate (e.g., commercially available under the trade designation SR-355 from Sartomer).

Exemplary monomers with five or six (meth)acryloyl groups include, but are not limited to, dipentaerythritol pentaacrylate (e.g., commercially available under the trade designation SR-399 from Sartomer) and a hexa-functional urethane acrylate (e.g., commercially available under the trade designation CN975 from Sartomer).

Some polymerizable compositions contain 0 to 80 weight percent of a monomer having a plurality of polymerizable groups based on a total weight of the polymerizable material. For example, the amount can be in a range of 10 to 80 weight percent, 20 to 80 weight percent, 30 to 80 weight percent, 40 to 80 weight percent, 10 to 70 weight percent, 10 to 50 weight percent, 10 to 40 weight percent, or 10 to 30 weight percent. The presence of the monomer having a plurality of polymerizable groups tends to enhance the strength of the gel composition formed when the reaction mixture is polymerized. Such gel compositions can be easier to remove from the mold without cracking. The amount of the monomer with a plurality of the polymerizable groups can be used to adjust the flexibility and the strength of the gel composition.

In some embodiments, the optional second monomer is a polar monomer. As used herein, the term “polar monomer” refers to a monomer having a free radical polymerizable group and a polar group. The polar group is typically non-acidic and often contains a hydroxyl group, a primary amido group, a secondary amido group, a tertiary amido group, an amino group, or an ether group (i.e., a group containing at least one alkylene-oxy-alkylene group of formula —R—O—R— where each R is an alkylene having 1 to 4 carbon atoms).

Suitable optional polar monomers having a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), and hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, Pa., USA) under the trade designation CD570, CD571, and CD572), and aryloxy substituted hydroxyalkyl (meth)acrylates (e.g., 2-hydroxy-2-phenoxypropyl (meth)acrylate).

Exemplary polar monomers with a primary amido group include (meth)acrylamide. Exemplary polar monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Exemplary polar monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

Exemplary polar monomers with an ether group include, but are not limited to, alkoxylated alkyl (meth)acrylates such as ethoxyethoxyethyl (meth)acrylate, 2-methoxyethyl (meth)acrylate, and 2-ethoxyethyl (meth)acrylate; and poly(alkylene oxide) (meth)acrylates such as poly(ethylene oxide) (meth)acrylates, and poly(propylene oxide) (meth)acrylates. The poly(alkylene oxide) acrylates are often referred to as poly(alkylene glycol) (meth)acrylates. These monomers can have any suitable end group such as a hydroxyl group or an alkoxy group. For example, when the end group is a methoxy group, the monomer can be referred to as methoxy poly(ethylene glycol) (meth)acrylate.

Suitable alkyl (meth)acrylates that can be used as a second monomer can have an alkyl group with a linear, branched, or cyclic structure. Examples of suitable alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, 3,3,5-trimethylcyclohexyl (meth)acrylate, n-decyl (meth)acrylate, isodecyl (meth)acrylate, isobornyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate.

The amount of a second monomer that is a polar monomer and/or an alkyl (meth)acrylate monomer is often in a range of 0 to 40 weight percent, 0 to 35 weight percent, 0 to 30 weight percent, 5 to 40 weight percent, or 10 to 40 weight percent based on a total weight of the polymerizable material.

Overall, the polymerizable material typically contains 20 to 100 weight percent first monomer and 0 to 80 weight percent second monomer based on a total weight of polymerizable material. For example, polymerizable material includes 30 to 100 weight percent first monomer and 0 to 70 weight percent second monomer, 30 to 90 weight percent first monomer and 10 to 70 weight percent second monomer, 30 to 80 weight percent first monomer and 20 to 70 weight percent second monomer, 30 to 70 weight percent first monomer and 30 to 70 weight percent second monomer, 40 to 90 weight percent first monomer and 10 to 60 weight percent second monomer, 40 to 80 weight percent first monomer and 20 to 60 weight percent second monomer, 50 to 90 weight percent first monomer and 10 to 50 weight percent second monomer, or 60 to 90 weight percent first monomer and 10 to 40 weight percent second monomer.

In some applications, it can be advantageous to minimize the weight ratio of polymerizable material to zirconia-based particles in the reaction mixture. This tends to reduce the amount of decomposition products of organic material that needs to be burned out prior to formation of the sintered article. The weight ratio of polymerizable material to zirconia-based particles is often at least 0.05, at least 0.08, at least 0.09, at least 0.1, at least 0.11, or at least 0.12. The weight ratio of polymerizable material to zirconia-based particles can be up to 0.80, up to 0.6, up to 0.4, up to 0.3, up to 0.2, or up to 0.1. For example, the ratio can be in a range of 0.05 to 0.8, 0.05 to 0.6, 0.05 to 0.4, 0.05 to 0.2, 0.05 to 0.1, 0.1 to 0.8, 0.1 to 0.4, or 0.1 to 0.3.

4. Photoinitiator

The reaction mixture used to form the gel composition contains a photoinitiator. The reaction mixtures advantageously are initiated by application of actinic radiation. That is, the polymerizable material is polymerized using a photoinitiator rather than a thermal initiator. Surprisingly, the use of a photoinitiator rather than a thermal initiator tends to result in a more uniform cure throughout the gel composition ensuring uniform shrinkage in subsequent steps involved in the formation of sintered articles. In addition, the outer surface of the cured part is more uniform and more defect free when a photoinitiator is used rather than a thermal initiator.

Photoinitiated polymerization reactions often lead to shorter curing times and fewer concerns about competing inhibition reactions compared to thermally initiated polymerization reactions. The curing times can be more easily controlled than with thermal initiated polymerization reactions that must be used with opaque reaction mixtures.

In most embodiments, the photoinitiators are selected to respond to ultraviolet and/or visible radiation. Stated differently, the photoinitiators usually absorb light in a wavelength range of 200 to 600 nanometers, 300 to 600 nanometers, or 300 to 450 nanometers. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Florham Park, N.J., USA) or under the trade designation ESACURE KB-1 from Sartomer (Exton, Pa., USA)). Other exemplary photoinitiators are substituted benzophenones such as 1-hydroxycyclohexyl benzophenone (available, for example, under the trade designation “IRGACURE 184” from Ciba Specialty Chemicals Corp., Tarrytown, N.Y.). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include camphorquinone, 1-hydroxycyclohexyl phenyl ketone (IRGACURE 184), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173).

The photoinitiator is typically present in an amount in the range of 0.01 to 5 weight percent, in the range of 0.01 to 3 weight percent, 0.01 to 1 weight percent, or 0.01 to 0.5 weight percent based on a total weight of polymerizable material in the reaction mixture.

5. Inhibitors

The reaction mixture used to form the gel composition can include an optional inhibitor. The inhibitor can help prevent undesirable side reactions and can help moderate the polymerization reaction. Suitable inhibitors are often 4-hydroxy-TEMPO (4-hydroxy-2,2,6,6-tetramethylpiperidinyloxy) or a phenol derivative such as, for example, butylhydroxytoluene or p-methoxyphenol. The inhibitor is often used in an amount in a range of 0 to 0.5 weight percent based on the weight of polymerizable materials. For example, the inhibitor can be present in an amount equal to at least 0.001 weight percent, at least 0.005 weight percent, at least 0.01 weight percent. The amount can be up to 1 weight percent, up to 0.5 weight percent, or up to 0.1 weight percent.

### Gel Compositions

A gel composition is provided that includes a polymerized product of the reaction mixture (i.e., casting sol) described above. That is, the gel composition is a polymerized product of a reaction mixture that includes (a) 20 to 60 weight percent zirconia-based particles based on a total weight of the reaction mixture, the zirconia-based particles having an average particle size no greater than 100 nanometers and comprising at least 70 mole percent ZrO₂, (b) 30 to 75 weight percent of a solvent medium, the solvent medium comprising at least 60 percent of an organic solvent having a boiling point equal to at least 150° C., (c) 2 to 30 weight percent polymerizable material based on a total weight of the reaction mixture, the polymerizable material comprising a first surface modification agent having a free radical polymerizable group; and (d) a photoinitiator for a free radical polymerization reaction.

The reaction mixture is typically placed into a mold. Thus, an article is provided that includes (a) a mold having a mold cavity and (b) a reaction mixture positioned within the mold cavity and in contact with a surface of the mold cavity. The reaction mixture is the same as described above.

Each mold has at least one mold cavity. The reaction mixture is typically exposed to ultraviolet and/or visible radiation while in contact with a surface of the mold cavity. The polymerizable material within the reaction mixture undergoes free radical polymerization. Because the first monomer functions as a surface modification agent for the zirconia-based particles within the reaction mixture and is attached to a surface of the zirconia-based particles, polymerization results in the formation of a three-dimensional gel composition that binds together zirconia-based particles. This usually leads to a strong and resilient gel composition. This also can lead to homogeneous gel compositions with small pore sizes that can be sintered at relatively lower temperatures.

The gel composition is formed within a mold cavity. Thus, an article is provided that includes (a) a mold having a mold cavity and (b) a gel composition positioned within the mold cavity and in contact with a surface of the mold cavity. The gel composition includes a polymerized product of a reaction mixture and the reaction mixture is the same as described above.

Because the gel composition is formed within a mold cavity, it takes on a shape defined by the mold cavity. That is, a shaped gel article is provided that is a polymerized product of a reaction mixture, wherein the reaction mixture is positioned within a mold cavity during polymerization and wherein the shaped gel article retains both a size and shape identical to the mold cavity (except in regions where the mold cavity was overfilled) when removed from the mold. The reaction mixture is the same as described above.

The reaction mixture (casting sol) typically allows transmission of ultraviolet/visible radiation. The percent transmission of a casting sol composition containing 40 weight percent zirconia-based particles is typically at least 5 percent when measured at 420 nanometers in a 1 centimeter sample cell (i.e., the spectrophotometer has a 1 centimeter path length). In some examples, the percent transmission under these same conditions is at least 7 percent, at least 10 percent and can be up to 20 percent or higher, up to 15 percent, or up to 12 percent. The percent transmission of a casting sol composition containing 40 weight percent zirconia-based particles is typically at least 20 percent when measured at 600 nanometers in a 1 centimeter sample cell. In some examples, the percent transmission under these same conditions is at least 30 percent, at least 40 percent and can be up to 80 percent or higher, up to 70 percent, or up to 60 percent. The reaction mixture is translucent and not opaque. In some embodiments, the cured gel compositions are translucent.

The transmission of the ultraviolet/visible radiation should be sufficiently high to form a gel composition that is uniform. The transmission should be sufficient to allow polymerization to occur uniformly throughout the mold cavity. That is, percent cure should be uniform or fairly uniform throughout the gel composition formed within the mold cavity. The depth of cure is often at least 5 millimeters, at least 10 millimeters, or at least 20 millimeters when cured for 12 minutes as described below in the Example section within a chamber having eight UV/visible lamps and using 0.2 weight percent photoinitiator based on the weight of the inorganic oxides.

The reaction mixture (casting sol) typically has a viscosity that is sufficiently low so that it can effectively fill small, complex features of a mold cavity. In many embodiments, the reaction mixtures have viscosities that are Newtonian or nearly Newtonian. That is, the viscosity is independent of shear rate or has only a slight dependence on shear rate. The viscosity can vary depending on the percent solids of the reaction mixture, the size of the zirconia-based particles, the composition of the solvent medium, the presence or absence of optional non-polymerizable surface modification agents, and the composition of the polymerizable material. In some embodiments, the viscosity is at least 2 centipoises, at least 5 centipoises, at least 10 centipoises, at least 25 centipoises, at least 50 centipoises, at least 100 centipoises, at least 150 centipoises, or at least 200 centipoises. The viscosity can be up to 500 centipoises, up to 300 centipoises, up to 200 centipoises, up to 100 centipoises, up to 50 centipoises, up to 30 centipoises, or up to 10 centipoises. For example, the viscosity can be in a range of 2 to 500 centipoises, 2 to 200 centipoises, 2 to 100 centipoises, 2 to 50 centipoises, 2 to 30 centipoises, 2 to 20 centipoises, or 2 to 10 centipoises.

The combination of low viscosity and small particle size of the zirconia-based particles advantageously allows the reaction mixture (casting sol) to be filtered before polymerization. The reaction mixture is often filtered prior to placement within the mold cavity. Filtering can be beneficial for removal of debris and impurities that can negatively impact the properties of the gel composition and properties of the sintered article such as optical transmission and strength. Suitable filters often retain material having a size greater than 0.22 micrometers, greater than 0.45 micrometers, greater than 1 micrometer, greater than 2 micrometers, or greater than 5 micrometers. Traditional ceramic molding compositions cannot be easily filtered due to particle size and/or viscosity.

In some embodiments, the mold has multiple mold cavities or multiple molds with a single mold cavity can be arranged to form a belt, sheet, continuous web or die that can be used in a continuous process of preparing shaped gel articles.

The mold can be constructed of any material commonly used for a mold. That is, the mold can be fabricated from a metallic material including an alloy, ceramic material, glass, quartz, or polymeric material. Suitable metallic materials include, but are not limited to nickel, titanium, chromium, iron, carbon steel, and stainless steel. Suitable polymeric materials include, but are not limited to, a silicone, polyester, polycarbonate, poly(ether sulfone), poly(methyl methacrylate), polyurethane, polyvinylchloride, polystyrene, polypropylene, or polyethylene. In some cases, the entire mold is constructed of one or more polymeric materials. In other cases, only the surfaces of the mold that are designed to contact the casting sol, such as the surface of the one or more mold cavities, are constructed of one or more polymeric materials. For example, when the mold is made from metal, glass, ceramic, or the like, one or more surfaces of the mold can optionally have a coating of a polymeric material.

The mold having one or more mold cavities can be replicated from a master tool. The master tool can have a pattern that is the inverse of the pattern that is on the working mold in that the master tool can have protrusions that correspond to the cavities on the mold. The master tool can be made of metal, such as nickel or an alloy thereof. To make the mold, a polymeric sheet can be heated and placed next to the master tool. The polymeric sheet can then be pushed against the master tool to emboss the polymeric sheet, thereby forming a working mold. It is also possible to extrude or cast one or more polymeric materials onto a master tool to prepare the working mold. Many other types of mold materials, such as metal, can be embossed by a master tool in a similar manner. Disclosures related to forming working molds from master tools include U.S. Pat. No. 5,125,917 (Pieper), U.S. Pat. No. 5,435,816 (Spurgeon), U.S. Pat. No. 5,672,097 (Hoopman), U.S. Pat. No. 5,946,991 (Hoopman), U.S. Pat. No. 5,975,987 (Hoopman), and U.S. Pat. No. 6,129,540 (Hoopman).

The mold cavity can have any desired three-dimensional shape. Some molds have a plurality of uniform mold cavities with the same size and shape. The mold cavity can have a surface that is smooth (i.e., lacking features) or can have features of any desired shape and size. The resulting shaped gel articles can replicate the features of the mold cavity even if the dimensions are quite small. This is possible because of the relatively low viscosity of the reaction mixture (casting sol) and the use of zirconia-based particles having an average particle size no greater than 100 nanometers. For example, the shaped gel article can replicate features of the mold cavity that have a dimension less than 100 micrometers, less than 50 micrometers, less than 20 micrometers, less than 10 micrometers, less than 5 micrometers, or less than 1 micrometer.

The mold cavity has at least one surface that allows transmission of ultraviolet and/or visible radiation to initiate the polymerization of the reaction mixture within the mold cavity. In some embodiments, this surface is selected to be constructed of a material that will transmit at least 50 percent, at least 60 percent, at least 70 percent, at least 80 percent, at least 90 percent, or at least 95 percent of the incident ultraviolet and/or visible radiation. Higher transmission may be needed as the thickness of the molded part increases. The surface is often glass or a polymeric material such as polyethylene terephthalate, poly(methyl methacrylate), or polycarbonate.

In some cases, the mold cavity is free of a release agent. This can be beneficial because it can help ensure that the contents of the mold stick to the mold walls and maintain the shape of the mold cavity. In other cases, release agents can be applied to the surfaces of the mold cavity to ensure clean release of the shaped gel article from the mold.

The mold cavity, whether coated with mold release agent or not, can be filled with the reaction mixture (casting sol). The reaction mixture can be placed into the mold cavity by any suitable methods. Examples of suitable methods include pumping through a hose, using a knife roll coater, or using a die such as a vacuum slot die. A scraper or leveler bar can be used to force the reaction mixture into the one or more cavities, and to remove any of the reaction mixture that does not fit into the mold cavity. Any portion of reaction mixture that does not fit into the one or more mold cavities can be recycled and used again later, if desired. In some embodiments, it may be desirable to form a shaped gel article that is formed from multiple adjacent mold cavities. That is, it may be desirable to allow the reaction mixture to cover a region between two mold cavities to form a desired shaped gel article.

Because of its low viscosity, the casting sol can effectively fill small crevices or small features in the mold cavity. These small crevices or features can be filled even at low pressures. The mold cavity can have a smooth surface or can have a complex surface with one or more features. The features can have any desired shape, size, regularity, and complexity. The casting sol can typically flow effectively to cover the surface of the mold cavity regardless of the complexity of the shape of the surface. The casting sol is usually in contact with all surfaces of the mold cavity.

Dissolved oxygen can be removed from the reaction mixture, either before the reaction mixture is placed within the mold or while the reaction mixture is in the mold cavity. This can be achieved by vacuum degassing or purging with an inert gas such as nitrogen or argon. Removing dissolved oxygen can reduce the occurrence of unwanted side reactions, particularly unwanted reactions that involve oxygen. Because such side reactions are not necessarily detrimental to the product, and do not occur in all circumstances, removing dissolved oxygen is not required.

Polymerization of the reaction mixture occurs upon exposure to ultraviolet and/or visible radiation and results in the formation of a gel composition, which is a polymerized (cured) product of the reaction mixture. The gel composition is a shaped gel article having a shape that is the same as the mold (e.g., the mold cavity). The gel composition is a solid or semi-solid matrix with liquid entrapped therein. The solvent medium in the gel composition is mainly the organic solvent having a boiling point equal to at least 150° C.

Due to the homogeneous nature of the casting sol and the use of ultraviolet/visible radiation to cure the polymeric material, the resulting gel composition tends to have a homogeneous structure. This homogeneous structure advantageously leads to isotropic shrinkage during further processing to form a sintered article.

The reaction mixture (casting sol) typically cures (i.e., polymerizes) with little or no shrinkage. This is beneficial for maintaining the fidelity of the gel composition relative to the mold. Without being bound by theory, it is believed that the low shrinkage may be contributable to the combination of high solvent medium concentrations in the gel compositions as well as the bonding of the zirconia-based particles together through the polymerized surface modification agent that is attached to the surface of the particles.

Preferably, the gelation process (i.e., the process of forming the gel composition) allows the formation of shaped gel articles of any desired size that can then be processed without inducing crack formation. For example, preferably the gelation process leads to a shaped gel article having a structure that will not collapse when removed from the mold. Preferably, the shaped gel article is stable and sufficiently strong to withstand drying and sintering.

### Formation of Xerogel or Aerogel

After polymerization, the shaped gel article is removed from the mold cavity and the shaped gel article is treated to remove the organic solvent having a boiling point equal to at least 150° C. and any other organic solvents or water that may be present. This can be referred to as drying the gel composition or the shaped gel article regardless of the method used to remove the organic solvent.

In some embodiments, removal of the organic solvent occurs by drying the shaped gel article at room temperature (e.g., 20° C. to 25° C.) or at an elevated temperature. Any desired drying temperature up to 200° C. can be used. If the drying temperature is higher, the rate of organic solvent removal may be too rapid and cracking can result. The temperature is often no greater than 175° C., no greater than 150° C., no greater than 125° C., or no greater than 100° C. The temperature for drying is usually at least 25° C., at least 50° C., or at least 75° C. A xerogel results from this process of organic solvent removal.

Forming a xerogel can be used for drying shaped gel articles with any dimensions but is most frequently used for the preparation of relatively small sintered articles. As the gel composition dries either at room temperature or at elevated temperatures, the density of the structure increases. Capillary forces pull the structure together resulting in some linear shrinkage such as up to about 25 percent, up to 20 percent or up to 15 percent. The shrinkage is typically dependent on the amount of inorganic oxide present and the overall composition. The linear shrinkage is often in a range of 5 to 25 percent, 10 to 25 percent, or 5 to 15 percent. Because the drying typically occurs most rapidly at the outer surfaces, density gradients are often established throughout the structure. Density gradients can lead to the formation of cracks. The likelihood of crack formation increases with the size and the complexity of the shaped gel article and with the complexity of the structure. In some embodiments, xerogels are used to prepare sintered bodies having a longest dimension no greater than about 1 centimeter.

In some embodiments, the xerogels contain some residual organic solvent with a boiling point equal to at least 150° C. The residual solvent can be up to 6 weight percent based on the total weight of the aerogel. For example, the xerogel can contain up to 5 weight percent, up to 4 weight percent, up to 3 weight percent, up to 2 weight percent, or up to 1 weight percent organic solvent having a boiling point equal to at least 150° C.

If the shaped gel article has fine features that can be easily broken or cracked, it is often preferable to form an aerogel intermediate rather than a xerogel. A shaped gel article of any size and complexity can be dried to an aerogel. An aerogel is formed by drying the shaped gel article under supercritical conditions. A supercritical fluid, such as supercritical carbon dioxide, can be contacted with the shaped gel article in order to remove solvents that are soluble in or miscible with the supercritical fluid. The organic solvent having a boiling point equal to at least 150° C. can be removed by supercritical carbon dioxide. There is no capillary effect for this type of drying and the linear shrinkage is often in a range of 0 to 25 percent, 0 to 20 percent, 0 to 15 percent, 5 to 15 percent, or 0 to 10 linear percent. The volume shrinkage is often in a range of 0 to 50 percent, 0 to 40 percent, 0 to 35 percent, 0 to 30 percent, 0 to 25 percent, 10 to 40 percent, or 15 to 40 percent. Both the linear and volume shrinkage are dependent on the percent inorganic oxide present in the structures. The density typically remains uniform throughout the structure. Supercritical extraction is discussed in detail in van Bommel et al., J Materials Sci., 29, 943-948 (1994), Francis et al., J Phys. Chem., 58, 1099-1114 (1954) and McHugh et al., Supercritical Fluid Extraction: Principles and Practice, Butterworth-Heinemann, Stoneham, Mass., 1986.

The use of the organic solvent having a boiling point equal to at least 150° C. advantageously eliminates the need to soak the shaped gel article in a solvent such as alcohol (e.g., ethanol) to replace water prior to supercritical extraction. This replacement is needed to provide a liquid that is soluble with (can be extracted by) the supercritical fluid. The soaking step often results in the formation of a rough surface on the shaped gel article. The rough surface created from the soaking step may result from residue deposition (e.g., organic residue) during the soaking step. Without the soaking step, the shaped gel article can better retain the original glossy surface it had upon removal from the mold cavity.

Supercritical extraction can remove all or most of the organic solvent having a boiling point equal to at least 150° C. The removal of the organic solvent results in the formation of pores within the dried structure. Preferably, the pores are sufficiently large to allow gases from the decomposition products of the polymeric material to escape without cracking the structure when the dried structure is further heated to burnout the organic material and to form a sintered article.

In some embodiments, the aerogels contain some residual organic solvent with a boiling point equal to at least 150° C. The residual solvent can be up to 6 weight percent based on the total weight of the aerogel. For example, the aerogel can contain up to 5 weight percent, up to 4 weight percent, up to 3 weight percent, up to 2 weight percent, or up to 1 weight percent organic solvent having a boiling point equal to at least 150° C.

In some embodiments, aerogels have a surface area (i.e., a BET specific surface area) in a range of 50 m²/gram to 400 m²/gram. For example, the surface area is at least 75 m²/gram, at least 100 m²/gram, least 125 m²/gram, at least 150 m²/gram, or at least 175 m²/gram. The surface area can be up to 350 m²/gram, up to 300 m²/gram, up to 275 m²/gram, up to 250 m²/gram, up to 225 m²/gram, or up to 200 m²/gram.

The volume percent inorganic oxide in the aerogel is often in a range of 3 to 30 volume percent. For example, the volume percent of the inorganic oxide is often at least 4 volume percent or at least 5 volume percent. Aerogels having a lower volume percent inorganic oxide tend to be quite fragile and may crack during supercritical extraction or subsequent processing. Additionally, if there is too much polymeric material present, the pressure during subsequent heating may be unacceptably high resulting in the formation of cracks. Aerogels with more than 30 volume percent inorganic oxide content tend to crack during the calcination process when the polymeric material decomposes and vaporizes. It may be more difficult for the decomposition products to escape from the denser structures. The volume percent inorganic oxide is often up to 25 volume percent, up to 20 volume percent, up to 15 volume percent, or up to 10 volume percent. The volume percent is often in a range of 3 to 25 volume percent, 3 to 20 volume percent, 3 to 15 volume percent, 4 to 20 volume percent, or 5 to 20 volume percent.

### Organic Burnout and Pre-Sintering

After removal of the solvent medium, the resulting xerogel or aerogel is heated to remove the polymeric material or any other organic material that may be present and to build strength through densification. The temperature is often raised as high as 1000° C. or 1100° C. during this process. The rate of temperature increase is usually carefully controlled so that the pressure resulting from the decomposition and vaporization of the organic material does not result in pressures within the structures sufficient to generate cracks.

The rate of temperature increase can be constant or can be varied over time. The temperature can be increased to a certain temperature, held at that temperature for a period of time, and then increased further at the same rate or at a different rate. This process can be repeated multiple times, if desired. The temperature is gradually increased to about 1000° C. or to about 1100° C. In some embodiments, the temperature is first increased from about 20° C. to about 200° C. at a moderate rate such as in a range of 10° C./hour to 30° C./hour. This is followed by increasing the temperature to about 400° C., to about 500° C., or to about 600° C. relatively slowly (e.g., at a rate of 1° C./hour to less than 10° C./hour). This slow heating rate facilitates vaporization of the organic material without cracking the structure. After the majority of the organic material has been removed, the temperature can then be rapidly increased to about 1000° C. or to about 1100° C. such as at a rate greater than 50° C./hour (e.g., 50° C./hour to 100° C./hour). The temperature can be held at any temperature for up to 5 minutes, up to 10 minutes, up to 20 minutes, up to 30 minutes, up to 60 minutes, or up to 120 minutes or even longer.

Thermogravimetric analysis and dilatometry can be used to determine the appropriate rate of heating. These techniques track the weight loss and shrinkage that occur at different heating rates. The heating rates in different temperature ranges can be adjusted to maintain a slow and near constant rate of weight loss and shrinkage until the organic material is removed. Careful control of organic removal facilitates the formation of sintered articles with minimal or no cracking.

The article is often cooled to room temperature after organic burnout. The cooled article optionally can be soaked in a basic solution such as an aqueous solution of ammonium hydroxide. Soaking can be effective to remove undesirable ionic species such as sulfate ions because of the porous nature of the articles at this stage of the process. Sulfate ions can ion exchange with hydroxyl ions. If sulfate ions are not removed, they can generate small pores in the sintered articles that tend to reduce the translucency and/or the strength.

More specifically, the ion exchange process often includes soaking the article that has been heated to remove organic material in an aqueous solution of 1 N ammonium hydroxide. This soaking step is often for at least 8 hours, at least 16 hours, or at least 24 hours. After soaking, the article is removed from the ammonium hydroxide solution and washed thoroughly with water. The article can be soaked in water for any desired period of time such as at least 30 minutes, at least 1 hour, at least 2 hours, or at least 4 hours. The soaking in water can be repeated several times, if desired, by replacing the water with fresh water.

After soaking, the article is typically dried in an oven to remove the water. For example, the article can be dried by heating in an oven set at a temperature equal to at least 80° C., at least 90° C., or at least 100° C. For example, the temperature can be in a range of 80° C. to 150° C., 90° C. to 150° C., or 90° C. to 125° C. for at least 30 minutes, at least 60 minutes, or at least 120 minutes.

### Sintering

After organic burnout and optional soaking in an aqueous solution of ammonium hydroxide, the dried article is sintered. Sintering typically occurs at a temperature greater than 1100° C. such as, for example, at least 1200° C., at least 1250° C., at least 1300° C., or at least 1320° C. The rate of heating can typically be quite rapid such as at least 100° C./hour, at least 200° C./hour, at least 400° C./hour, or at least 600° C./hour. The temperature can be held for any desired time to produce sintered articles having the desired density. In some embodiments, the temperature is held for at least 1 hour, at least 2 hours, or at least 4 hours. The temperature can be held for 24 hours or even longer, if desired.

The density of the dried article increases during the sintering step and the porosity is substantially reduced. If the sintered article has no pores (i.e., voids), it is considered to have the maximum density possible for that material. This maximum density is referred to as the “theoretical density”. If pores are present in the sintered article, the density is less than the theoretical density. The percentage of the theoretical density can be determined from electron micrographs of a cross-section of the sintered article. The percent of the area of the sintered article in the electron micrograph that is attributable to pores can be calculated. Stated differently, the percent of the theoretical density can be calculated by subtracting the percent voids from 100 percent. That is, if 1 percent of the area of the electron micrograph of the sintered article is attributable to pores, the sintered article is considered to have a density equal to 99 percent. The density can also be determined by the Archimedes method.

In many embodiments, the sintered article has a density that is at least 99 percent of the theoretical value. For example, the density can be at least 99.2 percent, at least 99.5 percent, at least 99.6 percent, at least 99.7 percent, at least 99.8 percent, at least 99.9 percent, or at least 99.95 percent or even at least 99.99 percent of the theoretical density. As the density approaches the theoretical density, the translucency of the sintered articles tends to improve. Sintered articles having a density that is at least 99 percent of the theoretical density often appears translucent to the human eye.

The sintered article contains crystalline zirconia-based material. The crystalline zirconia-based material is often predominately cubic and/or tetragonal. Tetragonal materials can undergo transformational toughening when fractured. That is, a portion of the tetragonal phase material can be transformed to monoclinic phase material in the region of the fracture. The monoclinic phase material tends to occupy a larger volume than the tetragonal phase and tends to arrest the propagation of the fracture.

In many embodiments, at least 80 percent of the zirconia-based material in the sintered article as initially prepared is present in the cubic and/or tetragonal crystalline phase. That is, as initially prepared, at least 80 percent, at least 85 percent, at least 90 percent, at least 95 percent, at least 98 percent, at least 99 percent, or at least 99.5 percent of the zirconia-based material is cubic and/or tetragonal phase. The remainder of the zirconia-based material is typically monoclinic. Stated in terms of the amount of monoclinic phase, up to 20 percent of the zirconia-based material is monoclinic.

The zirconia-based material in the sintered article is usually 80 to 100 percent cubic and/or tetragonal and 0 to 20 percent monoclinic, 85 to 100 percent cubic and/or tetragonal and 0 to 15 percent monoclinic, 90 to 100 percent cubic and/or tetragonal and 0 to 10 percent monoclinic, or 95 to 100 percent cubic and/or tetragonal and 0 to 5 percent monoclinic.

The average grain size is often in a range of 75 nanometers to 400 nanometers or in a range of 100 nanometers to 400 nanometers. The grain size is typically no greater than 400 nanometers, no greater than 350 nanometers, no greater than 300 nanometers, no greater than 250 nanometers, no greater than 200 nanometers, or no greater than 150 nanometers. This grain size contributes to the high strength of the sintered articles.

The sintered materials can have, for example, an average biaxial flexural strength of at least 300 MPa. For example, the average biaxial flexural strength can be at least 400 MPa, at least 500 MPa, at least 750 MPa, at least 1000 MPa, or even at least 1300 MPa.

Sintered materials can have a total transmittance of at least 65% at a thickness of one millimeter.

The shape of the sintered article is typically identical to that of the shaped gel article. Compared to the shaped gel article, the sintered article has undergone isotropic size reduction (i.e., isotropic shrinkage). That is, the extent of shrinkage in one direction is within 5 percent, within 2 percent, within 1 percent, or within 0.5 percent of the shrinkage in the other two directions. Stated differently, a net shaped sintered article can be prepared from the shaped gel articles. The shaped gel articles can have complex features that can be retained in the sintered article but with smaller dimensions based on the extent of isotropic shrinkage. That is, net shaped sintered articles can be formed from the shaped gel articles.

The amount of isotropic linear shrinkage between the shaped gel article and the sintered article is often in a range of 40 to 70 percent or in a range of 45 to 55 percent. The amount of isotropic volume shrinkage is often in a range of 80 to 97 percent, 80 to 95 percent, or 85 to 95 percent. These large amounts of isotropic shrinkage result from the relatively low amount of zirconia-based particles (3 to 30 volume percent) included in the reaction mixture used to form the gel composition (shaped gel article). Conventional teaching has been that high volume fractions of the inorganic oxides are needed to obtain fully dense sintered articles. Surprisingly, gel compositions can be obtained from casting sols with a relatively low amount of the zirconia-based particles that are sufficiently strong to be removed from molds (even molds having intricate and complex shapes and surfaces), dried, heated to burnout organic matter, and sintered without cracking. It is also surprising that the shape of the sintered articles can match that of the shaped gel article and the mold cavity so well in spite of the large percent shrinkage. The large percent shrinkage can be an advantage for some applications. For example, it allows the manufacture of smaller parts than can be obtained using many other ceramic molding processes.

The isotropic shrinkage tends to lead to the formation of sintered articles that are typically free of cracks and that have a uniform density throughout. Any cracks that form are often associated with cracks that result from the removal of the shaped gel article from the mold cavity rather than cracks that form during formation of the aerogel or xerogel, during burnout of the organic material, or during the sintering process. In some embodiments, particularly for larger articles or for articles with complex features, it may be preferable to form an aerogel rather than a xerogel intermediate.

Sintered articles with any desired size and shape can be prepared. The longest dimension can be up to 1 centimeter, up to 2 centimeters, up to 5 centimeters, or up to 10 centimeters or even longer. The longest dimension can be at least 1 centimeter, at least 2 centimeters, at least 5 centimeters, at least 10 centimeters, at least 20 centimeters, at least 50 centimeters, or at least 100 centimeters.

The sintered articles can have smooth surfaces or surfaces that include various features. The features can have any desired shape, depth, width, length, and complexity. For example, the features can have a longest dimension less than 500 micrometers, less than 100 micrometers, less than 50 micrometers, less than 25 micrometers, less than 10 micrometers, less than 5 micrometers, or less than 1 micrometer. Stated differently, sintered articles having a complex surface or multiple complex surfaces can be formed from a shaped gel article that has undergone isotropic shrinkage.

The sintered articles are net shaped articles formed from the shaped gel articles, which are formed within a mold cavity. The sintered article can often be used without any further milling or processing because they so closely mimic the shape of the shaped gel article, which has the same shape as the mold cavity used in its formation.

The sintered articles are typically strong and translucent. These properties are the result, for example, of starting with a zirconia-containing sol effluent that contains zirconia-based nanoparticles that are non-associated. These properties are also the result of preparing a gel composition that is homogenous. That is, the density and composition of the gel composition are uniform throughout the shaped gel article. These properties are also the result of preparing a dried gel shaped article (either a xerogel or aerogel) that has small uniform pores throughout. These pores are removed by sintering to form the sintered article. The sintered articles have a high theoretical density while having minimal grain size. The small grain size leads to high strength and high translucency. Various inorganic oxides such as yttrium oxide, for example, are often added to adjust the translucency by adjusting the amount of cubic and tetragonal phases in the sintered article.

Various embodiments are provided that are a reaction mixture, a gel composition, a reaction mixture positioned within a mold cavity, a gel composition positioned within a mold cavity, a shaped gel article, a method of making a xerogel, a method of making an aerogel, a method of making a sintered article, or a sintered article.

Embodiment 1A a reaction mixture that includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction. The reaction mixture can be referred to as a casting sol.

Embodiment 2A is the reaction mixture of Embodiment 1A, wherein the zirconia-based particles are crystalline.

Embodiment 3A is the reaction mixture of Embodiment 2A, wherein at least 50 weight percent of the zirconia-based particles have a cubic structure, tetragonal structure, or a combination thereof.

Embodiment 4A is the reaction mixture of Embodiment 3A, wherein at least 80 weight percent of the zirconia-based particles have a cubic structure, tetragonal structure, or a combination thereof. Embodiment 5A is the reaction mixture of any one of Embodiments 1A to 4A, wherein the zirconia-based particles comprise 70 to 100 mole percent zirconium oxide, 0 to 30 mole percent yttrium oxide, and 0 to 1 mole percent lanthanum oxide.

Embodiment 6A is the reaction mixture of any one of Embodiments 1A to 5A, wherein the zirconia-based particles comprise 80 to 99 mole percent zirconium oxide, 1 to 20 mole percent yttrium oxide, and 0 to 5 mole percent lanthanum oxide or 85 to 99 mole percent zirconium oxide, 1 to 15 mole percent yttrium oxide, and 0 to 6 mole percent lanthanum oxide.

Embodiment 7A is the reaction mixture of any one of Embodiments 1A to 6A, wherein the zirconia-based particles have an average primary particle size in a range of 2 to 50 nanometers, in a range of 2 to 20 nanometers, or in a range of 2 to 10 nanometers.

Embodiment 8A is the reaction mixture of any one of Embodiments 1A to 7A, wherein the reaction mixture contains 25 to 55 weight percent or 30 to 50 weight percent zirconia-based particles.

Embodiment 9A is the reaction mixture of any one of Embodiments 1A to 8A, wherein the solvent medium comprises at least 80 weight percent or at least 90 weight percent of the organic solvent having a boiling point equal to at least 150° C.

Embodiment 10A is the reaction mixture of any one of Embodiments 1A to 9A, wherein the organic solvent has a boiling point equal to at least 160° C. or at least 180° C.

Embodiment 11A is the reaction mixture of any one of Embodiments 1A to 10A, wherein the organic solvent having a boiling point equal to at least 150° C. is a glycol or polyglycol, mono-ether glycol or mono-ether polyglycol, di-ether glycol or di-ether polyglycol, ether ester glycol or ether ester polyglycol, carbonate, amide, or sulfoxide.

Embodiment 12A is the reaction mixture of any one of Embodiments 1A to 11A, wherein organic solvent has a molecular weight in a range of 25 grams/mole to 300 grams/mole.

Embodiment 13A is the reaction mixture of any one of Embodiments 1A to 12A, wherein the solvent medium is present in an amount of 30 to 70 weight percent, 35 to 60 weight percent or 35 to 50 weight percent.

Embodiment 14A is the reaction mixture of any one of Embodiments 1A to 13A, wherein the first surface modification agent having a free radical polymerizable group further has a surface modifying group that is a carboxyl group (—COOH) or an anion thereof.

Embodiment 15A is the reaction mixture of Embodiment 14A, wherein the first surface modification agent is (meth)acrylic acid.

Embodiment 16A is the reaction mixture of any one of Embodiments 1A to 13A, wherein the first surface modification agent having a free radical polymerizable group further has a surface modifying group that is a silyl group of formula —Si(R⁷)ₓ(R⁸)₃₋ₓ where R⁷ is a non-hydrolyzable group, R⁸ is hydroxyl or a hydrolyzable group, and the variable x is an integer equal to 0, 1, or 2.

Embodiment 17A is the reaction mixture of Embodiment 16A, wherein the non-hydrolyzable group is an alkyl group having 1 to 10 carbon atoms and wherein the hydrolyzable group is a halo (e.g., chloro), acetoxy, or an alkoxy having 1 to 10 carbon atoms.

Embodiment 18A is the reaction mixture of any one of Embodiments 1A to 17A, wherein the polymerizable material further comprises a second monomer that is a non-acidic polar monomer, an alkyl (meth)acrylate, a monomer with a plurality of polymerizable groups, or a mixture thereof.

Embodiment 19A is the reaction mixture of any one of Embodiments 1A to 18A, wherein the polymerizable material comprises 20 to 100 weight percent of the first surface modification agent having a free radical polymerizable group and 0 to 80 weight percent of a second monomer that is a non-acidic polar monomer, an alkyl (meth)acrylate, a monomer with a plurality of polymerizable groups, or a mixture thereof.

Embodiment 20A is the reaction mixture of any one of Embodiments 1A to 19A, wherein the reaction mixture further comprises a non-polymerizable surface modification agent.

Embodiment 21A is the reaction mixture of Embodiment 20A, wherein the non-polymerizable surface modification agent is of formula H₃CO—[(CH₂)_{y}O]_{z}-Q-COOH where Q is a divalent organic linking group, z is an integer in a range of 1 to 10, and y is an integer in a range of 1 to 4. Group Q often includes one or more alkylene group or arylene group and can further include one or more oxy, thio, carbonyloxy, carbonylimino groups.

Embodiment 22A is the reaction mixture of Embodiment 20A or 21A, wherein the non-polymerizable surface modification agent is present in an amount in a range of 1 to 10 weight percent based on the total weight of the reaction mixture.

Embodiment 23A is the reaction mixture of any one of Embodiments 1A to 22A, wherein the reaction mixture has a viscosity in a range of 2 to 500 centipoises or 2 to 100 centipoises or 2 to 50 centipoises. The zirconia-based particles are non-associated or substantially non-associated.

Embodiment 24A is the reaction mixture of any one of Embodiments 1A to 23A, wherein the reaction mixture contains 40 weight percent zirconia-based particles and has a percent transmission equal to at least 5 percent when measured in a spectrometer at a wavelength of 420 nanometers in a 1 centimeter sample cell.

Embodiment 1B is a gel composition that includes a polymerized product of a reaction mixture. The reaction mixture includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction.

Embodiment 2B is the gel composition of Embodiment 1B, wherein the reaction mixture is any one of Embodiments 1A to 24A.

Embodiment 1C is an article that includes (a) a mold having a mold cavity and (b) a reaction mixture positioned within the mold cavity and in contact with a surface of the mold cavity. The reaction mixture includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction.

Embodiment 2C is the article of Embodiment 1C, wherein the reaction mixture is any one of Embodiments 1A to 24A.

Embodiment 3C is the article of any one of Embodiments 1C or 2C, wherein the reaction mixture contacts all surfaces of the mold cavity.

Embodiment 4C is the article of any one of Embodiments 1C to 3C, wherein a surface of the mold cavity has features with dimensions less than 100 micrometers or less than 10 micrometers.

Embodiment 5C is the article of any one of Embodiments 1C to 4C, wherein the mold cavity has at least one surface that can transmit actinic radiation in the visible region, ultraviolet region, or both of the electromagnetic spectrum.

Embodiment 1D is an article that includes (a) a mold having a mold cavity and (b) a gel composition positioned within the mold cavity and in contact with a surface of the mold cavity. The gel composition includes a polymerized product of a reaction mixture that includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction.

Embodiment 2D is the article of Embodiment 1D, wherein the reaction mixture is any one of Embodiments 1A to 24A.

Embodiment 3D is the article of any one of Embodiments 1D or 2D, wherein the reaction mixture contacts all surfaces of the mold cavity.

Embodiment 4D is the article of any one of Embodiments 1D to 3D, wherein a surface of the mold cavity has features with dimensions less than 100 micrometers or less than 10 micrometers.

Embodiment 5D is the article of any one of Embodiments 1D to 4D, wherein the gel composition has a size and shape that is identical to that of the mold cavity (except in a region where the mold cavity was overfilled with the reaction mixture).

Embodiment 6D is the article of any one of Embodiments 1D to 5D, wherein the mold cavity has at least one surface that can transmit actinic radiation in the visible region, ultraviolet region, or both of the electromagnetic spectrum.

Embodiment 1E is a shaped gel article. The shaped gel article is a polymerized product of a reaction mixture, wherein the reaction mixture is positioned within a mold cavity during polymerization and wherein the shaped gel article retains both a size and shape identical to the mold cavity (except in a region where the mold cavity was overfilled with reaction mixture) when removed from the mold cavity. The reaction mixture includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction.

Embodiment 2E is the shaped gel article of Embodiment 1E, wherein the reaction mixture is any one of Embodiments 1A to 24A.

Embodiment 3E is the shaped gel article of any one of Embodiments 1E or 2E, wherein the reaction mixture contacts all surfaces of the mold cavity.

Embodiment 4E is the shaped gel article of any one of Embodiments 1E to 3E, wherein a surface of the mold cavity has features with dimensions less than 100 micrometers or less than 10 micrometers.

Embodiment 5E is the shaped gel article of any one of Embodiments 1E to 4E, wherein the shaped gel article is removable from the mold cavity without breaking or cracking.

Embodiment 6E is the shaped gel article of any one of Embodiments 1E to 5E, wherein the shaped gel article is free of cracks.

Embodiment 7E is the shaped gel article of any one of Embodiments 1E to 6E, wherein the density is constant throughout the shaped gel article.

Embodiment 1F is a method of making a sintered article. The method includes (a) providing a mold having a mold cavity, (b) positioning a reaction mixture within the mold cavity, (c) polymerizing the reaction mixture to form a shaped gel article that is in contact with the mold cavity, (d) removing the shaped gel article from the mold cavity, wherein the shaped gel article retains a size and shape identical to the mold cavity (except in regions where the mold cavity was overfilled), (e) forming a dried shaped gel article by removing the solvent medium, (f) heating the dried shaped gel article to form a sintered article. The sintered article has a shape identical to the mold cavity (except in regions where the mold cavity was overfilled) and the shaped gel article but is reduced in size proportional to an amount of isotropic shrinkage. The reaction mixture includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction.

Embodiment 2F is the method of Embodiment 1F, wherein the reaction mixture is any one of Embodiments 1A to 24A.

Embodiment 3F is the method of Embodiment 1F or 2F, wherein the reaction mixture contacts all surfaces of the mold cavity.

Embodiment 4F is the method of any one of Embodiments 1F to 3F, wherein a surface of the mold cavity has features with dimensions less than 100 micrometers or less than 10 micrometers.

Embodiment 5F is the method of any one of Embodiments 1F to 4F, wherein forming a dried shaped gel article by removing the solvent medium comprises forming an aerogel.

Embodiment 6F is the method of any one of Embodiments 1F to 4F, wherein forming a dried shaped gel article by removing the solvent medium comprises forming a xerogel.

Embodiment 7F is the method of any one of Embodiments 1F to 6F, wherein the sintered article is free of cracks.

Embodiment 8F is the method of any one of Embodiments 1F to 7F, wherein the isotropic linear shrinkage from the shaped gel article to the sintered article is in a range of 40 to 70 percent.

Embodiment 9F is the method of any one of Embodiments 1F to 8F, wherein the reaction mixture is filtered before positioning the reaction mixture within the mold cavity.

Embodiment 1G is a sintered article that is prepared using the method of any one of Embodiments 1F to 9F.

Embodiment 1H is a method of making an aerogel. The method includes providing a mold having a mold cavity and positioning a reaction mixture within the mold cavity. The reaction mixture includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction. The method further includes polymerizing the reaction mixture to form a shaped gel article that is in contact with the mold cavity and removing the shaped gel article from the mold cavity. The shaped gel article retains a size and shape identical to that of the mold cavity (except in regions where the mold cavity was overfilled). The method yet further includes removing the solvent medium from the shape gel article by supercritical extraction to form the aerogel.

Embodiment 2H is the method of Embodiment 1H, wherein the reaction mixture is any one of Embodiments 1A to 24A.

Embodiment 3H is the method of Embodiment 1H or 2H, wherein the supercritical extraction uses supercritical carbon dioxide.

Embodiment 4H is the method of any one of Embodiments 1H to 3H, wherein the reaction mixture is filtered before positioning the reaction mixture within the mold cavity.

Embodiment 1I is a method of making a xerogel. The method includes providing a mold having a mold cavity and positioning a reaction mixture within the mold cavity. The reaction mixture includes (a) 20 to 60 weight percent zirconia-based particles based on a total weight of the reaction mixture, the zirconia-based particles having an average particle size no greater than 100 nanometers and containing at least 70 mole percent ZrO₂, (b) 30 to 75 weight percent of a solvent medium based on the total weight of the reaction mixture, the solvent medium containing at least 60 percent of an organic solvent having a boiling point equal to at least 150° C., (c) 2 to 30 weight percent polymerizable material based on a total weight of the reaction mixture, the polymerizable material including a first surface modification agent having a free radical polymerizable group; and (d) a photoinitiator for a free radical polymerization reaction. The method further includes polymerizing the reaction mixture to form a shaped gel article that is in contact with the mold cavity and removing the shaped gel article from the mold cavity. The shaped gel article retains a size and shape identical to the mold cavity (except in regions where the mold cavity was overfilled). The method yet further includes removing the solvent medium from the shape gel article by evaporation at room temperature or at an elevated temperature.

Embodiment 2I is the method of Embodiment 1I, wherein the reaction mixture is any one of Embodiments 1A to 24A.

Embodiment 3I is the method of Embodiment 1I or 2I, wherein the reaction mixture is filtered before positioning the reaction mixture within the mold cavity.

### EXAMPLES

### Materials

| Material or abbreviation | Description |
|---|---|
| MEEAA | 2-(2-(2-Methoxyethoxy)ethoxy) Acetic Acid obtained from |
| | Aldrich Chemical Company, Milwaukee, WI, USA. |
| Zirconium acetate | An aqueous solution of zirconium acetate containing nominally |
| | 16.3 weight percent zirconium obtained from Magnesium |
| | Elektron, Inc., Flemington, NJ, USA. The aqueous solution was |
| | exposed to an ion exchange resin (obtained under the trade |
| | designation “AMBERLYTE IR 120” from Rohm and Haas |
| | Company, Philadelphia, PA, USA) before use (oxide content |
| | 21.85 wt. %). |
| Lanthanum Oxide | Lanthanum (III) oxide (99% rare earth oxides) obtained from |
| | Alfa Aesar, Ward Hill, MA, USA. |
| Yttrium acetate | Yttrium (III) acetate tetrahydrate obtained from AMR |
| | Technologies Inc., Toronto, Canada (oxide content 33.4 wt. %). |
| Lanthanum | Lathanum (III) acetate hydrate (oxide content 45.5 wt. %) |
| Acetate | obtained from Alfa Aesar, Ward Hill, MA, USA. |
| DI water | De-ionized water. |
| 1-Methoxy-2-propanol | An alcohol obtained from Aldrich Chemical Company, |
| | Milwaukee, WI, USA. |
| HEMA | 2-Hydroxyethyl methacrylate obtained from Alfa Aesar, Ward |
| | Hill, MA, USA. |
| “IRGACURE 819” | UV/Visible photoinitiator available under trade designation |
| | “IRGACURE 819” from BASF Corporation Vandalia, IL, USA. |
| “SR454” | Ethoxylated trimethylolpropane triacrylate, obtained from |
| | Sartomer Company Inc., Exton, PA, USA, under the trade |
| | designation “SR454”. |
| Diethylene glycol monoethyl | Diethylene glycol monoethyl ether obtained from Alfa Aesar, |
| ether | Ward Hill, MA, USA. |
| Ethanol | KOPTEC 200 proof ethanol obtained from DLI, King of |
| | Prussia, PA, USA. |
| DMF | N,N-Dimethylformamide obtained from EMD Chemicals Inc., |
| | Gibbstown, NJ, USA. |
| Propylene Carbonate | Propylene Carbonate obtained from Alfa Aesar, Ward Hill, MA, |
| | USA. |
| Diethylene glycol monomethyl | Diethylene glycol monomethyl ether obtained from Alfa Aesar, |
| ether | Ward Hill, MA, USA. |
| Diethylene glycol | Diethylene glycol obtained from Alfa Aesar, Ward Hill, MA, |
| | USA. |
| Acrylic acid | Acrylic acid obtained from Alfa Aesar, Ward Hill, MA, USA. |
| “SR506A” | Isobornyl acrylate obtained from Sartomer Company Inc., |
| | Exton, PA, USA, under the trade designation “SR506A”. |
| “SR238B” | 1,6-Hexanediol diacrylate obtained from Sartomer Company |
| | Inc., Exton, PA, USA, under the trade designation “SR238B”. |
| “SR295” | Pentaerythritol tetraacrylate obtained from Sartomer Company |
| | Inc., Exton, PA, USA, under the trade designation “SR295”. |
| “CN975” | Hexafunctional urethane acrylate obtained from Sartomer |
| | Company Inc., Exton, PA, USA, under the trade designation |
| | “CN975”. |
| HEAA | N-(2-Hydroxyethyl) acrylamide obtained from Tokyo Chemical |
| | Industry Co., LTD., Tokyo, Japan. |
| HEAS | Mono-2-(Methacryloyloxy) ethyl succinate obtained from |
| | Aldrich Chemical Company, Milwaukee, WI, USA. |
| B-CEA | Beta-carboxyethylacrylate obtained from CYTEC Industries |
| | Inc., Woodland Park, NJ, USA. |
| 4-Hydroxy-TEMPO | 4-Hydroxy-2,2,6,6-tetramethylpiperidin-1-oxyl, obtained from |
| | Aldrich Chemical Company, Milwaukee, WI, USA. |
| 3-(methacryloyloxy)- | 3-(methacryloyloxy)-propyltrimethoxysilane obtained from Alfa |
| propyltrimethoxy-silane | Aesar, Ward Hill, MA, USA. |
| Ammonium Hydroxide | Ammonium Hydroxide (assay 28-30 wt. % as NH₃) obtained |
| | from EMD Chemicals Inc., Gibbstown, NJ, USA. |

### Molds

### Fiducial Mold

A nickel cylinder 34.92 mm in diameter and 20.59 mm high was patterned on one face with fiducials using a focused ion beam. The fiducial pattern consisted of 4 grids spaced 5 mm apart from a center grid at a spacing of 90°. Each grid was 500 micrometers by 500 micrometers with an internal grid of 16 square measuring 125 microns by 125 microns. The top left grid of each square contained smaller features. There were 3 squares with dimensions of 25 microns by 25 microns, 10 microns by 10 microns, and 2.5 microns by 2.5 microns and 3 circles with diameters of 25 microns, 10 microns, and 2.5 microns.

### Hexagonal Post Mold

The hexagonal post mold is a polypropylene sheet that was patterned on one side with an array of hexagonal wells that were 29 micrometers deep. The wells were 125 micrometers in width at the largest dimension and the parallel edges were 109 micrometers apart. The distance from the center of one well to the center of the immediately adjacent well was 232 micrometers.

### Prismatic Array Mold

The prismatic array mold is a polymeric sheet that was patterned on one side with an array of parallel triangular prismatic structures. The peak to peak distance between adjacent structures was 50 micrometers. The height of the triangular prismatic structure was 25 micrometers.

### Beaker Mold

The beaker mold was the bottom outside cavity of a polypropylene 50 ml beaker. This cavity had a diameter of about 28 mm. The depth of the cavity was about 2 mm. The beaker bottom also had a center protrusion of about 1 mm high by 0.5 mm in diameter. The recycling symbol for polypropylene and the number 3 were positive on the bottom of the beaker. The numbers were on the order of 2 to 3 mm in dimension.

### Cup Mold

The cup mold was the bottom outside cavity of a high density polyethylene cup. The cavity had a diameter of about 38 mm. The depth of the cavity was about 2 mm. The cavity also had a center protrusion of about 0.5 mm high by 4 mm in diameter. The recycling symbol for high density polyethylene and numbers were positive on the bottom of the cup. The numbers were on the order of 3 to 4 mm. The cup bottom also contained a logo positive to the bottom surface.

### Food Container Mold

The food container mold was the bottom outside cavity of a polypropylene food storage container. The cavity had dimensions of about 34 mm by 70 mm by 2 mm. The recycling symbol for polypropylene and numbers were positive on the bottom of the cup. The numbers were on the order of 3 to 4 mm. The cup also contained a symbol indicating it was a food container positive to the bottom of the container.

### Methods

### Method for Crystalline Structure and Size (XRD Analysis)

Dried zirconia samples were ground by hand using an agate mortar and pestle. A liberal amount of the sample was applied by spatula to a glass microscope slide on which a section of double sided adhesive tape had been adhered. The sample was pressed into the adhesive on the tape by forcing the sample against the adhesive with the spatula blade. Excess sample was removed by scraping the sample area with the edge of the spatula blade, leaving a thin layer of particles adhered to the adhesive. Loosely adhered materials remaining after the scraping were removed by forcefully tapping the microscope slide against a hard surface. In a similar manner, corundum (Linde 1.0 μm alumina polishing powder, Lot Number C062, Union Carbide, Indianapolis, Ind.) was prepared and used to calibrate the X-ray diffractometer for instrumental broadening.

X-ray diffraction scans were obtained using a Philips vertical diffractometer having a reflection geometry, copper K_{α} radiation, and a proportional detector registry of the scattered radiation. The diffractometer was fitted with variable incident beam slits, fixed diffracted beam slits, and a graphite diffracted beam monochromator. The survey scan was recorded from 25 to 55 degrees two theta (20) using a step size of 0.04 degrees and a dwell time of 8 seconds. X-ray generator settings of 45 kV and 35 mA were used. Data for the corundum standard was collected on three separate areas of several individual corundum mounts. Likewise, data was collected on three separate areas of the thin layer sample mount.

The observed diffraction peaks were identified by comparison to reference diffraction patterns contained within the International Center for Diffraction Data (ICDD) powder diffraction database (sets 1-47, ICDD, Newton Square, Pa., USA). The diffraction peaks for the samples were attributed to either cubic/tetragonal (C/T) or monoclinic (M) forms of zirconia. For zirconia-based particles, the (111) peak for the cubic phase and (101) peak for the tetragonal phase could not be separated so these phases were reported together. The amounts of each zirconia form were evaluated on a relative basis and the form of zirconia having the most intense diffraction peak was assigned the relative intensity value of 100. The strongest line of the remaining crystalline zirconia form was scaled relative to the most intense line and given a value between 1 and 100.

Peak widths for the observed diffraction maxima due to corundum were measured by profile fitting. The relationship between mean corundum peak widths and corundum peak position (20) was determined by fitting a polynomial to these data to produce a continuous function used to evaluate the instrumental breadth at any peak position within the corundum testing range. Peak widths for the observed diffraction maxima due to zirconia were measured by profile fitting the observed diffraction peaks. The following peak widths were evaluated depending on the zirconia phase found to be present:
Cubic/Tetragonal (C/T): (1 1 1)
Monoclinic (M): (−1 1 1), and (1 1 1)

A Pearson VII peak shape model with K_{α1} and K_{α2} wavelength components and linear background model were used for all measurements. Widths were calculated as the peak full width at half maximum (FWHM) having units of degrees. The profile fitting was accomplished by use of the capabilities of the JADE diffraction software suite. Sample peak widths were evaluated for the three separate data collections obtained for the same thin layer sample mount.

Sample peaks were corrected for instrumental broadening by interpolation of instrumental breadth values from corundum instrument calibration and corrected peak widths converted to units of radians. The Scherrer equation was used to calculate the primary crystal size.

Crystallite Size(D)=Kλ/β(cos θ)

In the Scherrer equation, K is the form factor (here 0.9), λ is the wavelength (1.540598 Å), β is the calculated peak width after correction for instrumental broadening (in radians), and θ equals half the peak position (scattering angle). β is equal to [calculated peak FWHM—instrumental breadth] (converted to radians) where FWHM is full width at half maximum. The cubic/tetragonal (C/T) mean crystallite size was measured as the average of three measurements using (1 1 1) peak. That is,

C/T mean crystallite size=[D(1 1 1)_{area 1}+D(1 1 1)_{area 2}+D(1 1 1)ₐᵣₑₐ d/3.

The monoclinic (M) crystallite size was measured as the average of three measurements using the (−1 1 1) peak and three measurements using the (1 1 1) peak.

M mean crystallite size=[D(−1 1 1)_{area 1}D(−1 1 1)_{area 2}+D(−1 1 1)_{area 3}+D(1 1 1)_{area 1}+D(1 1 1)_{area 2}+D(1 1 1)0.3]/6

The weighted average of the cubic/tetragonal (C/T) and monoclinic phases (M) were calculated.

Weighted average=[(%C/T)(C/T size)+(%M)(M size)]/100

In this equation, % C/T equals the percent crystallinity contributed by the cubic and tetragonal crystallite content of the ZrO₂ particles; C/T size equals the size of the cubic and tetragonal crystallites; % M equals the percent crystallinity contributed by the monoclinic crystallite content of the ZrO₂ particles; and M size equals the size of the monoclinic crystallites.

### Method for Photon Correlation Spectroscopy (PCS)

Particle size measurements were made using a light scattering particle sizer equipped with a red laser having a 633 nm wavelength of light (obtained under the trade designation “ZETA SIZER-NANO SERIES, MODEL ZEN3600” from Malvern Instruments Inc., Westborough, Mass.). Each sample was analyzed in a one centimeter square polystyrene sample cuvette. The sample cuvette was filled with about 1 gram of deionized water, and then a few drops (about 0.1 gram) of the zirconia-based sol were added. The composition (e.g., sample) within each sample cuvette was mixed by drawing the composition into a clean pipette and discharging the composition back into the sample cuvette several times. The sample cuvette was then placed in the instrument and equilibrated at 25° C. The instrument parameters were set as follows: dispersant refractive index 1.330, dispersant viscosity 0.8872 MPa-second, material refractive index 2.10, and material absorption value 0.10 units. The automatic size-measurement procedure was then run. The instrument automatically adjusted the laser-beam position and attenuator setting to obtain the best measurement of particle size.

The light scattering particle sizer illuminated the sample with a laser and analyzed the intensity fluctuations of the light scattered from the particles at an angle of 173 degrees. The method of Photon Correlation Spectroscopy (PCS) was used by the instrument to calculate the particle size. PCS uses the fluctuating light intensity to measure Brownian motion of the particles in the liquid. The particle size is then calculated to be the diameter of sphere that moves at the measured speed.

The intensity of the light scattered by the particle is proportional to the sixth power of the particle diameter. The Z-average size or cumulant mean is a mean calculated from the intensity distribution and the calculation is based on assumptions that the particles are mono-modal, mono-disperse, and spherical. Related functions calculated from the fluctuating light intensity are the Intensity Distribution and its mean. The mean of the Intensity Distribution is calculated based on the assumption that the particles are spherical. Both the Z-average size and the Intensity Distribution mean are more sensitive to larger particles than smaller ones.

The Volume Distribution gives the percentage of the total volume of particles corresponding to particles in a given size range. The volume-average size is the size of a particle that corresponds to the mean of the Volume Distribution. Since the volume of a particle is proportional to the third power of the diameter, this distribution is less sensitive to larger particles than the Z-average size. Thus, the volume-average will typically be a smaller value than the Z-average size.

### Method for Determining Dispersion Index (DI)

The dispersion index is equal to the volume-average size measured using Photon Correlation Spectroscopy divided by the weighted average crystallite size measured by XRD.

### Method for Determining Polydispersity Index (PI)

The polydispersity index is a measure of the breadth of the particle size distribution and is calculated along with the Z-average size in the cumulant analysis of the intensity distribution using Photon Correlation Spectroscopy. For values of the polydispersity index of 0.1 and below, the breadth of the distribution is considered narrow. For values above 0.5, the breadth of the distribution is considered broad and it is unwise to rely on the Z-average size to fully characterize the particle size. Instead, one should characterize the particles using a distribution analysis such as the intensity or volume distribution. The calculations for the Z-average size and polydispersity index are defined in the ISO 13321:1996 E (“Particle size analysis--Photon correlation spectroscopy”, International Organization for Standardization, Geneva, Switzerland).

### Method for Measuring Weight Percent Solids

The weight percent solids were determined by drying a sample weighing 3-6 grams at 120° C. for 60 minutes. The percent solids can be calculated from the weight of the wet sample (i.e., weight before drying, weight_{wet}) and the weight of the dry sample (i.e., weight after drying, weight_{dry}) using the following equation.

Wt. % solids=100 (weight_{dry})/weight_{wet}

### Method for Measuring Oxide Content of a Solid

The oxide content of a sol sample was determined by measuring the percent solids content as described in the “Method for Measuring Weight Percent Solids” then measuring the oxide content of those solids as described in this section.

The oxide content of a solid was measured via thermal gravimetric analysis (obtained under the trade designation “TGA Q500” from TA Instruments, New Castle, Del., USA). The solids (about 50 mg) were loaded into the TGA and the temperature was taken to 900° C. The oxide content of the solid was equal to the residual weight after heating to 900° C.

### Method for Measuring Archimedes Density

The density of the sintered material was measured by the Archimedes technique. The measurements were made on a precision balance (identified as “AE 160” from Mettler Instrument Corp., Hightstown, N.J., USA) using a density determination kit (identified as “ME 33360” from Mettler Instrument Corp., Hightstown, N.J.). In this procedure the sample was first weighed in air (A), then immersed in water (B) and weighed. The water was distilled and deionized. One drop of a wetting agent (obtained under trade designation “TERGITOL-TMN-6” from Dow Chemical Co., Danbury, Conn., USA) was added to 250 ml of water. The density was calculated using the formula ρ=(A/(A−B)) ρ₀, where ρ₀ is the density of water.

The relative density can be calculated by reference to the theoretical density (ρₜ) of the material, ρᵣₑₗ=(ρ/ρₜ)100.

### Method for Determining Viscosity

The viscosity was measured using a Brookfield Cone and Plate Viscometer (Model Number DV II available from Brookfield Engineering Laboratories, Middleboro, Mass., USA). The measurements were obtained using spindle CPE-42. The instrument was calibrated with Brookfield Fluid I which gave a measured viscosity of 5.12 centipoises (cp) at 192 l/sec (50 RPM). The compositions were placed in the measurement chamber. Measurements were made at 3-4 different RPM (revolutions per minute). The measured viscosity was not affected much by the shear rate. The sheer rate was calculated as 3.84 multiplied by the RPM. The viscosity values reported are for the minimum shear rate where the torque was in range.

### Method for Filtration of Casting Sol

The sol was filtered using a 20 milliliter syringe and a 1.0 micron Glass Fiber Membrane filter (ACRODISC 25 mm Syringe filter, obtained from Pall Life Sciences, Ann Arbor, Mich., USA).

### Method A for Determining Light Transmission (% T)

The light transmission was measured using a Perkin Elmer Lambda 35 UV/VIS Spectrometer (available from Perkin Elmer Inc., Waltham, Mass., USA). The transmission was measured in a 10 mm quartz cuvette with a water filled 10 mm quartz cuvette as the reference. The aqueous ZrO₂ sols were measured at 1 and 10 weight % ZrO₂.

### Method B for Determining Light Transmission (% T)

Light transmission was measured for a sample in a quartz cell 40 mm wide and 40 mm high with a 10 mm cm path length (thickness of sample). This cell was located at the front sample position of an integrating sphere detector to measure Total Hemispherical Transmittance (THT). DI water (18 MegOhm) was used in the reference cell. Measurements were made on a Perkin Elmer Lambda 1050 spectrophotometer fitted with a PELA-1002 integrating sphere accessory. This sphere is 150 mm (6 inches) in diameter and complies with ASTM methods E903, D1003, and E308 as published in “ASTM Standards on Color and Appearance Measurement”, Third Edition, ASTM, 1991. The instrument was manufactured by Perkin Elmer (Waltham, Mass., USA). The scan speed was approximated 102 nm/minute. UV/Visible Integration was 0.56 second per point. The data interval was 1 nm, the slit width was 5 nm, and the mode was % Transmission. Data was recorded from 700 nm to 300 nm.

### Method for Curing Cast Sol Samples

The cast sol samples placed in the desired mold were cured by placing them in one of either the 1-bulb or the 8-bulb light curing chambers (i.e., light boxes): The 8-bulb light box had 500.3 cm×304.8 cm×247.65 cm inside dimensions and contained two banks of four T8 florescent bulbs. Each bulb was 457 mm long, 15 watt (Coral Sun Actinic Blue 420 item # CL-18 available from Zoo Med Laboratories, Inc., San Luis Obispo, Calif., USA). The bulbs had peak emission at 420 nm. The bulbs were positioned side by side, 50.8 mm apart (center to center). The sample was placed on a glass plate (the plate was 190.5 mm below the top light bank and 76.2 mm above the bottom bank) between the two light banks and irradiated for the desired time.

The 1-bulb curing box also had inside dimensions of 500.3 cm×304.8 cm×247.65 cm and used one T8 florescent bulb (same as the ones described above for 8-bulb light box). The sample was placed on a glass plate (the plate is 88.9 mm below the light) and irradiated for the desired time.

### Method for Super Critical Extraction of Gels

The supercritical extraction was performed using a 10-L laboratory-scale supercritical fluid extractor unit designed by and obtained from Thar Process, Inc., Pittsburgh, Pa., USA. The ZrO₂ based gels were mounted in a stainless steel rack. Sufficient ethanol was added to the 10-L extractor vessel to cover the gels (about 3500-6500 ml). The stainless steel rack containing the wet zirconia-based gels was loaded into the 10-L extractor so that the wet gels were completely immersed in the liquid ethanol inside the jacketed extractor vessel, which was heated and maintained at 60° C. After the extractor vessel lid was sealed in place, liquid carbon dioxide was pumped by a chilled piston pump (set point: −8.0° C.) through a heat exchanger to heat the CO₂ to 60° C. and into the 10-L extractor vessel until an internal pressure of 13.3 MPa was reached. At these conditions, carbon dioxide is supercritical. Once the extractor operating conditions of 13.3 MPa and 60° C. were met, a needle valve regulated the pressure inside the extractor vessel by opening and closing to allow the extractor effluent to pass through a porous 316L stainless steel frit (obtained from Mott Corporation, New Britain, Conn., USA as Model #1100S-5.480 DIA-.062-10-A), then through a heat exchanger to cool the effluent to 30° C., and finally into a 5-L cyclone separator vessel that was maintained at room temperature and pressure less than 5.5 MPa, where the extracted ethanol and gas-phase CO₂ were separated and collected throughout the extraction cycle for recycling and reuse. Supercritical carbon dioxide (scCO₂) was pumped continuously through the 10-L extractor vessel for 7 hours from the time the operating conditions were achieved. After the 7-hour extraction cycle, the extractor vessel was slowly vented into the cyclone separator over 16 hours from 13.3 MPa to atmospheric pressure at 60° C. before the lid was opened and the stainless steel rack containing the dried aerogels was removed. The dry aerogels were removed from their stainless steel rack, and weighed.

### Method for Burnout and Pre-Sinter—Procedure A

The dried gel body was placed on a bed of zirconia beads in an alumina crucible. The crucible was covered with alumina fiberboard and then fired in air according to the following schedule:

1—Heat from 20° C. to 220° C. at 18° C./hour rate,

2—Heat from 220° C. to 244° C. at 1° C./hour rate,

3—Heat from 244° C. to 400° C. at 6° C./hour rate,

4—Heat from 400° C. to 1020° C. at 60° C./hour rate,

5—Cool from 1020° C. to 20° C. at 120° C./hour rate.

### Method for Burnout and Pre-Sinter—Procedure B

The dried gel body was placed on a bed of zirconia beads in an alumina crucible. The crucible was covered with alumina fiberboard and then fired in air according to the following schedule:

1—Heat from 20° C. to 190° C. at 18° C./hour rate,

2—Heat from 190° C. to 250° C. at 1° C./hour rate,

3—Heat from 250° C. to 400° C. at 6° C./hour rate,

4—Heat from 400° C. to 1020° C. at 60° C./hour rate,

5—Cool from 1020° C. to 20° C. at 120° C./hour rate.

### Method for Ion Exchange

The pre-sintered body was ion exchanged by first placing it in a 118 ml glass jar containing 1.0N NH₄OH at a depth of about 2.5 cm. It was then soaked overnight for at least 16 hours. The NH₄OH was then poured off and the jar was filled with distilled water. The body was soaked in the distilled water for 1 hour. The water was then replaced with fresh distilled water. This step was repeated until the pH of the soak water was equal to that of fresh distilled water. The body was then dried at 90-125° C. for a minimum of 1 hour.

### Method for Sintering

The pre-sintered, ion exchanged body was placed on a bed of zirconia beads in an alumina crucible. The crucible was covered with alumina fiberboard and the sample was then sintered in air according to the following schedule:

1—Heat from 20° C. to 1020° C. at 600° C./hour rate,

2—Heat from 1020° C. to 1320° C. at 120° C./hour rate,

3—Hold at 1320° C. for 2 hours,

4—Cool down from 1320° C. to 20° C. at 600° C./hour rate.

### Method for Measuring Shrinkage

The measurement of shrinkage from the mold to the sintered part was done as follows unless otherwise stated. The dimensions of the mold and the sintered part were measured from microscope images captured using NIS-Elements D imaging software available from Nikon Corporation, Tokyo, Japan. Manual measurement tools for length were used. It is expected that there would be an error of +/−1% linearly using this technique due to error in cursor placement. The measured linear shrinkage corresponded well for the formulated volume percent oxide. For example, the sol used for Example 4 was 10.1 volume percent. This would predict theoretically a linear shrinkage of 53.5%. The measured shrinkage (using the method described herein) for this sample was 53.2%, which matched the theoretically predicted shrinkage value very well. However, the variability between the predicted and measured shrinkage could vary slightly due to experimental error during preparation of the sol, concentration of the sol and preparation of the casting sol.

### Preparation of Sol-S1

Sol-S1 had a composition of ZrO₂ (89.9 mol %)/Y₂O₃ (9.6 mol %)/La₂O₃ (0.5 mol %) in terms of inorganic oxides. A hydrothermal reactor was used for preparing the Sol-S1. The hydrothermal reactor was prepared from 15 meters of stainless steel braided smooth tube hose (0.64 cm inside diameter, 0.17 cm thick wall; obtained under the trade designation “DUPONT T62 CHEMFLUOR PTFE” from Saint-Gobain Performance Plastics, Beaverton, Mich.). This tube was immersed in a bath of peanut oil heated to the desired temperature. Following the reactor tube, a coil of an additional 3 meters of stainless steel braided smooth tube hose (“DUPONT T62 CHEMFLUOR PTFE”; 0.64 cm I.D., 0.17 cm thick wall) plus 3 meters of 0.64 cm stainless-steel tubing with a diameter of 0.64 cm and wall thickness of 0.089 cm was immersed in an ice-water bath to cool the material and a backpressure regulator valve was used to maintain an exit pressure of 3.45 MPa.

A precursor solution was prepared by combining the zirconium acetate solution (2,000 grams) with DI water (2074.26 grams). Yttrium acetate (252.04 grams) and lanthanum oxide (6.51 grams) were added while mixing until fully dissolved. The solids content of the resulting solution was measured gravimetrically as described above (120° C./hour forced air oven) to be 20.83 weight %. DI water (417.6 grams) was added to adjust the final concentration to 19 weight %. The resulting solution was pumped at a rate of 11.48 ml/min. through the hydrothermal reactor. The temperature was 225° C. and the average residence time was 42 minutes. A clear and stable zirconia sol was obtained.

### Preparation of Sol-S2 to Sol-S6

Sol-S2 to Sol-S6 were prepared in a similar manner to Sol-S1, except that the compositions and temperatures were varied. The compositions and reaction temperatures for Sol-S1 to Sol-S6 are listed in Table 1, below.

TABLE 1

| | Temperature | | | |
|---|---|---|---|---|
| Sol | (° C.) | Mole % ZrO₂ | Mole % Y₂O₃ | Mole % La₂O₃ |
| Sol- S1 | 225 | 89.9 | 9.6 | 0.5 |
| Sol- S2 | 214 | 97.7 | 2.3 | 0 |
| Sol- S3 | 207 | 88 | 12 | 0 |
| Sol- S4 | 225 | 95.76 | 4.24 | 0 |
| Sol- S5 | 225 | 95.76 | 4.24 | 0 |
| Sol- S6 | 225 | 88 | 12 | 0 |

The properties of Sol-S1 to Sol-S6 were determined using the methods described above. Table 2, below, summarizes the PCS data such as Z-Average size (nm), Polydispersity Index (PI) and light transmission (% T) data for each of Sol-S1 to Sol-S6 (at 1 weight % and 10 weight %) at 600 nm and 420 nm. The light transmission was based on Method A described above.

TABLE 2

| | | | Volume | % T @ | % T @ | % T @ | % T @ |
|---|---|---|---|---|---|---|---|
| | Z-Average | | Average | 1% and | 1% and | 10% and | 10% and |
| Sol | Size (nm) | PI | Size (nm) | 600 nm | 420 nm | 600 nm | 420 nm |
| Sol- S1 | 16.29 | 0.228 | 11.73 | 96.64 | 90.61 | 80.11 | 46.07 |
| Sol- S2 | 16.52 | 0.295 | 6.40 | 96.28 | 83.26 | 76.26 | 29.25 |
| Sol- S3 | 14.98 | 0.114 | 11.84 | 97.89 | 92.71 | 86.99 | 54.28 |
| Sol- S4 | 16.17 | 0.243 | 9.14 | 96.45 | 86.95 | 82.51 | 43.88 |
| Sol- S5 | 15.72 | 0.242 | 8.83 | 96.58 | 87.35 | 84.70 | 48.58 |
| Sol- S6 | 14.72 | 0.280 | 9.89 | 98.27 | 94.57 | 87.94 | 60.40 |

Table 3, below, summarizes the crystallite size and dispersion index (DI) data for each of Sol-S1 to Sol-S6 determined from XRD analysis and PCS as described above.

TABLE 3

| | | | | | Volume | |
|---|---|---|---|---|---|---|
| | M | M size | C/T | C/T size | Average | |
| Sol | Intensity | (nm) | intensity | (nm) | (nm) | DI |
| Sol- S1 | ND | ND | 100 | 5.4 | 5.4 | 2.17 |
| Sol- S2 | 13 | 4.5 | 100 | 8.5 | 8.5 | 0.75 |
| Sol- S3 | ND | ND | 100 | 5.5 | 5.5 | 2.15 |
| Sol- S4 | ND | ND | 100 | 6.9 | 6.9 | 1.32 |
| Sol- S5 | ND | ND | 100 | 7.0 | 7.0 | 1.26 |
| Sol- S6 | ND | ND | 100 | 4.7 | 4.7 | 2.10 |

ND means not determined.

Sol-S1 to Sol-S6 were further processed to increase their concentration, remove acetic acid or incorporate ethanol. A combination of one or more of ultrafiltration, diafiltration and distillation were used. The diafiltration and ultrafiltration were performed using a membrane cartridge (obtained under the trade designation “M21S-100-01P” from Spectrum Laboratories Inc., Rancho Dominguez, Calif.). Distillation was performed using rotary evaporation.

### Example 1

To prepare Example 1, Sol-S1 was concentrated to a composition of 37.9 weight % oxide and 9.9 weight % acetic acid. Then, to prepare a casting sol, 542.2 grams of the concentrated Sol-S1, MEEAA (14.7 grams), and diethylene glycol monoethyl ether (162.9 grams) were charged to a 1000 ml round bottom (RB) flask and mixed. The sample weight was reduced by 312.6 grams via rotary evaporation. Diethylene glycol monoethyl ether (38.5 grams), acrylic acid (22.2 grams), and ethoxylated trimethylolpropane triacrylate (“SR454”) (39.0 grams) were added to the flask. IRGACURE 819 (0.41 gram) was dissolved in diethylene glycol monoethyl ether (14.5 grams) and charged to the flask with stirring. The resulting sol was passed through a 1 micron filter. The sol (i.e., casting sol) contained 39.39 weight % oxide (approximately 10.1 volume %) and 41.38 weight % solvent.

Then, a gel disc was formed from the above casting sol by injecting the sol into a cavity mold. The disc dimensions were defined by a stainless steel open cylinder that was 61.71 mm in diameter by 2.67 mm high. The faces of the mold were defined by a 10 mil (250 micrometer) PET film that was supported on one side by DELRIN and LEXAN on the other. The LEXAN allowed light to pass through and cure the sol to form the gel disc. Sol was supplied to the cavity mold from a syringe through tubing and an inlet port. The cavity mold was also equipped with an outlet port. When the sol filled the mold with no bubble inclusions and was exiting through the outlet port the mold was closed off using shut off valves to trap the sol in the mold. The mold fixture was then placed in an 8-bulb light box described above and the sol was cured for 3 minutes. The gel was left in the stainless steel open cylinder with the cured gel faces exposed to ambient conditions. Shims that extended just beyond the gel were secured to the front and back of the stainless steel mold on the top and bottom to prevent the gel from falling out during super critical extraction. The disc was held in the vertical orientation during extraction by placing it in a rack. The disc was dried using super critical extraction as described above. The resulting aerogel was crack free.

Then the resulting aerogel was burned out and pre-sintered according to Schedule A described above. The resulting pre-sintered disc was crack free and flat. The disc was ion exchanged according to the above described procedure.

Finally, the pre-sintered disc was sintered according to the procedure above. The sintered disc was crack free and flat. The smooth surfaces of the PET film were replicated resulting in faces that were smooth and glossy. When the disc was placed on printed material such as a tape with a printed “3M” insignia, the printed characters were clearly visible. The diameter of the sintered disc had shrunk 52.7 linear percent as compared to the mold diameter. The Archimedes density of the sintered disc was measured as described above to be 5.99 g/cc.

### Example 2

To prepare Example 2, Sol-S2 was concentrated to a composition of 41.14 weight % oxide and 11.49 weight % acetic acid. Then, to prepare the casting sol, the concentrated Sol-S2 (537.57 grams), MEEAA (7.90 grams), and diethylene glycol monoethyl ether (116.36 grams) were charged to a 1000 ml RB flask and mixed. The sample weight was reduced by 296.49 grams via rotary evaporation. The concentrated sol (78.62 grams) was charged to a jar and combined with diethylene glycol monoethyl ether (23.79 grams), acrylic acid (5.15 grams), isobornyl acrylate (“SR506 A”) (4.47 grams), 1,6-hexanediol diacrylate (“SR238 B”) (1.84 grams), and pentaerythritol tetraacrylate (“SR295”) (4.36 grams). IRGACURE 819 (0.0955 gram) was dissolved in diethylene glycol monoethyl ether (3.40 grams) and charged to the flask with stirring. The resulting sol was passed through a 1 micron filter. The sol (i.e., casting sol) contained 39.76 weight % oxide (approximately 10.1 volume %) and 43.63 weight % solvent.

Then, a gel disc was molded using the prismatic array mold described above from the above casting sol. A 100.6 mm×152.4 mm glass plate was covered with a sheet of 10 mil (250 micrometer) PET. The mold was then attached to the PET with double sided tape. The shape and dimensions of the molded gel were defined using a 2.54 mm high by 25.4 mm diameter polycarbonate ring. The polycarbonate ring was adhered to the structured film by applying a thin coating of 3M ESPE IMPRINT 3 LIGHT BODY VPS IMPRESSION MATERIAL to the bottom edge of the ring and pressing it into the film tool. This was done to form a seal that would prevent leaking of the cast sol. The impression material was allowed to cure. The sol was pipetted into the mold until it crowned above the edge of the mold. A piece of 10 mil (250 micrometer) PET was carefully placed over the top of the sol in a fashion to avoid bubble formation. This film defines one face of the molded gel and acts as a barrier to oxygen inhibition of cure. The construction was moved to an 8-bulb light box described above for curing. The sol was light cured for 3 minutes to form the gel. The resulting gel was carefully removed from the mold. The resulting gel had dry surfaces and was crack free. It was placed in a sealed container until it was dried using super critical extraction as described above. The resulting aerogel was crack free.

The resulting aerogel was burned out and pre-sintered according to schedule A. The resulting pre-sintered disc was crack free and flat. The disc was ion exchanged according to the above procedure.

Finally, the pre-sintered disc was sintered according to the procedure described above. The sintered disc was crack free and contained features that replicated the film tool structure very well. The sharp peaks and valleys of the prismatic array mold were present and the features were parallel and undistorted. The sintered body underwent a shrinkage of 53.9% linearly compared to the mold. The Archimedes density was measured to be 6.10 g/cc using the method described above. The translucency was as expected for a fully dense sintered material of this composition.

### Example 3

To prepare Example 3, the same casting sol as described above for Example 2 was used.

A gel disc was made using the same procedure as used in Example 2 except the hexagonal post mold described above was used instead of the prismatic array mold to create a structure. The resulting gel had dry surfaces and was crack free. It was placed in a sealed container until it was dried using super critical extraction as described above. The resulting aerogel was crack free.

The resulting aerogel was burned out and pre-sintered according to schedule A. The resulting pre-sintered disc was crack free and flat. The disc was ion exchanged according to the above procedure.

Finally, the pre-sintered disc was sintered according to procedure described above. The sintered disc was crack free and contained features that replicated the film tool structure very well. The resulting positive hexagonal posts had sharp edges and the array of posts were parallel and undistorted. Machine lines present in the mold were replicated. The sintered body underwent a shrinkage of 52.9% linearly in height compared to the mold. The Archimedes density was measured to be 6.11 g/cc using the above method. The translucency was as expected for a fully dense sintered material of this composition.

### Example 4

Example 4 was prepared in the same manner as Example 3 above, except that a gel disc was made using the fiducial mold described above to create a structure. The fiducial mold was placed on a 100.6 mm×152.4 mm glass plate that was covered with a sheet of 10 mil (250 micrometer) PET. The shape and dimensions of the molded gel were defined using a 2.54 mm high by 25.4 mm diameter polycarbonate ring. The polycarbonate ring was adhered to the fiducial mold by applying a thin coating of 3M ESPE IMPRINT 3 LIGHT BODY VPS IMPRESSION MATERIAL to the bottom edge of the ring and pressing it into the tool. This was done to form a seal that would prevent leaking of the cast sol. The impression material was allowed to cure. The sol was pipetted into the mold until it crowned above the edge of the mold. A piece of 10 mil (250 micrometer) PET was carefully placed over the top of the sol in a fashion to avoid bubble formation. This film defined one face of the molded gel and acted as a barrier to oxygen inhibition of cure. The construction was moved to an 8-bulb light box for curing as described above. The sol was light cured for 3 minutes to form the gel. The resulting gel was carefully removed from the mold. The resulting gel had dry surfaces and was crack free. It was placed in a sealed container until it was dried using super critical extraction as described above. The resulting aerogel was crack free and reduced in size by 18.9 linear percent from the gel body.

The resulting aerogel was burned out and pre-sintered according to schedule A. The resulting pre-sintered disc was crack free and flat. The disc was ion exchanged according to the above procedure.

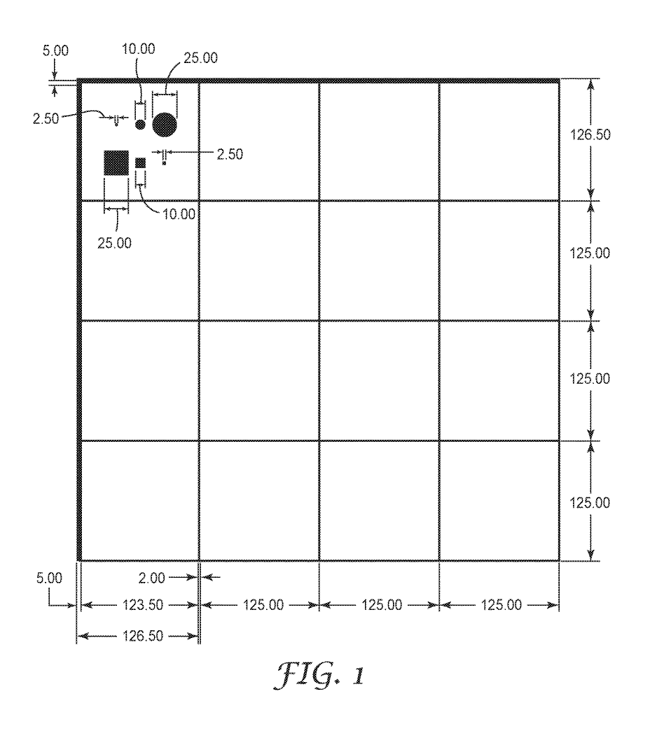

The pre-sintered disc was sintered according to the procedure described above. The sintered disc was crack free and contained features that replicated the fiducial mold structure very well, including the smallest 2.5 micron features, with a shrinkage factor of 53.2% linearly. The translucency was as expected for a fully dense sintered material of this composition. No distortion of the linear features was measured. FIG. 1 is a schematic drawing of the metrology features contained on the face of the fiducial mold for one of the 500 micron by 500 micron grids.

Analysis of the fiducial features of the sintered part was done using an interferometer and the dimensions compared to the mold features. This was done to determine uniformity of shrinkage.

Shrinkage of the outer grid compared to the inner grid was determined to be 53.2 linear percent (((2.34 mm-5 mm)/5 mm)*100). Measurement of 6 squares within each of the 5 grids to determine uniformity of shrinkage showed shrinkage of 53.3 linear percent with a standard deviation of 0.27 (((58.49 mm-125.2 mm)/125.2 mm)*100). The difference in shrinkage was within the accuracy of the metrology method.

### Example 5

Example 5 was prepared in the same manner as Example 4 above, except that a structured gel square was made using a mold designated as Push Mould 2013 (made in People's Republic of China, available from Staedtler Mars GmbH & Co. KG, Nuremberg, Germany). The sol was pipetted into the mold until it crowned above the edge of the mold. A piece of 10 mil (250 micrometer) PET was carefully placed over the top of the sol in a fashion to avoid bubble formation. This film defined one face of the molded gel and acted as a barrier to oxygen inhibition of cure. The construction was moved to a 1-bulb light box for curing as described above. The sol was light cured for 3 minutes to form the gel. The resulting gel was carefully removed from the mold. The resulting gel had dry surfaces and was crack free. It was placed in a sealed container until it was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

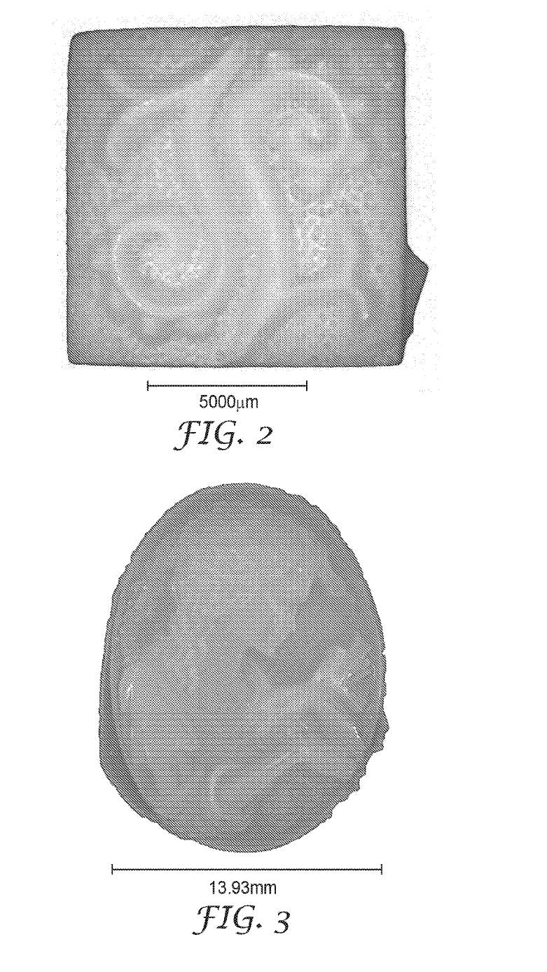

Finally, the pre-sintered body was sintered according to the procedure described above. The sintered body was crack free and contained features that replicated the mold structure very well with a shrinkage factor of about 53% as expected. The translucency was as expected for a fully dense sintered material of this composition. An image of the sintered part is shown in FIG. 2.

### Example 6

To prepare Example 6, Sol-S3 was concentrated to a composition of 42.53 weight % oxide and 7.0 weight % acetic acid. Then, to prepare the casting sol, the concentrated Sol-S3 (150.02 grams), MEEAA (4.54 grams), and diethylene glycol monoethyl ether (61.73 grams) were charged to a 250 ml RB flask and mixed. The sample weight was reduced by 75.90 grams via rotary evaporation. The resulting sol (35.37 grams) was charged to a vial and combined with diethylene glycol monoethyl ether (0.54 gram), acrylic acid (1.74 grams), isobornyl acrylate (“SR506 A”) (1.51 grams), 1,6-hexanediol diacrylate (“SR238 B”) (0.62 gram), and pentaerythritol tetraacrylate (“SR295”) (0.80 gram). IRGACURE 819 (0.0323 gram) was added and stirred until dissolved. The sol was passed through a 1 micron filter. The viscosity was 147.7 cp at 7.68 l/sec. The sol contained 39.59 weight % oxide (approximately 10.1 volume %) and 39.63 weight % solvent.

A structured gel was made as described in Example 5, except the cup mold described above was used, and it was in an 8-bulb light box described above for curing. The resulting gel had dry surfaces and was crack free. It was placed in a sealed container until it was extracted. The surfaces of the gel were still dry the next day.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

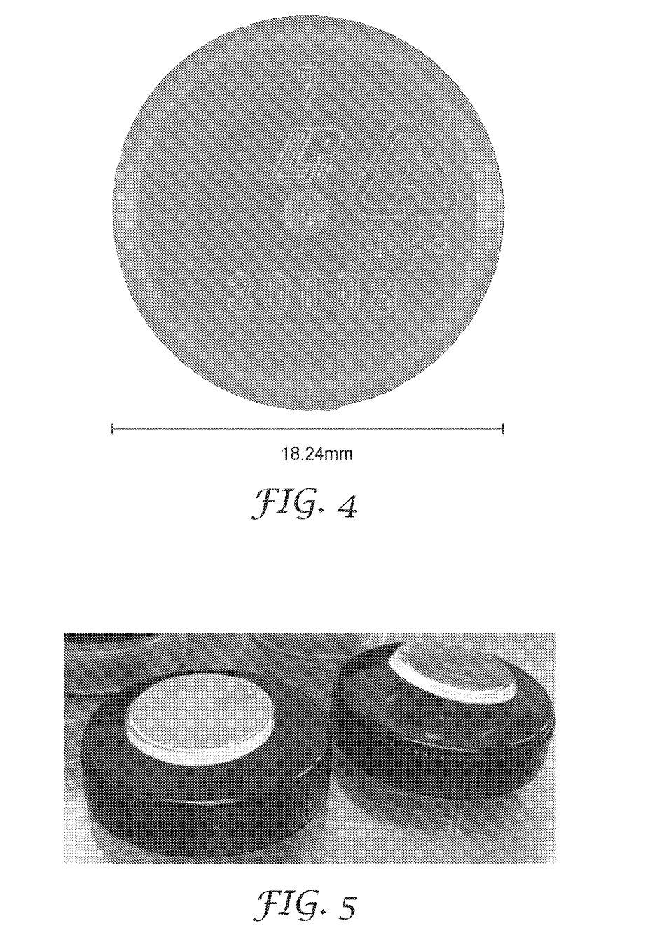

The pre-sintered body was sintered according to the procedure described above. The sintered body was crack free and contained features that replicated the cup mold features very well. The numbers, letters and symbols were all replicated with sharp edges and no distortion. The shrinkage factor was about 53% as expected. The Archimedes density was measured to be 5.98 g/cc using the above method. The translucency was as expected for a fully dense material of this composition. The sintered body is shown in FIG. 4.

### Example 7

To prepare Example 7, Sol-S4 was concentrated to a composition of 45.91 weight % oxide and 6.62 weight % acetic acid. Then, to prepare the casting sol, the concentrated Sol-S4 (533.21 grams), MEEAA (8.74 grams), and diethylene glycol monoethyl ether (131.32 grams) were charged to a 1000 ml RB flask and mixed. The sample weight was reduced by 266.47 grams via rotary evaporation. The resulting sol (25.99 grams) was charged to a vial and combined with diethylene glycol monoethyl ether (9.36 grams), acrylic acid (1.65 grams), and N-hydroxyethyl acrylamide (0.86 gram). IRGACURE 819 (0.0313 gram) was dissolved in diethylene glycol monoethyl ether (1.27 grams) and added to the vial. The sol was passed through a 1 micron filter. The viscosity was 21.9 cp at 15.36 l/sec. The sol contained 39.93 weight % oxide (approximately 10.1 volume %) and 48.57 weight % solvent.

A gel disc was molded from the above casting sol. A 100.6 mm×152.4 mm glass plate was covered with a sheet of 10 mil (250 micrometer) PET. The shape and dimensions of the molded gel were defined using a 2.54 mm high by 25.4 mm diameter polycarbonate ring. The polycarbonate ring was adhered to the 10 mil (250 micrometer) PET film by applying a thin coating of 3M ESPE IMPRINT 3 LIGHT BODY VPS IMPRESSION MATERIAL to the bottom edge of the ring and pressing it onto the PET film. This was done to form a seal that would prevent leaking of the cast sol. The impression material was allowed to cure. The sol was pipetted into the mold until it crowned above the edge of the mold. A piece of 10 mil (250 micrometer) PET was carefully placed over the top of the sol in a fashion to avoid bubble formation. This film defined the two faces of the molded gel and acted as a barrier to oxygen inhibition of cure. The construction was moved to an 8-bulb light box described above for curing. The sol was light cured for 3 minutes to form the gel. The resulting gel was carefully removed from the mold. The resulting gel had dry surfaces and was crack free. It was placed in a sealed container until it was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and replicated the mold very well. The shrinkage of the disc diameter was measured to be 53.3% using a caliper. The Archimedes density was measured to be 6.06 g/cc using the above method. The translucency was as expected for a fully dense material of this composition.

### Example 8

To prepare Example 8, Sol-S4 was concentrated to a composition of 45.91 weight % oxide and 6.62 weight % acetic acid. Then, to prepare the casting sol, the concentrated Sol-S4 (518.57 grams), MEEAA (8.51 grams), and diethylene glycol monoethyl ether (127.70 grams) were charged to a 1000 ml RB flask and mixed. The sample weight was reduced by 261.92 grams via rotary evaporation. The resulting sol (216.17 grams) was charged to a 500 ml RB flask and combined with diethylene glycol monoethyl ether (61.55 grams), acrylic acid (14.16 grams), and ethoxylated trimethylolpropane triacrylate (“SR454”) (24.91 grams). IRGACURE 819 (0.2621 gram) was dissolved in diethylene glycol monoethyl ether (12.07 grams) and added to the flask with stirring. The sol was passed through a 1 micron filter. The viscosity was 24.9 cp at 15.36 l/sec. The sol contained 39.81 weight % oxide (approximately 10.1 volume %) and 43.72 weight % solvent.

A gel disc was made using the same procedure as used in Example 2 except the hexagonal post mold described above was used to create a structure. The resulting gel had dry surfaces and was crack free. It was placed in a sealed container until it was extracted. The next day the top and bottom of the gel were wet.

The gel body was dried using super critical extraction as described above. The resulting aerogel was crack free.

The resulting aerogel was burned out and pre-sintered according to schedule B. The resulting pre-sintered body was crack free and flat. The body was ion exchanged according to the above procedure.

The pre-sintered body was sintered according to the procedure described above. The sintered disc was crack free and contained features that replicated the film tool structure very well. The resulting positive hexagonal posts had sharp edges and the array of posts were parallel and undistorted. Machine lines present in the mold were replicated. The sintered body underwent a shrinkage of 53.8% linearly. The Archimedes density was measured to be 6.04 g/cc using the method described above. The translucency was as expected for a fully dense material of this composition.

### Example 9

To prepare Example 9, Sol-S4 was concentrated to a composition of 45.91 weight % oxide and 6.62 weight % acetic acid. Then, to prepare the casting sol, the concentrated Sol-S4 (533.21 grams), MEEAA (8.74 grams), and diethylene glycol monoethyl ether (131.32 grams) were charged to a 1000 ml RB flask and mixed. The sample weight was reduced by 266.47 grams via rotary evaporation. The resulting sol (208.97 grams) was charged to a 500 ml RB flask and combined with diethylene glycol monoethyl ether (59.39 grams), acrylic acid (13.60 grams), isobornyl acrylate (“SR506 A”) (11.79 grams), 1,6-hexanediol diacrylate (“SR238 B”) (4.84 grams), and pentaerythritol tetraacrylate (“SR295”) (6.20 grams). IRGACURE 819 (0.2516 gram) was dissolved in diethylene glycol monoethyl ether (10.21 grams) and charged to the flask with stirring. The sol was passed through a 1 micron filter. The viscosity was 21.6 cp at 15.36 l/sec. The sol contained 39.89 weight % oxide (approximately 10.1 volume %) and 43.48 weight % solvent.

A gel body was prepared as in Example 4. The resulting gel had dry surfaces and was crack free. It was placed in a sealed container until it was extracted. The next day the gel was damp.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and contained features that replicated the fiducial mold structure very well, including the smallest 2.5 micron features and the scratches, with a shrinkage factor of 54.0% linearly. The Archimedes density was measured to be 6.06 g/cc using the method described above. The translucency was as expected for a fully dense material of this composition. No distortion of the linear features was measured.

### Example 10

Example 10 was run in the same manner as Example 9, except that the bottom face of the mold was the face of a button battery 11 mm in diameter. The battery face contained letters, numbers and symbols on the order of 1 to 2 mm in size negative to the surface. The sides of the mold were defined by tape wrapped around the battery. The sol was pipetted into the mold until it crowned above the edge of the mold. A piece of 10 mil (250 micrometer) PET was carefully placed over the top of the sol in a fashion to avoid bubble formation. This film defined one face of the molded gel and acted as a barrier to oxygen inhibition of cure. The construction was moved to an 8-bulb light box described above for curing. The sol was light cured for 3 minutes to form the gel. The resulting gel was carefully removed from the mold. The resulting gel had dry surfaces and was crack free. It was placed in a sealed container until it was extracted. The next day the gel surfaces were dry.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and contained features that replicated the battery face structure very well. The numbers, letters and symbols were all replicated with sharp edges and no distortion. The shrinkage factor was about 53% as expected. The Archimedes density was measured to be 6.04 g/cc using the method above. The translucency was as expected for a fully dense material of this composition.

### Example 11

To prepare Example 11, Sol-S4 was concentrated to a composition of 45.91 weight % oxide and 6.62 weight % acetic acid. Then, to prepare the casting sol, the concentrated Sol-S4 (550.15 grams), MEEAA (9.02 grams), and diethylene glycol monoethyl ether (135.45 grams) were charged to a 1000 ml RB flask and mixed. The sample weight was reduced by 274.28 grams via rotary evaporation. The resulting sol (105.03 grams) was charged to a 250 ml RB flask and combined with diethylene glycol monoethyl ether (34.37 grams), acrylic acid (6.83 grams), and ethoxylated trimethylolpropane triacrylate (“SR454”) (12.01 grams). IRGACURE 819 (0.1262 gram) was added to the flask, stirring until dissolved. The sol was passed through a 1 micron filter. The sol contained 39.85 weight % oxide (approximately 10.1 volume %) and 43.07 weight % solvent.

A structured gel was made using the same procedure as in Example 5 except a silicone push mold cavity designated as Longzang F0188S Fondant Silicone Sugar Craft Mold, Mini available from Amazon.com was used. The resulting gel had wet surfaces and was crack free. It was placed in a sealed container until it was extracted.

The gel body was dried using super critical extraction as described above. The resulting aerogel was crack free.

The resulting aerogel was burned out and pre-sintered according to schedule B. The resulting pre-sintered body was crack free and flat. The body was ion exchanged according to the above procedure.

The pre-sintered body was sintered according to the procedure described above. The sintered part was crack free and replicated the intricate features of the mold structure very well with a uniform shrinkage of about 53% as expected. The Archimedes density was measured to be 6.06 g/cc using the method above. The translucency was as expected for a fully dense material of this composition. FIG. 3 is an image of the sintered Example 11 sample.

### Example 12

Example 12 was run using the casting sol described in Example 9.

A structured gel was made as described in Example 5 except that the cup mold described above was used. The resulting gel had dry surfaces and was crack free. It was placed in a sealed container until it was extracted. The surfaces of the gel were still dry the next day.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and contained features that replicated the cup mold features very well. The numbers, letters and symbols were all replicated with sharp edges and no distortion. The shrinkage factor was about 53% as expected. The Archimedes density was measured to be 6.05 g/cc using the method described above. The translucency was as expected for a fully dense material of this composition.

### Example 13

Example 13 was run using the casting sol described in Example 9.

A structured gel was made as described in Example 5 except that the food container mold described above was used. The resulting gel had dry surfaces and was crack free. It was placed in a sealed container until it was extracted. The surfaces of the gel were still dry the next day.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and contained features that replicated the container mold features very well. The numbers, letters and symbols were all replicated with sharp edges and no distortion. The shrinkage factor was about 53% as expected. The Archimedes density was measured to be 6.07 g/cc using the method described above. The translucency was as expected for a fully dense material of this composition.

### Example 14

To prepare Example 14, Sol-S4 was concentrated to a composition of 45.91 weight % oxide and 6.62 weight % acetic acid. Then, to prepare the casting sol, the concentrated Sol-S4 (533.21 grams), MEEAA (8.74 grams), and diethylene glycol monoethyl ether (131.32 grams) were charged to a 1000 ml

RB flask and mixed. The sample weight was reduced by 266.47 grams via rotary evaporation. The resulting sol (26.57 grams) was charged to a vial and combined with diethylene glycol monoethyl ether (7.28 grams), acrylic acid (1.73 grams), isobornyl acrylate (“SR506 A”) (1.50 grams), 1,6-hexanediol diacrylate (“SR238 B”) (0.62 gram), and a hexafunctional urethane acrylate (“CN975”) (1.11 grams). IRGACURE 819 (0.0323 gram) was dissolved in diethylene glycol monoethyl ether (1.31 grams) and added to the vial. The sol was passed through a 1 micron filter. The viscosity was 24.3 cp at 15.36 l/sec. The sol contained 39.83 weight % oxide (approximately 10.1 volume %) and 42.76 weight % solvent.

A gel disc was made using the same procedure as used in Example 2 except the hexagonal post mold described above was used to create a structure. The resulting gel had dry surfaces and was crack free. It was placed in a sealed container until it was extracted. The next day the surfaces of the gel were dry.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered disc was crack free and contained features that replicated the film tool structure very well. The resulting positive hexagonal posts had sharp edges and the array of posts were parallel and undistorted. The post faces contained no residue. Machine lines present in the mold were replicated. The sintered body underwent a shrinkage of 53.3% linearly. The Archimedes density was measured to be 6.06 g/cc using the method described above. The translucency was as expected for a fully dense material of this composition.

### Example 15

To prepare Example 15, Sol-S2 was concentrated to a composition of 40.71 weight % oxide and 11.28 weight % acetic acid. Then, to prepare the casting sol, the concentrated Sol-S2 (401.1 grams), MEEAA (5.81 grams), and diethylene glycol monoethyl ether (185.52 grams) were charged to a 1000 ml RB flask and mixed. The sample weight was reduced by 218.92 grams via rotary evaporation. Acrylic acid (17.28 grams), and N-(2-Hydroxyethyl) Acrylamide (HEAA) (8.85 grams) were added to the flask. IRGACURE 819 (0.3288 gram) was dissolved in diethylene glycol monoethyl ether (38.82 grams) and charged to the flask with stirring. The sol contained 37.25 weight % oxide (approximately 8.9 volume %) and 51.19 weight % solvent. The sol was passed through a 1 micron filter.

A structured gel was made by casting the above sol into a silicone push mold cavity designated as Bead Clear Silicone Mold by Oksana Bell purchased on etsy.com. The sol was pipetted into the mold until it crowned above the edge of the mold. A piece of 10 mil (250 micrometer) PET was carefully placed over the top of the sol in a fashion to avoid bubble formation. A glass slide was then placed over the film. This film defines one face of the molded gel and acts as a barrier to oxygen inhibition of cure. The construction was moved to an 8-bulb light box described above for curing. The sol was light cured for 3 minutes to form the gel. The resulting gel was carefully removed from the mold. The resulting gel had wet surfaces and was crack free. It was placed in a sealed container until it was extracted. This was repeated to form multiple beads.

The gel bodies were dried using super critical extraction as described above. The resulting aerogel beads were crack free.

The resulting aerogels were burned out and pre-sintered according to schedule B. The resulting pre-sintered bodies were crack free. The bodies were ion exchanged according to the above procedure.

The pre-sintered bodies were sintered according to the procedure described above. The sintered stringing beads had an outer diameter of 4.17 mm, an inner diameter of 2.16 mm and a height of 3.43 mm. They were crack free and replicated the mold well with a shrinkage of about 53% as expected. The translucency was as expected for a fully dense material of this composition.

### Example 16

To prepare Example 16, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (300 grams), MEEAA (8.15 grams), and diethylene glycol monoethyl ether (169.25 grams) were charged to a 1000 ml RB flask and mixed. The sample weight was reduced to 431.69 grams via rotary evaporation. Acrylic acid (3.95 grams), and ethoxylated trimethylolpropane triacrylate (“SR454”) (6.98 grams) were added to a jar containing the ZrO₂ sol (70.01 grams). IRGACURE 819 (0.0731 gram) was dissolved in diethylene glycol monoethyl ether (11.1 grams) and charged to the jar. The viscosity was 26.7 cp at 15.36 l/sec. The sol contained 39.66 weight % oxide (approximately 10.1 volume %) and 42.6 weight % solvent.

A gel body was molded using the procedure of Example 7. The resulting gel was carefully removed from the mold and was crack free. The resulting gel surfaces were wet top and bottom. The gel replicated the mold well. It was placed in a sealed container until it was extracted.

The gel body was dried using super critical extraction as described above. The resulting aerogel was crack free and reduced in size by 18.9 linear percent from the gel body.

The resulting aerogel was burned out and pre-sintered according to schedule B. The resulting pre-sintered body was crack free. The body was ion exchanged according to the above procedure.

### Example 17

To prepare Example 17, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (300 grams), MEEAA (8.15 grams), and diethylene glycol monoethyl ether (169.25 grams) were charged to a 1000 ml RB flask and mixed. The sample weight was reduced to 431.69 grams via rotary evaporation. Heasuccinate (3.95 grams), and ethoxylated trimethylolpropane triacrylate (“SR454”) (6.96 grams) were added to a jar containing the ZrO₂ sol (69.95 grams). IRGACURE 819 (0.0729 gram) was dissolved in diethylene glycol monoethyl ether (11.29 grams) and charged to the jar. The viscosity was 31.2 cp at 15.36 l/sec. The sol contained 39.63 weight % oxide (approximately 10.1 volume %) and 42.6 weight % solvent.

A gel body was molded using the procedure of Example 7. The resulting gel was crack free. The resulting gel surfaces were wet top and bottom and the resulting gel was white and opaque. The gel replicated the mold well. It was placed in a sealed container until it was extracted.

The gel body was dried using super critical extraction as described above. The resulting aerogel was crack free and reduced in size by 19.8 linear percent from the gel body.

The resulting aerogel was burned out and pre-sintered according to schedule B. The resulting pre-sintered body was crack free. The body was ion exchanged according to the above procedure.

### Example 18

To prepare Example 18, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (300 grams), MEEAA (8.15 grams), and diethylene glycol monoethyl ether (169.25 grams) were charged to a 1000 ml RB flask and mixed. The sample weight was reduced to 431.69 grams via rotary evaporation. Beta-Carboxyacrylate (3.96 grams), and ethoxylated trimethylolpropane triacrylate (“SR454”) (6.95 grams) were added to a jar containing the ZrO₂ sol (70.01 grams). IRGACURE 819 (0.0725 gram) was dissolved in diethylene glycol monoethyl ether (11.24 grams) and charged to the jar. The viscosity was 30.7 cp at 15.36 l/sec. The sol contained 39.63 weight % oxide (approximately 10.1 volume %) and 41.92 weight % solvent.

A structured gel was made as described in Example 5 except the beaker mold described above was used, and it was in an 8-bulb light box described above for curing. The resulting gel was carefully removed from the mold with no cracks forming during this process. The resulting gel surfaces were wet top and bottom and the gel was white and opaque, but less so than Example 17. The gel replicated the mold well. It was placed in a sealed container until it was extracted. Examination of the gel after sitting overnight and prior to extraction showed it to be a whitish, but less so than Example 17.

The gel body was dried using super critical extraction as described above. The resulting aerogel was crack free and reduced in size by 19.4 linear percent from the gel body.

The resulting aerogel was burned out and pre-sintered according to schedule B. The resulting pre-sintered body was crack free. The body was ion exchanged according to the above procedure.

The pre-sintered body was sintered according to the procedure described above. The sintered body was crack free and contained features that replicated the beaker mold features very well. The numbers and symbols were all replicated with sharp edges and no distortion. The shrinkage factor was about 53% as expected. The Archimedes density was measured to be 6.04 g/cc using the method described above. The translucency was lower than expected for a fully dense material of this composition.

### Example 19

To prepare Example 19, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (200 grams), MEEAA (3.29 grams), and N,N-dimethylformamide (66.69 grams) were charged to a 500 ml RB flask and mixed. The sample weight was reduced to 145.73 grams via rotary evaporation. N,N-dimethylformamide (20.63 grams) was added to the flask. Acrylic acid (4.10 grams), and ethoxylated trimethylolpropane triacrylate (“SR454”) (7.19 grams) were added to a jar containing the ZrO₂ sol (70.01 grams). IRGACURE 819 (0.077 gram) was dissolved in N,N-dimethylformamide (12.4 grams) and charged to the jar. The viscosity was 7.92 cp at 38.4 l/sec. The sol contained 40.4 weight % oxide (approximately 10.1 volume %) and 43.3 weight % solvent.

A structured gel was made as described in Example 5 except the beaker mold described above was used, and it was in an 8-bulb light box described above for curing. This gel had very good release from the mold. The resulting gel surfaces were wet top and bottom and the gel was very translucent. The gel replicated the mold well. It was placed in a sealed container until it was extracted. Examination of the gel after sitting overnight and prior to extraction showed it to be a very clear gel with wet surfaces.

The gel body was dried using super critical extraction as described above. The resulting aerogel was crack free and reduced in size by 17.0 linear percent from the gel body.

The resulting aerogel was burned out and pre-sintered according to schedule B. The resulting pre-sintered body was crack free. The body was ion exchanged according to the above procedure.

The pre-sintered body was sintered according to the procedure described above. The sintered body was crack free and contained features that replicated the beaker mold features very well. The numbers and symbols were all replicated with sharp edges and no distortion. The shrinkage factor was about 53% as expected. The Archimedes density was measured to be 6.06 g/cc using the method described above. The translucency was as expected for a fully dense material of this composition.

### Example 20

To prepare Example 20, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (125.06 grams), MEEAA (4.01 grams), and propylene carbonate (41.19 grams) were charged to a 500 ml RB flask and mixed. The sample weight was reduced to 108.37 grams via rotary evaporation. Acrylic acid (3.93 grams), and ethoxylated trimethylolpropane triacrylate (“SR454”) (6.91 grams) were added to a jar containing the ZrO₂ sol (69.99 grams). IRGACURE 819 (0.072 gram) was dissolved in propylene carbonate (18.0 grams) and charged to the jar. The viscosity was 17.3 cp at 19.2 l/sec. The sol contained 36.76 weight % oxide (approximately 10.1 volume %) and 45.07 weight % solvent.

A structured gel was made as described in Example 5 except the beaker mold described above was used, and it was in an 8-bulb light box described above for curing. The resulting gel surfaces were wet top and bottom. The gel replicated the mold well. It was placed in a sealed container until it was extracted. Examination of the gel after sitting overnight and prior to extraction showed it to be a very clear, blue gel with wet surfaces.

The gel body was dried using super critical extraction as described above. The resulting aerogel was crack free and reduced in size by 18.0 linear percent from the gel body.

The resulting aerogel was burned out and pre-sintered according to schedule B. The resulting pre-sintered body that was crack free. The body was ion exchanged according to the above procedure.

The pre-sintered body was sintered according to the procedure described above. The sintered body was crack free and contained features that replicated the beaker mold features very well. The numbers and symbols were all replicated with sharp edges and no distortion. The shrinkage factor was about 53% as expected. The Archimedes density was measured to be 6.06 g/cc using the method above. The translucency was as expected for a fully dense material of this composition.

### Example 21

To prepare Example 21, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (125.11 grams), MEEAA (2.03 grams), and diethylene glycol monomethy ether (42.1 grams) were charged to a 500 ml RB flask and mixed. The sample weight was reduced to 108.38 grams via rotary evaporation. Acrylic acid (3.95 grams), and ethoxylated trimethylolpropane triacrylate (“SR454”) (6.91 grams) were added to a jar containing the ZrO₂ sol (70.05 grams). IRGACURE 819 (0.0715 gram) was dissolved in diethylene glycol monomethyl ether (11.6 grams) and charged to the jar. The viscosity was 31.1 cp at 19.2 l/sec. The sol contained 39.30 weight % oxide (approximately 10.1 volume %) and 41.9 weight % solvent.

A gel body was molded using the procedure of Example 7. The resulting gel was crack free. The resulting gel surfaces were wet top and bottom. The gel replicated the mold well. It was placed in a sealed container until it was extracted.

The gel body was dried using super critical extraction as described above. The resulting aerogel was crack free and reduced in size by 18.4 linear percent from the gel body.

The resulting aerogel was burned out and pre-sintered according to schedule B. The resulting pre-sintered body was crack free. The body was ion exchanged according to the above procedure.

### Example 22

To prepare Example 22, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (125.37 grams), MEEAA (2.01 grams), and diethylene glycol (42.2 grams) were charged to a 500 ml RB flask and mixed. The sample weight was reduced to 107.9 grams via rotary evaporation. Acrylic acid (3.96 grams), and ethoxylated trimethylolpropane triacrylate (“SR454”) (6.96 grams) were added to a jar containing the ZrO₂ sol (70.08 grams). IRGACURE 819 (0.0731 gram) was dissolved in diethylene glycol (16.37 grams) and charged to the jar. The viscosity was 130.2 cp at 7.68 l/sec. The sol contained 37.62 weight % oxide (approximately 10.1 volume %) and 45.10 weight % solvent.

A structured gel was made as described in Example 5 except the beaker mold described above was used, and it was in an 8-bulb light box described above for curing. The resulting gel had a smear on the top surface and the bottom surface was dry. The gel replicated the mold well. It was placed in a sealed container until it was extracted. Examination of the gel after sitting overnight and prior to extraction showed it to be a very clear, slightly blue gel with slightly wet surfaces.

The gel body was dried using super critical extraction as described above. The resulting aerogel was crack free and reduced in size by 18.7 linear percent from the gel body.

The resulting aerogel was burned out and pre-sintered according to schedule B. The resulting pre-sintered body was crack free. The body was ion exchanged according to the above procedure.

The pre-sintered body was sintered according to the procedure described above. The sintered body was crack free and contained features that replicated the beaker mold features very well. The numbers and symbols were all replicated with sharp edges and no distortion. The shrinkage factor was about 53% as expected. The Archimedes density was measured to be 6.05 g/cc using the method above. The translucency was as expected for a fully dense material of this composition.

### Comparative Example A

To prepare Comparative Example A, Sol-S5 was concentrated to a composition of 45.04 weight % oxide and 6.62 weight % acetic acid and the liquid phase was 59.91 weight % ethanol. Then, to prepare the casting sol, the concentrated Sol-S5 (37.65 grams) was charged to a vial and combined with acrylic acid (1.79 grams), 2-hydroxyethyl methacrylate (0.92 gram), and ethanol (0.16 gram). IRGACURE 819 (0.0342 gram) was added to the vial, mixing until dissolved. The sol was passed through a 1 micron filter. The sol contained 41.81 weight % oxide (approximately 10.1 volume %) and 46.86 weight % solvent.

A gel body was molded using the procedure of Example 7. The resulting gel was carefully removed from the mold and was crack free. The gel was allowed to sit out in ambient conditions. Bowing was visible after 3 minutes. After 4.5 minutes, edge cracks formed. Observation continued for another 8.5 minutes. After a total ambient drying time of 13 minutes the gel was badly bowed and cracked. The dried article is shown in FIG. 5 (right side).

### Example 23

Example 23 was run using the casting sol described in Example 9. A structured gel was made as described in Example 7. The resulting gel was carefully removed from the mold and was crack free. The gel was allowed to sit out in ambient conditions. It showed no signs of bowing or cracking during the 13 minutes of observation. It was then placed in a sealed container. FIG. 5 is a micrograph of molded gel samples of Comparative Example A (which was badly bowed and cracked) and Example 23 (which was crack free and flat) after ambient drying for 13 minutes. The dried article is shown in FIG. 5 (left side).

### Example 24

To prepare Example 24, Sol-S6 was concentrated to a composition of 34.68 weight % oxide and 3.70 weight % acetic acid. Then, to prepare the casting sol, the concentrated Sol-S6 (313.94 grams), MEEAA (3.90 grams), and diethylene glycol monoethyl ether (123.68 grams) were charged to a 1000 ml RB flask and mixed. The sample weight was reduced by 191.75 grams via rotary evaporation. Acrylic acid (11.52 grams), and N-(2-Hydroxyethyl) Acrylamide (HEAA) (5.90 grams) were added to the flask. IRGACURE 819 (0.2204 gram) was dissolved in diethylene glycol monoethyl ether (25.88 grams) and charged to the flask with stirring. The sol contained 37.12 weight % oxide (approximately 8.9 volume %) and 51.03 weight % solvent. The sol was passed through a 1 micron filter.

A structured gel was made by casting the above sol into a plastic push mold cavity designated as mold #08-0389 by Yaley Enterprises, Redding, Calif. The sol was pipetted into the mold until it crowned above the edge of the mold. A piece of 10 mil PET was carefully placed over the top of the sol in a fashion to avoid bubble formation. This film defines one face of the molded gel and acts as a barrier to oxygen inhibition of cure. The construction was moved to the 8-bulb light box described above for curing. The sol was light cured for 5 minutes to form the gel. It was left in the mold and placed in a plastic bag until it was extracted. The resulting gel was carefully removed from the mold. The resulting gel was crack free.

The gel body was dried using super critical extraction as described above except the vessel was maintained at a pressure of 110 bar, a 9 hour extraction cycle was used and the extractor vessel was vented in recycle mode for 12 hours. The resulting aerogel was crack free.

The resulting aerogel was burned out and pre-sintered according to schedule A. The resulting pre-sintered body was crack free. The body was ion exchanged according to the above procedure.

The pre-sintered body was sintered according to the procedure described above. The sintered part was a crack free, distortion free ring that replicated the mold well. It had an inner diameter of 32.22 mm, an outer diameter of 34.99 mm and a height of 7.53 mm. It had a shrinkage of about 53% as expected. The translucency was as expected for a fully dense material of this composition.

### Example 25

To prepare Example 25, Sol-S2 was concentrated to a composition of 41.14 weight % oxide and 11.49 weight % acetic acid. Then, to prepare the casting sol, the concentrated Sol-S2 (650.35 grams), MEEAA (9.54 grams), and diethylene glycol monoethyl ether (140.39 grams) were charged to a 1000 ml RB flask and mixed. The sample weight was reduced by 358.32 grams via rotary evaporation. The resulting sol (5.41 grams) was charged to a vial and combined with diethylene glycol monoethyl ether (2.53 grams), ethanol (1.55 grams), acrylic acid (0.72 grams), isobornyl acrylate (“SR506 A”) (0.63 gram), 1,6-hexanediol diacrylate (“SR238 B”) (0.26 grams), and pentaerythritol tetraacrylate (“SR295”) (0.33 gram). IRGACURE 819 (0.0594 gram) was dissolved in diethylene glycol monoethyl ether (1.98 grams) and added to the vial. The sol was passed through a 1 micron filter. The sol contained 24.3 weight % oxide (approximately 4.92 volume %) and 57.74 weight % solvent.

A gel body was molded using the procedure of Example 7. The resulting gel was crack free. The resulting gel surfaces were dry top and bottom. The gel replicated the mold well. It was placed in a sealed container until it was extracted.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and replicated the mold very well. The shrinkage of the disc diameter was measured to be 63.1% using a caliper. The Archimedes density was measured to be 6.11 g/cc using the above method. The translucency was as expected for a fully dense material of this composition.

### Example 26

To prepare Example 26, Sol-S2 was concentrated to a composition of 41.14 weight % oxide and 11.49 weight % acetic acid. Then, to prepare the casting sol, the concentrated Sol-S2 (650.35 grams), MEEAA (9.54 grams), and diethylene glycol monoethyl ether (140.39 grams) were charged to a 1000 ml RB flask and mixed. The sample weight was reduced by 358.32 grams via rotary evaporation. The resulting sol (20.23 grams) was charged to a jar and combined with diethylene glycol monoethyl ether (7.06 grams), acrylic acid (1.33 grams), isobornyl acrylate (“SR506 A”) (1.15 grams), 1,6-hexanediol diacrylate (“SR238 B”) (0.46 gram), and pentaerythritol tetraacrylate (“SR295”) (0.62 gram). IRGACURE 819 (0.0247 gram) was added to the jar, mixing until dissolved. The sol was passed through a 1 micron filter. The sol contained 39.67 weight % oxide (approximately 10.1 volume %) and 43.7 weight % solvent.

A gel disc was molded from the above casting sol in a cylindrical polypropylene mold (15.9 mm diameter). After the sol (approximately 0.5 ml) was pipetted into the mold, the mold was sealed leaving no space between the sol and the walls of the mold. The sealed mold was placed in the 8-bulb light box described above for curing. The sol was light cured for 3 minutes to form the gel. The resulting gel was carefully removed from the mold. The surfaces of the gel were dry and the gel was crack-free.

The ZrO₂-based gel was placed on a nylon mesh in a PYREX dish so that it was standing on the side of the disc. The gel was dried under ambient conditions for 36 days.

The resulting xerogel was burned out and pre-sintered according to schedule A. The resulting pre-sintered body was crack free. The body was ion exchanged according to the above procedure.

The pre-sintered body was sintered according to the procedure described above. The sintered body was crack free, and had a translucency similar to that of discs of the same oxide formulation prepared by an aerogel route. The Archimedes density was measured to be 6.07 g/cc. The shrinkage of the disc was 52.3% in the diameter measured using a caliper.

### Example 27

To prepare Example 27, Sol-S2 was concentrated to a composition of 40.5 weight % oxide and 11.3 weight % acetic acid. Then, to prepare the casting sol, the concentrated Sol-S2 (511.63 grams), MEEAA (7.45 grams), and diethylene glycol monoethyl ether (154.75 grams) were charged to a 1000 ml RB flask and mixed. The sample weight was reduced to 390.80 grams via rotary evaporation. Acrylic acid (1.73 grams), isobornyl acrylate (“SR506 A”) (1.5017 grams), 1,6-hexanediol diacrylate (“SR238 B”) (0.6163 grams), and pentaerythritol tetraacrylate (“SR295”) (0.7903 grams) were added to a jar containing the ZrO₂ sol (30.0 grams). IRGACURE 819 (0.0320 gram) was dissolved in diethylene glycol (19.2 grams) and charged to the jar. The viscosity was 10.9 cp at 15.36 l/sec. The sol contained 29.74 weight % oxide (approximately 6.6 volume %) and 57.69 weight % solvent.

A gel body was molded using the procedure of Example 7. The resulting gel was crack free. The resulting gel surfaces were dry top and bottom. The gel replicated the mold well. It was placed in a sealed container until it was extracted.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and replicated the mold very well. The shrinkage of the disc diameter was measured to be 59.2% using a caliper. The Archimedes density was measured to be 6.10 g/cc using the above method. The translucency was as expected for a fully dense material of this composition.

### Example 28

To prepare Example 28, Sol-S2 was concentrated to a composition of 40.5 weight % oxide and 11.3 weight % acetic acid. Then, to prepare the casting sol, the concentrated Sol-S2 (511.63 grams), MEEAA (7.45 grams), and diethylene glycol monoethyl ether (154.75 grams) were charged to a 1000 ml RB flask and mixed. The sample weight was reduced to 390.80 grams via rotary evaporation. Acrylic acid (1.73 grams), isobornyl acrylate (“SR506 A”) (1.5017 grams), 1,6-hexanediol diacrylate (“SR238 B”) (0.6163 grams), and pentaerythritol tetraacrylate (“SR295”) (0.790 grams) were added to a jar containing the ZrO₂ sol (30.0 grams). IRGACURE 819 (0.0320 gram) was dissolved in diethylene glycol (11.2 grams) and charged to the jar. The viscosity was 13.8 cp at 15.36 l/sec. The sol contained 34.87 weight % oxide (approximately 8.2 volume %) and 59.39 weight % solvent.

A gel body was molded using the procedure of Example 7. The resulting gel was crack free. The resulting gel surfaces were dry top and bottom. The gel replicated the mold well. It was placed in a sealed container until it was extracted.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and replicated the mold very well. The shrinkage of the disc diameter was measured to be 56.0% using a caliper. The Archimedes density was measured to be 6.08 g/cc using the above method. The translucency was as expected for a fully dense material of this composition.

### Example 29

To prepare Example 29, Sol-S2 was concentrated to a composition of 40.5 weight % oxide and 11.3 weight % acetic acid. Then, to prepare the casting sol, the concentrated Sol-S2 (511.63 grams), MEEAA (7.45 grams), and diethylene glycol monoethyl ether (154.75 grams) were charged to a 1000 ml RB flask and mixed. The sample weight was reduced to 390.80 grams via rotary evaporation. Acrylic acid (1.73 grams), isobornyl acrylate (“SR506 A”) (1.5017 grams), 1,6-hexanediol diacrylate (“SR238 B”) (0.6163 grams), and pentaerythritol tetraacrylate (“SR295”) (0.7903 grams) were added to a jar containing the ZrO₂ sol (30.0 grams). IRGACURE 819 (0.0320 gram) was dissolved in diethylene glycol (2.21 grams) and charged to the jar. The viscosity was 28.9 cp at 15.36 l/sec. The sol contained 43.44 weight % oxide (approximately 11.57 volume %) and 38.2 weight % solvent.

A gel body was molded using the procedure of Example 7. The resulting gel was crack free. The resulting gel surfaces were dry top and bottom. The gel replicated the mold well. It was placed in a sealed container until it was extracted.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and replicated the mold very well. The shrinkage of the disc diameter was measured to be 51.1% using a caliper. The Archimedes density was measured to be 6.10 g/cc using the above method. The translucency was as expected for a fully dense material of this composition.

### Example 30

To prepare Example 30, Sol-S2 was concentrated to a composition of 40.5 weight % oxide and 11.3 weight % acetic acid. Then, to prepare the casting sol, the concentrated Sol-S2 (200 grams), MEEAA (10.35 grams), and diethylene glycol monoethyl ether (33.41 grams) were charged to a 500 ml RB flask and mixed. The sample weight was reduced to 134.07 grams via rotary evaporation. Acrylic acid (5.0 grams), and 4-hydroxy-TEMPO (0.02 grams of 5 weight % solution in water) were added to the flask. The weight was reduced to 137.65 grams via rotary evaporation. IRGACURE 819 (0.475 grams of a 10 weight % solution in diethylene glycol monoethylether) and diethylene glycol monoethylether (3.4 grams) was added to jar containing the ZrO₂ sol (40.73 grams). The viscosity was 81.4 cp at 11.52 l/sec. The sol contained 54.33 weight % oxide (approximately 16.81 volume %) and 31.81 weight % solvent.

A gel body was molded using the procedure of Example 7. The resulting gel was crack free.

### Example 31

To prepare Example 31, Sol-S2 was concentrated to a composition of 40.5 weight % oxide and 11.3 weight % acetic acid. Then, to prepare the casting sol, the concentrated Sol-S2 (200 grams), MEEAA (10.35 grams), and diethylene glycol monoethyl ether (33.41 grams) were charged to a 500 ml RB flask and mixed. The sample weight was reduced to 134.07 grams via rotary evaporation. Acrylic acid (5.0 grams), and 4-hydroxy-TEMPO (0.02 grams of 5 weight % solution in water) were added to the flask. The weight was reduced to 137.65 grams via rotary evaporation. IRGACURE 819 (0.517 grams of a 10 weight % solution in diethylene glycol monoethylether), isobornyl acrylate (“SR506 A”) (0.263 grams), 1,6-hexanediol diacrylate (“SR238 B”) (0.526 grams), pentaerythritol tetraacrylate (“SR295”) (0.526 grams) and diethylene glycol monoethylether (6.09 grams) were added to the jar containing the ZrO₂ sol (40.73 grams). The viscosity was 42.4 cp at 11.52 l/sec. The sol contained 49.84 weight % oxide (approximately 14.18 volume %) and 33.3 weight % solvent.

A gel body was molded using the procedure of Example 7. The resulting gel was carefully removed from the mold and was crack free. The resulting gel surfaces were dry top and bottom. The gel replicated the mold well. It was placed in a sealed container until it was extracted.

The gel body was dried using super critical extraction as described above. The resulting aerogel was burned out and pre-sintered according to schedule A. The resulting pre-sintered body was crack free and flat. The body was ion exchanged according to the above procedure.

The pre-sintered body was sintered according to the procedure described above. The shrinkage of the disc diameter was measured to be 46.1% using a caliper. The Archimedes density was measured to be 6.10 g/cc using the above method. The translucency was as expected for a fully dense material of this composition.

### Example 32

To prepare Example 32, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (300 grams), MEEAA (8.15 grams), and diethylene glycol monoethyl ether (169.25 grams) were charged to a 1000 ml RB flask and mixed. The sample weight was reduced to 431.69 grams via rotary evaporation. Acrylic acid (1.12 grams), and ethoxylated trimethylolpropane triacrylate (“SR454”) (2.01 grams) were added to a jar containing the ZrO₂ sol (20.01 grams) and diethylene glycol monoethyl ether (3.19 grams) was charged to the jar. The sol contained 39.67 weight % oxide (approximately 10.1 volume %) and 41.98 weight % solvent. The composition was similar to Example 16.

The UV/visible transmission was measured using Method A for Determining Light Transmission (% T) described above. Table 4 summarizes the % T versus the wavelength.

TABLE 4

| Wavelength (nm) | % T |
|---|---|
| 200 | 0.21 |
| 210 | 0.089 |
| 220 | 0.048 |
| 230 | 0.039 |
| 240 | 0.034 |
| 250 | 0.0013 |
| 260 | 0.017 |
| 270 | 0.011 |
| 280 | 0.037 |
| 290 | 0.04 |
| 300 | 0.050 |
| 310 | 0.037 |
| 320 | 0.0511 |
| 330 | 1.603 |
| 340 | 1.648 |
| 350 | 1.055 |
| 360 | 1.050 |
| 370 | 1.551 |
| 380 | 2.834 |
| 390 | 4.351 |
| 400 | 5.915 |
| 410 | 7.903 |
| 420 | 10.158 |
| 430 | 12.640 |
| 440 | 15.417 |
| 450 | 18.426 |
| 460 | 21.419 |
| 470 | 24.552 |
| 480 | 27.735 |
| 490 | 30.871 |
| 500 | 33.979 |
| 510 | 37.058 |
| 520 | 40.030 |
| 530 | 42.923 |
| 540 | 45.716 |
| 550 | 48.332 |
| 560 | 50.963 |
| 570 | 53.386 |
| 580 | 55.659 |
| 590 | 57.897 |
| 600 | 60.011 |
| 610 | 61.994 |
| 620 | 63.921 |
| 630 | 65.634 |
| 640 | 67.328 |
| 650 | 69.148 |
| 660 | 70.455 |
| 670 | 71.851 |
| 680 | 73.194 |
| 690 | 74.432 |
| 700 | 75.673 |
| 710 | 76.826 |
| 720 | 78.186 |
| 730 | 79.610 |
| 740 | 81.001 |
| 750 | 81.875 |
| 760 | 82.639 |
| 770 | 83.308 |
| 780 | 84.074 |
| 790 | 84.795 |

### Example 33

The sol composition was similar to that used in Example 21 except there was no initiator added. The UV/visible transmission was measured using Method B for Determining Light Transmission (% T) described above and is shown in Table 5. The data indicate that there is significant light transmission through 1 cm of the sample for the spectral range from 700 nm to less than 350 nm. The Total Hemispherical Transmittance (THT, or total of all light transmitted) indicates all light passed through the sample.

TABLE 5

| Wavelength (nm) | % T |
|---|---|
| 300 | 0.05 |
| 310 | 0.16 |
| 320 | 0.55 |
| 330 | 1.07 |
| 340 | 1.83 |
| 350 | 3.29 |
| 360 | 6.49 |
| 370 | 11.81 |
| 380 | 17.81 |
| 390 | 22.50 |
| 400 | 26.30 |
| 410 | 29.67 |
| 420 | 32.84 |
| 430 | 35.90 |
| 440 | 38.89 |
| 450 | 41.83 |
| 460 | 44.65 |
| 470 | 47.34 |
| 480 | 49.95 |
| 490 | 52.61 |
| 500 | 55.12 |
| 510 | 57.43 |
| 520 | 59.68 |
| 530 | 61.88 |
| 540 | 63.96 |
| 550 | 65.93 |
| 560 | 67.79 |
| 570 | 69.56 |
| 580 | 71.26 |
| 590 | 72.87 |
| 600 | 74.41 |
| 610 | 75.85 |
| 620 | 77.17 |
| 630 | 78.41 |
| 640 | 79.56 |
| 650 | 80.66 |
| 660 | 81.77 |
| 670 | 82.81 |
| 680 | 83.73 |
| 690 | 84.63 |
| 700 | 85.49 |

### Example 34

To prepare Example 34, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (300 grams), MEEAA (8.15 grams), and diethylene glycol monoethyl ether (169.25 grams) were charged to a 1000 ml RB flask and mixed. The sample weight was reduced to 431.69 grams via rotary evaporation. Acrylic acid (8.20 grams), and ethoxylated trimethylolpropane triacrylate (“SR454”) (14.25 grams) were added to a jar containing the ZrO₂ sol (145.02 grams). IRGACURE 819 (0.1515 gram) was dissolved in diethylene glycol monoethyl ether (23.25 grams) and charged to the jar. The sol was passed through a 1 micron filter. The sol contained 39.67 weight % oxide (approximately 10.1 volume %) and 41.98 weight % solvent.

The curable composition was placed in the polypropylene mold (approximately L×W×D of 65 mm×45 mm×42 mm). A piece of 10 mil (250 micrometer) PET was carefully placed over the top of the sol in a fashion to avoid bubble formation. This film defined one face of the molded gel and acted as a barrier to oxygen inhibition of cure. The filled mold was moved to the 8-bulb light box to cure. The sol was light cured for 12 minutes. The resulting gel had dry surfaces and was crack free. This resulted in a uniform cure throughout. The sample depth of cure was >21 mm.

### Example 35

To prepare Example 35, Sol-S5 was concentrated to a composition of 45.08 weight % oxide and 6.63 weight % acetic acid and the water/ethanol ratio was 59.09/40.09. Then, to prepare the casting sol, the concentrated Sol-S5 (300 grams), MEEAA (8.15 grams), and diethylene glycol monoethyl ether (169.25 grams) were charged to a 1000 ml RB flask and mixed. The sample weight was reduced to 431.69 grams via rotary evaporation. Acrylic acid (1.44 grams) was added to a jar containing the ZrO₂ sol (25.02 grams). IRGACURE 819 (0.0261 gram) was dissolved in diethylene glycol monoethyl ether (6.21 grams) and charged to the jar. The viscosity was 20.1 cp at 15.36 l/sec. The sol contained 39.97 weight % oxide (approximately 10.1 volume %) and 49.06 weight % solvent.

A gel body was molded using the procedure of Example 7. The resulting gel was crack free. The resulting gel was carefully removed from the mold and was crack free. The resulting gel surfaces were dry top and bottom. The gel replicated the mold well. It was placed in a sealed container until it was extracted.

The gel body was dried using super critical extraction as described above. The resulting aerogel was crack free.

The resulting aerogel was burned out and pre-sintered according to schedule A. The resulting pre-sintered body was crack free and flat. The body was ion exchanged according to the above procedure.

The pre-sintered body was sintered according to the procedure described above. The sintered body was crack free and replicated the mold very well. The shrinkage of the disc diameter was measured to be 52.9% using a caliper. The Archimedes density was measured to be 6.06 g/cc using the above method. The translucency was as expected for a fully dense material of this composition.

### Example 36

To prepare Example 36, dialyzed Sol-S2 (400.0 grams, 35.38 percent solids, 31.97 percent ZrO₂) was charged to a 1 quart (946.35 ml) jar. Methoxypropanol (400 grams) and 3-(acryloxyproply) trimethoxy silane (44.40 grams) were then charged to a 1 liter beaker with stirring. The methoxypropanol mixture was then charged to the Sol-S2 with stirring. The jar was sealed and heated to 90° C. for 4 hours. After heating, DI water (1100 grams) and concentrated NH₃ (25.01 grams, 29 weight %) were charged to a 4 liter beaker. The above sol was added to this with minimal stirring. A white precipitate was obtained. The precipitate was isolated as a damp filter cake via vacuum filtration. The solids (360 grams) were dispersed in methoxypropanol (1400 grams). The mixture was stirred for about 24 hours. The mixture was then concentrated (273.29 grams) via rotary evaporation. Methoxypropanol was charged (221 grams) and the mixture was concentrated via rotary evaporation. The final product (293.33 grams) was isolated at 46.22 percent solids. The mixture was filtered through a 1 micron filter.

The above sol (65.06 grams) and diethylene glycol monoethyl ether (20.04 grams) and 1 drop of 5% 4-Hydroxy-TEMPO in water was charged to a 500 ml RB flask. The mixture was then concentrated (52.25 grams) via rotary evaporation. Acrylic acid (1.03 grams), isobornyl acrylate (“SR506 A”) (0.899 grams), 1,6-hexanediol diacrylate (“SR238 B”) (0.369 grams), and pentaerythritol tetraacrylate (“SR295”) (0.479 grams) were added to a jar containing the ZrO₂ sol (20.0 grams). IRGACURE 819 (0.0191 gram) was dissolved in diethylene glycol monoethylether (0.6654 grams) and charged to the jar. The viscosity was 18.6 cp at 15.36 l/sec. The sol contained 40.70 weight % oxide (approximately 10.1 volume %) and 35.54 weight % solvent.

A structured gel was made as described in Example 5 except the beaker mold described above was used. The resulting gel was carefully removed from the mold with no cracks forming during this process.

### Example 37

To prepare Example 37, Sol-S2 was concentrated to a composition of 40.5 weight % oxide and 11.3 weight % acetic acid. Then, to prepare the casting sol, the concentrated Sol-S2 (99.98 grams) and diethylene glycol monoethyl ether (37.11 grams) were charged to a 500 ml RB flask and mixed. The sample weight was reduced to 100.01 grams via rotary evaporation. Acrylic acid (4.35 grams) was added to the flask. The weight was reduced to 90.86 grams via rotary evaporation. Isobornyl acrylate (“SR506 A”) (1.325 grams), 1,6-hexanediol diacrylate (“SR238 B”) (0.547 grams) and pentaerythritol tetraacrylate (“SR295”) (0.693 grams) were added to a jar containing the ZrO₂ sol (30.00 grams). IRGACURE 819 (0.0288 gram) was dissolved in diethylene glycol monoethyl ether (0.964 grams) and charged to the jar. The sol contained 42.07 weight % oxide (approximately 10.7 volume %) and 40.87 weight % solvent.

A structured gel was made as described in Example 5 except the beaker mold described above was used. The resulting gel was carefully removed from the mold with no cracks forming during this process.

1. A gel composition comprising a polymerized product of a reaction mixture comprising:
a. 20 to 60 weight percent zirconia-based particles based on a total weight of the reaction mixture, the zirconia-based particles having an average particle size no greater than 100 nanometers and comprising at least 70 mole percent ZrO₂;
b. 30 to 75 weight percent of a solvent medium based on the total weight of the reaction mixture, the solvent medium comprising at least 60 percent of an organic solvent having a boiling point equal to at least 150° C.;
c. 2 to 30 weight percent polymerizable material based on the total weight of the reaction mixture, the polymerizable material comprising (1) a first surface modification agent having a free radical polymerizable group; and
d. a photoinitiator for a free radical polymerization reaction.

2. The gel composition of claim 1, wherein the solvent medium comprises at least 80 weight percent of the organic solvent having the boiling point equal to at least 150° C.

3. The gel composition of claim 1, wherein the organic solvent having the boiling point equal to at least 150° C. is of Formula (I) 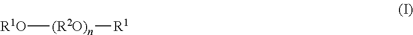
wherein
each R¹ independently is hydrogen, alkyl, aryl, or acyl;
each R² is typically ethylene or propylene; and
n is in a range of 1 to 10.

4. The gel composition of claim 1, wherein the zirconia-based particles are crystalline and wherein at least 80 weight percent of the zirconia-based particles have a cubic structure, tetragonal structure, or a combination thereof.

5. The gel composition of claim 1, wherein the first surface modification agent having a free radical polymerizable group further has a surface modifying group that is (1) a carboxyl group (—COOH) or an anion thereof; or (2) a silyl group of formula —Si(R⁷)ₓ(R⁸)₃₋ₓ where R⁷ is a non-hydrolyzable group, R⁸ is hydroxyl or a hydrolyzable group, and the variable x is an integer equal to 0, 1, or 2.

6. The gel composition of claim 1, wherein the zirconia-based particles comprise 80 to 99 mole percent zirconium oxide, 1 to 20 mole percent yttrium oxide, and 0 to 5 mole percent lanthanum oxide.

7. An article comprising:
a mold having a mold cavity; and
a gel composition positioned within the mold cavity and in contact with a surface of the mold cavity, the gel composition comprising a polymerized product of a reaction mixture comprising:
a. 20 to 60 weight percent zirconia-based particles based on a total weight of the reaction mixture, the zirconia-based particles having an average particle size no greater than 100 nanometers and comprising at least 70 mole percent ZrO₂;
b. 30 to 75 weight percent of a solvent medium based on the total weight of the reaction mixture, the solvent medium comprising at least 60 percent of an organic solvent having a boiling point equal to at least 150° C.;
c. 2 to 30 weight percent polymerizable material based on a total weight of the reaction mixture, the polymerizable material comprising (1) a first surface modification agent having a free radical polymerizable group; and
d. a photoinitiator for a free radical polymerization reaction.

8. The article of claim 7, wherein the mold cavity has at least one surface that can transmit actinic radiation in the visible region, ultraviolet region, or both of the electromagnetic spectrum.

9. The article of claim 7, wherein the reaction mixture contacts all surfaces of the mold cavity.

10. The article of claim 7, wherein the gel composition has a size and shape that is identical to that of the mold cavity (except in a region where the mold cavity was overfilled with the reaction mixture).

11. A shaped gel article comprising a polymerized product of a reaction mixture, wherein the reaction mixture is positioned within a mold cavity during polymerization and wherein the shaped gel article retains both a size and shape identical to the mold cavity (except in a region where the mold cavity was overfilled) when removed from the mold cavity, the reaction mixture comprising:
a. 20 to 60 weight percent zirconia-based particles based on a total weight of the reaction mixture, the zirconia-based particles having an average particle size no greater than 100 nanometers and comprising at least 70 mole percent ZrO₂;
b. 30 to 75 weight percent of a solvent medium based on the total weight of the reaction mixture, the solvent medium comprising at least 60 percent of an organic solvent having a boiling point equal to at least 150° C.;
c. 2 to 30 weight percent polymerizable material based on a total weight of the reaction mixture, the polymerizable material comprising (1) a first surface modification agent having a free radical polymerizable group; and
d. a photoinitiator for a free radical polymerization reaction.

12. The shaped gel article of claim 11, wherein the shaped gel article is removable from the mold cavity without breaking or cracking.

13. A method of making a sintered article, the method comprising:
providing a mold having a mold cavity;
positioning a reaction mixture within the mold cavity, the reaction mixture comprising:
a. 20 to 60 weight percent zirconia-based particles based on a total weight of the reaction mixture, the zirconia-based particles having an average particle size no greater than 100 nanometers and comprising at least 70 mole percent ZrO₂;
b. 30 to 75 weight percent of a solvent medium based on the total weight of the reaction mixture, the solvent medium comprising at least 60 percent of an organic solvent having a boiling point equal to at least 150° C.;
c. 2 to 30 weight percent polymerizable material based on a total weight of the reaction mixture, the polymerizable material comprising (1) a first surface modification agent having a free radical polymerizable group; and
d. a photoinitiator for a free radical polymerization reaction;
polymerizing the reaction mixture to form a shaped gel article that is in contact with the mold cavity;
removing the shaped gel article from the mold cavity, wherein the shaped gel article retains a size and shape identical to the mold cavity (except in regions where the mold cavity was overfilled);
forming a dried shaped gel article by removing the solvent medium; and
heating the dried shaped gel article to form a sintered article, wherein the sintered article has a shape identical to the mold cavity (except in regions where the mold cavity was overfilled) and to the shaped gel article but reduced in size proportional to an amount of isotropic shrinkage.

14. The method of claim 13, wherein forming a dried shaped gel article by removing the solvent medium comprises forming an aerogel.

15. The method of claim 13, wherein forming a dried shaped gel article by removing the solvent medium comprises forming a xerogel.
